(19) United States
(12) Patent Application Publication
(10) Pub. No.: US 2026/0114361 A1
(43) Pub. Date: Apr. 30, 2026

(54) ELECTRIC VEHICLE, ELECTRIC GARDEN VEHICLE, AND ELECTRIC RIDING LAWN MOWER

(71) Applicant: JIANGSU DONGCHENG M&E TOOLS CO., LTD., Nantong (CN)

(72) Inventor: Haodong WANG, Nantong (CN)

(21) Appl. No.: 19/432,949

(22) Filed: Dec. 25, 2025

Related U.S. Application Data
(63) Continuation of application No. PCT/CN2024/102507, filed on Jun. 28, 2024.

(30) Foreign Application Priority Data
Jun. 28, 2023 (CN) 202310773365.7
Oct. 31, 2023 (CN) 202311423869.2
Oct. 31, 2023 (CN) 202311426810.9

(51) Int. Cl. A01D 34/00; A01D 34/64; A01D 34/78; A01D 67/00; A01D 101/00

(52) U.S. Cl. CPC A01D 34/006; A01D 34/64; A01D 34/78; A01D 67/00; A01D 2101/00

(57) ABSTRACT

Provided are an electric vehicle, an electric garden vehicle, and an electric riding lawn mower. The electric vehicle includes a functional motor and a controller assembly configured to control an operating state of the functional motor. The functional motor has a plurality of operating parameters, and the controller assembly has a plurality of control strategies corresponding to the operating parameters. The controller assembly includes a heavy load identification unit configured to select a target operating parameter and determine whether the functional motor enters a heavy load state based on the target operating parameter and/or a change of the target operating parameter. The heavy load control unit is configured to select, in response to determining that the functional motor enters the heavy load state, a second control strategy and control the functional motor based on the second control strategy to exit the heavy load state.

### CROSS-REFERENCE TO RELATED APPLICATIONS

This application is a continuation of International Patent Application No. PCT/CN2024/102507, filed on Jun. 28, 2024, which claims benefit of and priority to CN. Patent Application No. 202310773365.7 filed Jun. 28, 2023 and titled “Device Control Method, Apparatus, and Computer-Readable Storage Medium”, Application No. 202311426810.9 filed Oct. 31, 2023 and titled “Electric Work Vehicle and Detection Method for Heavy-Load State”, Application No. 202311423869.2 filed Oct. 31, 2023 and titled “Electric Work Vehicle and Detection Method for Heavy-Load State”, the entirety of which is hereby incorporated by reference.

### FIELD

The present disclosure relates to the technical field of vehicle engineering, and particularly to an electric vehicle, an electric garden vehicle, and an electric riding lawn mower.

### BACKGROUND

Compared to traditional fuel-powered lawn mowers, battery-powered lawn mowers offer the advantages of all-weather zero emissions, zero fuel consumption, low noise, and simple maintenance due to the absence of gasoline, engine oil, air filters, spark plugs, fuel storage, etc. In battery-powered lawn mowers, an electric motor replaces the fuel engine as the power source, providing power to the drive wheel motor and the mowing motor. Battery-powered lawn mowers can independently control different drive wheel motors to achieve straight-line travel, reversing, turning, and zero-turn steering, thereby reducing the structural complexity of the entire machine and enabling more flexible control.

During operation, variations in actual grass density can affect the operational load of the lawn mower. A sudden change from sparse to dense grass conditions often causes the load on the mowing motor to abruptly become a heavy load. Consequently, the output power, operating current, and other parameters of the mowing motor may increase instantaneously, potentially leading to motor damage due to overcurrent or triggering an overcurrent protection shutdown. This situation can seriously impact the overall machine stability and the user experience.

### SUMMARY

Embodiments of the present disclosure provide an electric work vehicle, an electric garden work vehicle, and an electric riding lawn mower, which can promptly and accurately identify sudden heavy-load conditions and take corresponding control measures, thereby enhancing overall machine stability and optimizing user experience.

In one aspect, an embodiment of the present disclosure provides an electric work vehicle, including: a frame; a functional mechanism attached to the frame, including a functional motor and an output assembly driven by the functional motor to perform a functional operation; a controller assembly configured to control an operating state of the functional motor.

The functional motor has a plurality of operating parameters, and the controller assembly has a plurality of control strategies corresponding to the plurality of operating parameters of the functional motor.

The controller assembly includes a heavy load identification unit and a heavy load control unit.

The heavy load identification unit is configured to: select a target operating parameter from the plurality of operating parameters; and determine whether the functional motor enters a heavy load state based on the target operating parameter and/or a change of the target operating parameter.

The target operating parameter does not correspond to a first control strategy currently adopted by the controller assembly for the functional motor.

The heavy load control unit is configured to: select, in response to determining that the functional motor has entered the heavy load state, a second control strategy from the plurality of control strategies; and control the functional motor based on the second control strategy to cause the functional motor to exit the heavy load state.

In another aspect, an embodiment of the present disclosure further provides an electric garden work vehicle, including: a frame; a functional mechanism attached to the frame, including a functional motor and an output assembly driven by the functional motor to perform a specific functional operation; a controller assembly configured to control an operating state of the functional motor.

The functional motor has a plurality of operating parameters, and the controller assembly has a plurality of control strategies corresponding to the plurality of operating parameters of the functional motor.

The controller assembly includes a heavy load identification unit and a heavy load control unit.

The heavy load identification unit is configured to: select a target operating parameter from the plurality of operating parameters; and determine whether the functional motor enters a heavy load state based on the target operating parameter and/or a change of the target operating parameter.

The target operating parameter does not correspond to a first control strategy currently adopted by the controller assembly for the functional motor.

The heavy load control unit is configured to: select, in response to determining that the functional motor has entered the heavy load state, a second control strategy from the plurality of control strategies; and control the functional motor based on the second control strategy to cause the functional motor to exit the heavy load state.

In another aspect, an embodiment of the present disclosure further provides an electric riding lawn mower, including: a frame; a carrying mechanism disposed on the frame and configured to carry a user; a mowing mechanism attached to the frame, including a mowing motor and a cutting blade assembly driven by the mowing motor to perform a mowing operation; a controller assembly configured to control an operating state of the mowing motor.

The mowing motor has a plurality of operating parameters, and the controller assembly has a plurality of control strategies corresponding to the plurality of operating parameters of the mowing motor.

The controller assembly includes a heavy load identification unit and a heavy load control unit.

The heavy load identification unit is configured to: select a target operating parameter from the plurality of operating parameters; and determine whether the mowing motor enters a heavy load state based on the target operating parameter and/or a change of the target operating parameter.

The target operating parameter does not correspond to a first control strategy currently adopted by the controller assembly for the mowing motor.

The heavy load control unit is configured to: select, in response to determining that the mowing motor has entered the heavy load state, a second control strategy from the plurality of control strategies; and control the mowing motor based on the second control strategy to cause the mowing motor to exit the heavy load state.

As can be seen from the above, the electric work vehicle, electric garden work vehicle, and electric riding lawn mower provided by one or more embodiments of the present disclosure have the following beneficial technical effects:

In the electric work vehicle, electric garden work vehicle, and electric riding lawn mower, the heavy load identification unit in the controller assembly monitors one or a plurality of operating parameters related to the functional motor, and determines whether the functional motor enters a heavy load state based on the operating parameter(s) and/or changes in the operating parameter(s). Upon determining that the functional motor has entered the heavy load state, the heavy load control unit in the controller assembly selects an appropriate control strategy according to the situation and promptly adjusts and controls the functional motor to make it exit the heavy load state. This approach enables precise and sensitive identification of sudden heavy-load changes in the motor, further facilitates a rapid response to such changes, timely adjustment of the control strategy, and maintains the motor system in a normal operating state, thereby enhancing overall machine stability and work efficiency, and optimizing the user experience.

### BRIEF DESCRIPTION OF THE DRAWINGS

The features, aspects, and advantages of the present disclosure will become better understood when the following detailed description is read with reference to the accompanying drawings in which like characters represent like parts throughout the drawings.

FIG. 1 is a schematic structural diagram of an electric work vehicle according to an embodiment of the present disclosure.

FIG. 2 is a schematic structural diagram of an electric work vehicle according to an embodiment of the present disclosure.

FIG. 3 is a functional block diagram of a controller assembly in an electric work vehicle according to an embodiment of the present disclosure.

FIG. 4 is a schematic diagram of a method for a heavy load identification unit selecting a rotational speed parameter as a target operating parameter for heavy load determination in an electric work vehicle according to an embodiment of the present disclosure.

FIG. 5 is a schematic diagram of a method for a heavy load identification unit determining heavy load by using a motor rotational speed parameter in an electric work vehicle according to an embodiment of the present disclosure.

FIG. 6 is a schematic diagram of a heavy load identification unit determining a heavy load mutation based on a motor rotational speed threshold in an electric work vehicle according to an embodiment of the present disclosure.

FIG. 7 is a schematic diagram of a heavy load identification unit determining a heavy load mutation based on a motor rotational speed difference threshold in an electric work vehicle according to an embodiment of the present disclosure.

FIG. 8 is a schematic diagram of a heavy load identification unit determining a heavy load mutation based on a motor rotational speed rate-of-change threshold in an electric work vehicle according to an embodiment of the present disclosure.

FIG. 9 is a schematic diagram of a method for a heavy load identification unit determining heavy load by using a motor sector time parameter in an electric work vehicle according to an embodiment of the present disclosure.

FIG. 10 is a schematic diagram of a heavy load identification unit determining a heavy load mutation based on a motor sector time threshold in an electric work vehicle according to an embodiment of the present disclosure.

FIG. 11 is a schematic diagram of a heavy load identification unit determining a heavy load mutation based on a motor sector time difference threshold in an electric work vehicle according to an embodiment of the present disclosure.

FIG. 12 is a schematic diagram of a heavy load identification unit determining a heavy load mutation based on a motor sector time rate-of-change threshold in an electric work vehicle according to an embodiment of the present disclosure.

FIG. 13 is a schematic diagram of a method for a heavy load identification unit selecting an electrical parameter as a target operating parameter for heavy load determination in an electric work vehicle according to an embodiment of the present disclosure.

FIG. 14 is a schematic diagram of a method for a heavy load identification unit determining heavy load based on an electrical parameter in an electric work vehicle according to an embodiment of the present disclosure.

FIG. 15 is a schematic diagram of a heavy load identification unit determining a heavy load mutation based on a bus current threshold in an electric work vehicle according to an embodiment of the present disclosure.

FIG. 16 is a schematic diagram of a heavy load identification unit determining a heavy load mutation based on a bus current difference threshold in an electric work vehicle according to an embodiment of the present disclosure.

FIG. 17 is a schematic diagram of a heavy load identification unit determining a heavy load mutation based on a bus current rate-of-change threshold in an electric work vehicle according to an embodiment of the present disclosure.

FIG. 18 is a schematic diagram of a heavy load identification unit determining a heavy load mutation based on a bus voltage drop threshold in an electric work vehicle according to an embodiment of the present disclosure.

FIG. 19 is a schematic diagram of a heavy load identification unit determining a heavy load mutation based on a conducting phase voltage drop threshold in an electric work vehicle according to an embodiment of the present disclosure.

FIG. 20 is a schematic diagram of freewheeling time of a functional motor during operation in an electric work vehicle according to an embodiment of the present disclosure.

FIG. 21 is a schematic diagram of a method for a heavy load identification unit selecting a power parameter as a target operating parameter for heavy load determination in an electric work vehicle according to an embodiment of the present disclosure.

FIG. 22 is a schematic diagram of a method for a heavy load identification unit determining heavy load based on a power parameter in an electric work vehicle according to an embodiment of the present disclosure.

FIG. 23 is a schematic diagram of a method for a heavy load identification unit selecting a torque parameter as a target operating parameter for heavy load determination in an electric work vehicle according to an embodiment of the present disclosure.

FIG. 24 is a schematic diagram of a method for a heavy load identification unit determining heavy load based on a torque parameter in an electric work vehicle according to an embodiment of the present disclosure.

FIG. 25 is a schematic diagram of a method for a heavy load identification unit selecting a PWM duty cycle parameter as a target operating parameter for heavy load determination in an electric work vehicle according to an embodiment of the present disclosure.

FIG. 26 is a schematic diagram of a method for a heavy load identification unit determining heavy load based on a PWM duty cycle parameter in an electric work vehicle according to an embodiment of the present disclosure.

FIG. 27 is a schematic diagram of a method for a heavy load identification unit selecting a rotational speed parameter and an electrical parameter as target operating parameters for heavy load determination in an electric work vehicle according to an embodiment of the present disclosure.

FIG. 28 is a schematic diagram of a method for a heavy load identification unit determining heavy load based on a motor rotational speed parameter and an electrical parameter in an electric work vehicle according to an embodiment of the present disclosure.

FIG. 29 is a schematic diagram of a heavy load identification unit determining a heavy load mutation based on a current-to-speed ratio threshold in an electric work vehicle according to an embodiment of the present disclosure.

FIG. 30 is a schematic diagram of a method for a heavy load identification unit determining heavy load based on a motor sector time parameter and an electrical parameter in an electric work vehicle according to an embodiment of the present disclosure.

FIG. 31 is a schematic diagram of a heavy load identification unit determining a heavy load mutation based on a current-to-speed ratio threshold in an electric work vehicle according to an embodiment of the present disclosure.

FIG. 32 is a schematic diagram of a heavy load identification unit determining a heavy load mutation based on a current-to-speed ratio difference threshold in an electric work vehicle according to an embodiment of the present disclosure.

FIG. 33 is a schematic diagram of a heavy load identification unit determining a heavy load mutation based on a current-to-speed ratio difference threshold in an electric work vehicle according to an embodiment of the present disclosure.

FIG. 34 is a schematic diagram of a heavy load identification unit determining a heavy load mutation based on a current-to-speed ratio rate-of-change threshold in an electric work vehicle according to an embodiment of the present disclosure.

FIG. 35 is a schematic diagram of a heavy load identification unit determining a heavy load mutation based on a current-to-speed ratio rate-of-change threshold in an electric work vehicle according to an embodiment of the present disclosure.

FIG. 36 is a schematic diagram of a method for a heavy load identification unit selecting a rotational speed parameter and a power parameter as target operating parameters for heavy load determination in an electric work vehicle according to an embodiment of the present disclosure.

FIG. 37 is a schematic diagram of a method for a heavy load identification unit determining heavy load based on a motor rotational speed parameter and a power parameter in an electric work vehicle according to an embodiment of the present disclosure.

FIG. 38 is a schematic diagram of a method for a heavy load identification unit determining heavy load based on a motor sector time parameter and a power parameter in an electric work vehicle according to an embodiment of the present disclosure.

FIG. 39 is a schematic diagram of a method for a heavy load identification unit selecting a rotational speed parameter and a torque parameter as target operating parameters for heavy load determination in an electric work vehicle according to an embodiment of the present disclosure.

FIG. 40 is a schematic diagram of a method for a heavy load identification unit determining heavy load based on a motor rotational speed parameter and a torque parameter in an electric work vehicle according to an embodiment of the present disclosure.

FIG. 41 is a schematic diagram of a method for a heavy load identification unit determining heavy load based on a motor sector time parameter and a torque parameter in an electric work vehicle according to an embodiment of the present disclosure.

FIG. 42 is a schematic diagram of a method for a heavy load identification unit selecting a rotational speed parameter and a PWM duty cycle parameter as target operating parameters for heavy load determination in an electric work vehicle according to an embodiment of the present disclosure.

FIG. 43 is a schematic diagram of a method for a heavy load identification unit determining heavy load based on a motor rotational speed parameter and a PWM duty cycle parameter in an electric work vehicle according to an embodiment of the present disclosure.

FIG. 44 is a schematic diagram of a method for a heavy load identification unit determining heavy load based on a motor sector time parameter and a PWM duty cycle parameter in an electric work vehicle according to an embodiment of the present disclosure.

FIG. 45 is a schematic diagram of a method for a heavy load identification unit selecting an electrical parameter and a PWM duty cycle parameter as target operating parameters for heavy load determination in an electric work vehicle according to an embodiment of the present disclosure.

FIG. 46 is a schematic diagram of a method for a heavy load identification unit determining heavy load based on a duty-cycle-to-current ratio in an electric work vehicle according to an embodiment of the present disclosure.

FIG. 47 is a schematic diagram of a method for a heavy load identification unit selecting a power parameter and a PWM duty cycle parameter as target operating parameters for heavy load determination in an electric work vehicle according to an embodiment of the present disclosure.

FIG. 48 is a schematic diagram of a method for a heavy load identification unit determining heavy load based on a duty-cycle-to-power ratio in an electric work vehicle according to an embodiment of the present disclosure.

FIG. 49 is a schematic diagram of a method for a heavy load identification unit selecting a torque parameter and a PWM duty cycle parameter as target operating parameters for heavy load determination in an electric work vehicle according to an embodiment of the present disclosure.

FIG. 50 is a schematic diagram of a method for a heavy load identification unit determining heavy load based on a duty-cycle-to-torque ratio in an electric work vehicle according to an embodiment of the present disclosure.

FIG. 51 is a logic block diagram of applying PWM duty cycle open-loop control to a functional motor in an electric work vehicle according to an embodiment of the present disclosure.

FIG. 52 is a schematic diagram of a heavy load control unit reducing a duty cycle by using a linear reduction method in an electric work vehicle according to an embodiment of the present disclosure.

FIG. 53 is a schematic diagram of a heavy load control unit reducing a duty cycle by using a curvilinear reduction method in an electric work vehicle according to an embodiment of the present disclosure.

FIG. 54 is a schematic diagram of bus current change when the heavy load control unit switches from a PWM duty cycle open-loop control strategy to a current closed-loop control strategy in an electric work vehicle according to an embodiment of the present disclosure.

FIG. 55 is a schematic diagram of motor rotational speed change when the heavy load control unit switches from a PWM duty cycle open-loop control strategy to a rotational speed closed-loop control strategy in an electric work vehicle according to an embodiment of the present disclosure.

FIG. 56 is a schematic diagram of motor power change when the heavy load control unit switches from a PWM duty cycle open-loop control strategy to a power closed-loop control strategy in an electric work vehicle according to an embodiment of the present disclosure.

FIG. 57 is a schematic diagram of motor torque change when the heavy load control unit switches from a PWM duty cycle open-loop control strategy to a torque closed-loop control strategy in an electric work vehicle according to an embodiment of the present disclosure.

FIG. 58 is a logic block diagram of applying rotational speed closed-loop control to a functional motor in an electric work vehicle according to an embodiment of the present disclosure.

FIG. 59 is a schematic diagram of a heavy load control unit reducing the motor rotational speed by using a linear reduction method in an electric work vehicle according to an embodiment of the present disclosure.

FIG. 60 is a schematic diagram of a heavy load control unit reducing the motor rotational speed by using a curvilinear reduction method in an electric work vehicle according to an embodiment of the present disclosure.

FIG. 61 is a schematic diagram of bus current change when the heavy load control unit switches from a rotational speed closed-loop control strategy to a current closed-loop control strategy in an electric work vehicle according to an embodiment of the present disclosure.

FIG. 62 is a schematic diagram of duty cycle change when the heavy load control unit switches from a rotational speed closed-loop control strategy to a PWM duty cycle open-loop control strategy in an electric work vehicle according to an embodiment of the present disclosure.

FIG. 63 is a schematic diagram of motor power change when the heavy load control unit switches from a rotational speed closed-loop control strategy to a power closed-loop control strategy in an electric work vehicle according to an embodiment of the present disclosure.

FIG. 64 is a schematic diagram of motor torque change when the heavy load control unit switches from a rotational speed closed-loop control strategy to a torque closed-loop control strategy in an electric work vehicle according to an embodiment of the present disclosure.

### DETAILED DESCRIPTION OF THE EMBODIMENTS

To make the objectives, technical solutions, and advantages of the embodiments of the present disclosure clearer, the technical solutions in the embodiments of the present disclosure will be described clearly and completely below with reference to the accompanying drawings in the embodiments of the present disclosure. Obviously, the described embodiments are part, rather than all of the embodiments of the present disclosure. Based on the embodiments of the present disclosure, all other embodiments obtained by persons of ordinary skill in the art without making creative efforts shall fall within the protection scope of the present disclosure.

Compared to traditional fuel-powered lawn mowers, battery-powered lawn mowers offer the advantages of all-weather zero emissions, zero fuel consumption, low noise, and simple maintenance due to the absence of gasoline, engine oil, air filters, spark plugs, fuel storage, etc. In battery-powered lawn mowers, the fuel engine in the power system is replaced by an electric motor, which is capable of independently control the drive wheel motors to achieve straight-line travel, reversing, turning, and zero-turn steering, thereby reducing the structural complexity of the entire machine and enabling more flexible control.

During operation, the working load of the mowing motor varies significantly. Under sparse and short grass conditions, the load is very small, whereas under tall and dense grass conditions, the load becomes very heavy. In practical working conditions, the transition from sparse to dense grass is not always gradual, and can be abrupt. The motor load suddenly becomes a heavy load when moving from sparse grass directly into dense grass. On the other hand, after prolonged operation, the mowing deck inevitably accumulates a large amount of grass debris. This debris mixed with newly cut dense grass causes the overall machine load to continuously increase. Continuous operation in the heavy load range makes the system exceptionally sensitive to sudden load changes. A common scenario under these conditions is that a slight, sudden increase in load can trigger the system's overload protection.

If the controller's protection current threshold is set too high or the delay time is too long, protection lag can occur. This may cause the power device to operate beyond its Safe Operating Area (SOA) for an extended period, leading to burnout, most typically from overcurrent damage. Even if the power device is not damaged, the substantial current surge imposes significant stress on the motor itself, which is destructive. Over time, the motor stator may burn out, or the rotor magnets may demagnetize. Conversely, if the controller sets the protection current threshold too low or the response time too short, the protection becomes very sensitive, making it less likely for the power device to be damaged. However, this also means the system is highly prone to shutdown under the aforementioned heavy load mutation conditions, severely affecting the user's work experience.

In response to the above problems, an electric work vehicle, an electric garden work vehicle, and an electric riding lawn mower are provided according to the embodiments of the present disclosure. Based on the plurality of control strategies applicable to the motor, various operating parameters associated with the motor are monitored. The load variation of the motor is determined according to an operating parameter among the operating parameters and/or a change in the parameter among the operating parameters. This approach enables precise and sensitive identification of sudden heavy-load changes in the motor, facilitates a rapid response to such heavy load mutations, allows for timely adjustment of the control strategy, and maintains the motor system in a normal operating state. Consequently, it enhances overall machine stability and work efficiency, and optimizes the user experience.

The embodiments of the present disclosure will be described in detail below with reference to the accompanying drawings. However, those of ordinary skill in the art can understand that many technical details are provided in the various embodiments of the present disclosure to facilitate a better understanding for the reader. Nevertheless, the technical solutions claimed in the present disclosure can be achieved even without these technical details and based on various changes and modifications to the following embodiments.

Based on the same objective, in an aspect, an embodiment of the present disclosure provides an electric work vehicle.

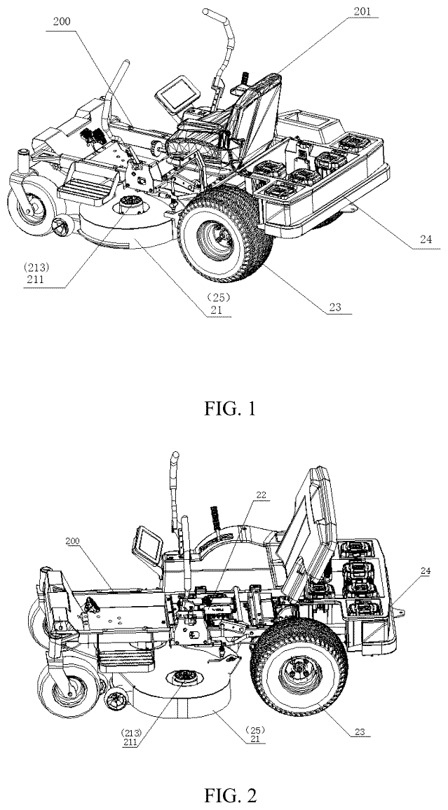

As shown in FIGS. 1 to 3, an electric work vehicle provided by one or more embodiments of the present disclosure includes: a frame 200, and a functional mechanism 21 and a drive mechanism 23 connected to the frame.

The frame 200 extends at least partially parallel to the front-rear direction. A carrying mechanism 201 may be disposed on the frame 200. The carrying mechanism 201 is configured to carry an operator of the electric work vehicle and may include at least one of a seat or a standing platform. FIG. 1 exemplarily shows only the case where the carrying mechanism 201 includes a seat. The seat or the standing platform is for the working user to sit or stand on. That is, the electric work vehicle may provide a riding work mode or a standing work mode. Furthermore, the structures of the seat and the standing platform may be flexibly switched, meaning the work mode of the electric work vehicle can be flexibly switched between the riding work mode and the standing work mode according to the actual needs of the working user. A hand-operated component may further be disposed on the frame 200. Based on the hand-operated component, the electric work vehicle can also provide a walk-behind work mode.

The functional mechanism 21 is attached to the frame 200 and includes a functional motor 211 and an output assembly driven by the functional motor 211 to perform a functional operation. It is understandable that the functional mechanism 21 may include a plurality of output assemblies, and the plurality of output assemblies are driven by at least one functional motor 211.

The drive mechanism 23 is configured to enable the electric work vehicle to travel within garden scenarios such as lawns, gardens, fences, greens, or other road surfaces. It includes a drive motor and a drive wheel driven by the drive motor. During the travel of the electric work vehicle, the functional mechanism 21 performs corresponding functional operations in an orderly manner under the control of the controller assembly 22.

As shown in FIG. 1, the electric work vehicle further includes a power system 24. The power system 24 is configured to supply power to the functional mechanism 21 and the drive mechanism 23.

The power system 24 is disposed on the frame 200 and detachably connected to the frame 200. The power system 24 includes a plurality of battery units. The plurality of battery units may be at least one of a first specification battery pack and a second specification battery pack. The specification differences between the first specification battery pack and the second specification battery pack include, but are not limited to, differences in battery pack capacity, voltage, internal resistance, weight, size, energy density, cell type, state of charge information, battery health status information, etc.

In some embodiments, the difference between the first specification battery pack and the second specification battery pack lies in the capacity. The capacity of the first specification battery pack is greater than the capacity of the second specification battery pack. The second specification battery pack is configured to power handheld garden tools. For example, the second specification battery pack may power garden tools such as grass trimmers, pruners, blowers, chain saws, etc. Additionally, the second specification battery pack may also power torque output tools such as electric drills, electric hammers, etc.; power sawing tools such as circular saws, jigsaws, reciprocating saws, etc.; or power grinding tools such as angle grinders, sanders, etc.

In some embodiments, the difference between the first specification battery pack and the second specification battery pack lies in the type of cells used. For example, the first specification battery pack and the second specification battery pack may use lithium iron phosphate cells and ternary lithium cells, respectively. In an implementation, the plurality of battery units in the power system may use nickel-cadmium battery cells, lead-acid battery cells, graphene cells, etc.

The use of at least one of the first specification battery pack and the second specification battery pack as the plurality of battery units in the power system 24 allows the electric work vehicle to be compatible with battery packs of different specifications. This meets the requirements for high-power work while also being adaptable to handheld electric garden tools, making the working methods of the operator more flexible.

In some embodiments, the functional mechanism 21 is configured to perform a mowing function. The functional mechanism 21 includes a mowing motor 213 and a mowing element driven by the mowing motor 213. The functional mechanism 21 may include one or more mowing elements, and the one or more mowing elements are driven by at least one mowing motor 213.

It is understandable that, in some embodiments, the output assembly in the functional mechanism 21 may be replaced with other functional components, such as components for snow removal, snow blowing, snow plowing, flushing, etc. Those skilled in the art should be able to adaptively replace various functional components without creative effort, all of which should fall within the protection scope of this embodiment.

In the electric work vehicle, a controller assembly 22 is provided corresponding to the functional mechanism 21. The controller assembly 22 is configured to control an operating state of the functional motor 211. As shown in FIG. 2, the controller assembly 22 may be integrated into the vehicle's integrated controller system of the electric work vehicle or may be independently arranged. The control chip used in the controller assembly 22 may be, for example, a Microcontroller Unit (MCU), an Advanced RISC Machine (ARM), etc.

The functional motor 211 has a plurality of operating parameters. When controlling the functional motor 211, the controller assembly 22 may use a plurality of control strategies respectively corresponding to the plurality of operating parameters.

The plurality of operating parameters of the functional motor 211 may include, for example, a rotational speed parameter, an electrical parameter, a power parameter, a torque parameter, and a PWM duty cycle parameter.

Corresponding to the aforementioned plurality of operating parameters, the plurality of control strategies applicable to the controller assembly 22 are respectively a rotational speed closed-loop control strategy, a current closed-loop control strategy, a power closed-loop control strategy, a torque closed-loop control strategy, and a PWM duty cycle open-loop control strategy.

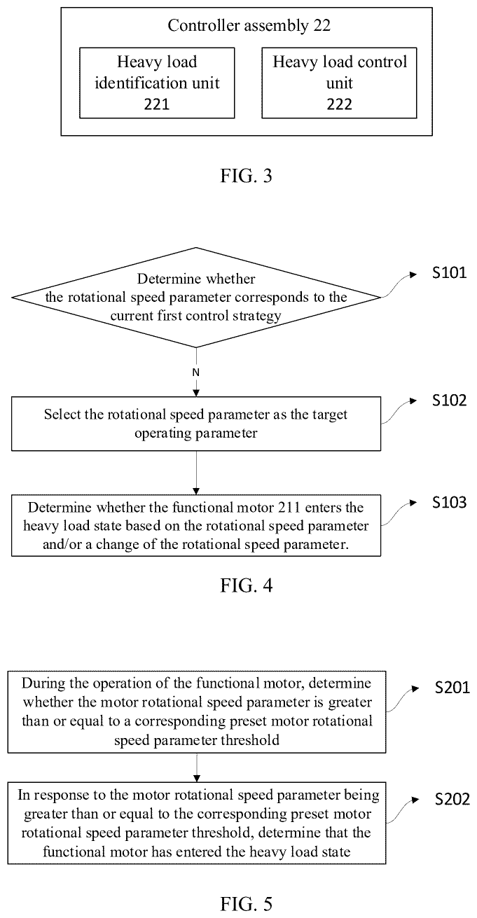

As shown in FIG. 3, in some embodiments, the controller assembly 22 includes a heavy load identification unit 221 and a heavy load control unit 222.

The heavy load identification unit 221 is configured to select a target operating parameter from the plurality of operating parameters, and determine whether the functional motor enters a heavy load state based on the target operating parameter and/or a change of the target operating parameter.

The target operating parameter does not correspond to a first control strategy currently adopted by the controller assembly 22 for the functional motor 211. For example, when the first control strategy currently adopted by the controller assembly 22 is the rotational speed closed-loop control strategy, an operating parameter other than the rotational speed parameter is selected as the target operating parameter. For example, if the first control strategy currently adopted by the controller assembly 22 is not the torque closed-loop control strategy, the torque parameter may be selected as the target operating parameter.

It is understandable that there are a plurality of operating parameters that do not correspond to the current first control strategy. The heavy load identification unit 221 may select one or more operating parameters as the target operating parameter(s) for monitoring.

When a heavy load mutation occurs during the operation of the functional motor 211, the load torque suddenly increases, and parameters such as motor speed, motor power, duty cycle, and related electrical parameters fluctuate and change correspondingly. The heavy load identification unit 221 monitors one or more operating parameters related to the functional motor 211 and can accurately and sensitively detect and identify the load mutation condition of the motor based on the one or more operating parameters and/or the change(s) in the one or more operating parameters, thereby determining whether the functional motor 211 enters the heavy load state.

In response to the heavy load identification unit 221 identifying that the functional motor 211 has entered the heavy load state, the heavy load control unit 222 in the controller assembly 22 may select a second control strategy to control the functional motor 211. For example, the functional motor 211 may be controlled to exit the heavy load state by reducing the duty cycle, reducing the speed, reducing or maintaining the current, reducing or maintaining the power, reducing or maintaining the torque, etc. The second control strategy may be the same as the first control strategy or different from the first control strategy.

In the electric work vehicle, the heavy load identification unit 221 in the controller assembly 22 monitors one or more operating parameters related to the functional motor 211 and determines whether the functional motor 211 enters the heavy load state based on the one or more operating parameters and/or the change(s) in the one or more operating parameters. In response to the determination that the functional motor 211 has entered the heavy load state, the heavy load control unit 222 in the controller assembly 22 selects an appropriate control strategy according to the situation and promptly adjusts the functional motor 211 to cause the functional motor 211 to exit the heavy load state. This approach enables precise and sensitive identification of heavy load mutations in the motor, further facilitates a rapid response to heavy load mutations, allows for timely adjustment of the control strategy, maintains the motor system in a normal operating state, thereby enhancing overall machine stability and work efficiency, and optimizing the user experience.

As shown in FIG. 4, in an electric work vehicle according to one or more embodiments of the present disclosure, the heavy load identification unit being configured to select a target operating parameter from the plurality of operating parameters and determine whether the functional motor enters a heavy load state based on the target operating parameter and/or a change of the target operating parameter includes the heavy load identification unit being configured to perform following steps S101 to S103.

S101: Determine whether the rotational speed parameter corresponds to the current first control strategy.

S102: In response to the rotational speed parameter not corresponding to the first control strategy, select the rotational speed parameter as the target operating parameter.

The control strategy corresponding to the rotational speed parameter is the rotational speed closed-loop control strategy. If the control strategy currently adopted by the controller assembly 22 for the functional motor 211 is a non-rotational-speed closed-loop control strategy, such as a current closed-loop control strategy, a power closed-loop control strategy, a torque closed-loop control strategy, or a PWM duty cycle open-loop control strategy, the heavy load identification unit 221 may select the rotational speed parameter as the target operating parameter.

The target operating parameter is determined based on the current first control strategy. If the first control strategy is a non-rotational-speed closed-loop control strategy, the heavy load identification unit 221 may select the rotational speed parameter as the target operating parameter.

S103: Determine whether the functional motor 211 enters the heavy load state based on the rotational speed parameter and/or a change of the rotational speed parameter. The heavy load identification unit 221 selects the rotational speed parameter as the target operating parameter and further monitors the rotational speed parameter. The change of the rotational speed parameter may include, for example, a difference obtained by comparing the rotational speed parameter at different time instants, a rate of increase or decrease of the rotational speed parameter, etc.

As shown in FIG. 5, in an electric work vehicle according to one or more embodiments of the present disclosure, the rotational speed parameter includes a motor rotational speed parameter. The method for the heavy load identification unit 221 to determine whether the functional motor 211 enters the heavy load state based on the rotational speed parameter and/or the change of the rotational speed parameter includes following steps S201 to S202.

At step S201, during the operation of the functional motor, it is determined whether the motor rotational speed parameter is greater than or equal to a corresponding preset motor rotational speed parameter threshold.

The motor rotational speed parameter includes a motor rotational speed, a motor rotational speed difference, and a motor rotational speed rate of change of the functional motor 211. The preset motor rotational speed parameter threshold corresponding to the motor rotational speed is a motor rotational speed threshold. The preset motor rotational speed parameter threshold corresponding to the motor rotational speed difference is a motor rotational speed difference threshold. The preset motor rotational speed parameter threshold corresponding to the motor rotational speed rate of change is a motor rotational speed rate-of-change threshold.

The motor rotational speed may be acquired by sampling a rotational speed of the functional motor 211.

The motor rotational speed difference refers to a difference in the motor rotational speed of the functional motor 211 at two adjacent moments. In some embodiments, the motor rotational speed difference ΔNₖ may be obtained by obtaining the difference between the motor rotational speed Nₖ acquired at the current moment and the motor rotational speed Nk−1 acquired at the previous moment. The motor rotational speed difference may be an absolute value, meaning the obtained ΔNₖ is positive, thereby facilitating subsequent calculations.

The motor rotational speed rate of change characterizes the trend of change of the motor rotational speed of the functional motor at predetermined moments. The motor rotational speed rate of change may include the first derivative and/or the second derivative of the motor rotational speed as a function of time.

In some embodiments, motor rotational speeds acquired at a plurality of moments may be fitted to obtain a motor rotational speed curve, and the slope of the motor rotational speed curve may be determined as the motor rotational speed rate of change. The slope of the motor rotational speed curve is the first derivative of the motor rotational speed. In other embodiments, the slope of the slope of the motor rotational speed curve may be determined as the motor rotational speed rate of change. The slope of the slope of the motor rotational speed curve is the second derivative of the motor rotational speed.

In some embodiments, the method for the heavy load identification unit 221 to determine whether the motor rotational speed parameter is greater than or equal to the corresponding preset motor rotational speed parameter threshold includes:

acquiring at least one motor rotational speed parameter and determining whether the at least one motor rotational speed parameter is smaller than or equal to the corresponding preset motor rotational speed parameter threshold.

The heavy load identification unit 221 may acquire one motor rotational speed parameter, such as the motor rotational speed, compare the motor rotational speed parameter with the corresponding preset motor rotational speed parameter threshold, such as the motor rotational speed threshold, and determine the magnitude relationship between the motor rotational speed parameter and the corresponding motor rotational speed parameter threshold.

The heavy load identification unit 221 may acquire two motor rotational speed parameters, such as the motor rotational speed and the motor rotational speed difference, compare the two motor rotational speed parameters with corresponding two preset motor rotational speed parameter thresholds, such as the motor rotational speed threshold and the motor rotational speed difference threshold, and determine the magnitude relationship between the two motor rotational speed parameters and their respective preset motor rotational speed parameter thresholds.

The heavy load identification unit 221 may acquire the aforementioned three motor rotational speed parameters, compare the three motor rotational speed parameters with the corresponding three preset motor rotational speed parameter thresholds, and determine the magnitude relationship between the three motor rotational speed parameters and their respective preset motor rotational speed parameter thresholds.

At step S202, in response to the motor rotational speed parameter being greater than or equal to the corresponding preset motor rotational speed parameter threshold, it is determined that the functional motor has entered the heavy load state.

It should be noted that the heavy load identification unit 221 monitors and analyzes the corresponding operating parameters during the operation of the functional motor 211. The term “operation process” here refers to the stable execution of corresponding functional operations, excluding phases where operating parameters change due to active user control. Active user control of the functional motor 211, at phases such as a rotational speed gear switching phase, a speed increase phase at the beginning of operation, and a speed decrease phase near the end of operation, etc., causes significant changes in the operation of the functional motor 211. Therefore, the operation process described in the embodiments of the present disclosure does not include the aforementioned phases.

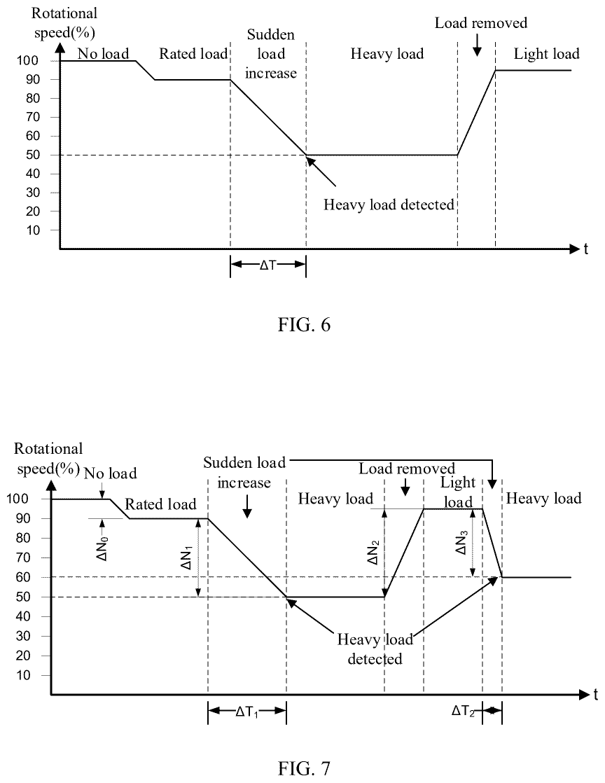

The motor rotational speed is taken as an example, as shown in FIG. 6, which is a schematic diagram of determining a heavy load mutation based on a motor rotational speed threshold during the operation of the functional motor 211.

The heavy load identification unit 221 may determine whether the current motor rotational speed Nₖ of the functional motor 211 is smaller than or equal to a corresponding motor rotational speed threshold Nr. In response to the determination that the current motor rotational speed Nₖ of the functional motor 211 is smaller than or equal to the corresponding motor rotational speed threshold N_{T}, it is determined that the functional motor 211 has entered the heavy load state.

Furthermore, a time limit condition may be added. in response to the current rotational speed Nₖ being smaller than or equal to the preset rotational speed threshold N_{T} within a preset time interval ΔT, which may be, for example, 0.01 to 10 seconds, it is determined that the load has entered a heavy load operating region.

Further, the aforementioned time limit may be segmented by presetting X ΔTₓ time intervals. For example, X=4, ΔT₀=10 seconds, ΔT₁=1 second, ΔT₂=0.1 seconds, ΔT₃=0.01 seconds. When the rotational speed Nₖ is smaller than or equal to N_{T0} within ΔT₀ (10 seconds), and/or the current rotational speed Nₖ is smaller than or equal to N_{T1} within ΔT₁ (1 second), and/or the current rotational speed Nₖ is smaller than or equal to N_{T2} within ΔT₂ (0.1 seconds), and/or the current rotational speed Nₖ is smaller than or equal to N_{T3} within ΔT₃ (0.01 seconds), it is determined that the load has entered the heavy load operating region. N_{T0}˜N_{T3} satisfy the relational expression (1): N_{T0}≥N_{T1}≥N_{T2}≥N_{T3}, or N_{T0}≤N_{T1}≤N_{T2}≤N_{T3}.

It is understandable that the functional motor 211 is set with different rotational speed gears. For example, under no-load conditions, the low-gear rotational speed is 2800 RPM, the medium-gear rotational speed is 3000 RPM, and the high-gear rotational speed is 3200 RPM. The motor rotational speed threshold may be set for different rotational speed gears and may be set as an absolute value or a proportional value.

For the case where the threshold is set as an absolute value, examples are as follows.
(1) The rotational speed thresholds for all gears are the same within the same time interval condition.

The low-gear rotational speed threshold is 1500 RPM, the medium-gear rotational speed threshold is 1500 RPM, and the high-gear rotational speed threshold is 1500 RPM. After adding the time limit condition, the rotational speed thresholds for the same gear under different time intervals are shown in Table 1 below.

TABLE 1

| Rotational Speed Thresholds | ΔT₀ | ΔT₁ | ΔT₂ | ΔT₃ |
|---|---|---|---|---|
| Low-Gear NT | 1900 | 1500 | 1200 | 1000 |
| Medium-Gear NT | 1900 | 1500 | 1200 | 1000 |
| High-Gear NT | 1900 | 1500 | 1200 | 1000 |

(2) The rotational speed thresholds for different gears are different under the same time interval condition:

The rotational speed threshold is positively correlated with gears. The low-gear rotational speed threshold is 1300 RPM, the medium-gear rotational speed threshold is 1400 RPM, and the high-gear rotational speed threshold is 1500 RPM. After adding the time limit condition, the rotational speed thresholds for the same gear in different time intervals are shown in Table 2 below.

TABLE 2

| Rotational Speed Thresholds | ΔT₀ | ΔT₁ | ΔT₂ | ΔT₃ |
|---|---|---|---|---|
| Low-Gear NT | 1600 | 1300 | 1100 | 1000 |
| Medium-Gear NT | 1700 | 1400 | 1200 | 1100 |
| High-Gear NT | 1800 | 1500 | 1300 | 1200 |

In another embodiment, the rotational speed threshold is negatively correlated with gears. The low-gear rotational speed threshold is 1550 RPM, the medium-gear rotational speed threshold is 1450 RPM, and the high-gear rotational speed threshold is 1350 RPM. After adding the time limit condition, the rotational speed thresholds for the same gear in different time intervals are shown in Table 3 below.

TABLE 3

| Rotational Speed Thresholds | ΔT₀ | ΔT₁ | ΔT₂ | ΔT₃ |
|---|---|---|---|---|
| Low-Gear NT | 1750 | 1550 | 1350 | 1150 |
| Medium-Gear NT | 1650 | 1450 | 1250 | 1050 |
| High-Gear NT | 1550 | 1350 | 1150 | 950 |

Examples for the case where the threshold is set as a proportional value are as follows.
(1) The proportional value is the same for all gears under the same time interval condition. The proportional value is fixed at 50%. The low-gear rotational speed threshold is 1400 RPM, the medium-gear rotational speed threshold is 1500 RPM, and the high-gear rotational speed threshold is 1600 RPM. After adding the time limit condition, the rotational speed thresholds for the same gear in different time intervals are shown in Table 4 below.

TABLE 4

| Rotational Speed Thresholds | ΔT₀ | ΔT₁ | ΔT₂ | ΔT₃ |
|---|---|---|---|---|
| Low-Gear NT | 1540 | 1400 | 1260 | 1120 |
| Medium-Gear NT | 1650 | 1500 | 1350 | 1200 |
| High-Gear NT | 1760 | 1600 | 1440 | 1280 |

(2) The proportional values for different gears are different under the same time interval condition:

The proportional value is positively correlated with the gear. The low-gear proportional value is 45%, with a low-gear rotational speed threshold of 1260 RPM; the medium-gear proportional value is 50%, with a medium-gear rotational speed threshold of 1500 RPM; the high-gear proportional value is 55%, with a high-gear rotational speed threshold of 1760 RPM. After adding the time limit condition, the rotational speed thresholds for the same gear in different time intervals are shown in Table 5 below.

TABLE 5

| Rotational Speed Thresholds | ΔT₀ | ΔT₁ | ΔT₂ | ΔT₃ |
|---|---|---|---|---|
| Low-Gear NT | 1400 | 1260 | 1120 | 980 |
| Medium-Gear NT | 1650 | 1500 | 1350 | 1200 |
| High-Gear NT | 1920 | 1760 | 1600 | 1440 |

The proportional value is negatively correlated with the gear. The low-gear proportional value is 55%, with a low-gear rotational speed threshold of 1540 RPM; the medium-gear proportional value is 50%, with a medium-gear rotational speed threshold of 1500 RPM; the high-gear proportional value is 45%, with a high-gear rotational speed threshold of 1440 RPM. After adding the time limit condition, the rotational speed thresholds for the same gear in different time intervals are shown in Table 6 below.

TABLE 6

| Rotational Speed Thresholds | ΔT₀ | ΔT₁ | ΔT₂ | ΔT₃ |
|---|---|---|---|---|
| Low-Gear NT | 1680 | 1540 | 1400 | 1260 |
| Medium-Gear NT | 1650 | 1500 | 1350 | 1200 |
| High-Gear NT | 1600 | 1440 | 1280 | 1120 |

The motor rotational speed difference is taken as an example, as shown in FIG. 7, which is a schematic diagram of determining a heavy load mutation based on a motor rotational speed difference threshold during the operation of the functional motor 211.

The motor rotational speed difference is obtained by calculating the difference between the rotational speed Nₖ acquired at the current moment and the rotational speed Nₖ₋₁ acquired at the previous moment, and is denoted by ΔNₖ. The rotational speed difference may be an absolute value, meaning the obtained ΔNₖ is positive, thereby facilitating subsequent calculations.

The heavy load identification unit 221 may calculate the difference between the motor rotational speed Nₖ acquired at the current moment and the motor rotational speed Nₖ₋₁ acquired at the previous moment to obtain the motor rotational speed difference ΔNₖ. In response to ΔNₖ being smaller than or equal to a preset motor rotational speed difference threshold ΔN_{T}, it is determined that the functional motor 211 has entered the heavy load state.

Furthermore, a time limit condition can be added. In response to the current rotational speed difference ΔNₖ being smaller than or equal to the rotational speed difference threshold ΔN_{T} within a preset time interval ΔT, which may be for example 0.01 to 10 seconds, it is determined that the load has entered the heavy load operating region.

Further, the aforementioned time limit may be segmented by presetting X ΔTₓ time intervals. For example, X=4, ΔT₀=10 seconds, ΔT₁=1 second, ΔT₂=0.1 seconds, ΔT₃=0.01 seconds. The difference between the rotational speed Nₖ acquired at the current moment and the rotational speed Ng acquired at a moment ΔT₀ (10 seconds) earlier is calculated to obtain ΔN_{kg}; the difference between Nₖ and the rotational speed Nh obtained at a moment ΔT₁ (1 second) earlier is calculated to obtain ΔNₖₕ; the difference between Nₖ and the rotational speed Nᵢ obtained at a moment ΔT₂ (0.1 seconds) earlier is calculated to obtain ΔNₖᵢ; the difference between Nₖ and the rotational speed Nj obtained at a moment ΔT₃ (0.01 seconds) earlier is calculated to obtain ΔNₖⱼ. If ΔN_{kg} is smaller than or equal to the preset rotational speed difference threshold ΔN_{T0}, and/or ΔNₖₕ is smaller than or equal to the preset rotational speed difference threshold ΔN_{T1}, and/or ΔNₖᵢ is smaller than or equal to the preset rotational speed difference threshold ΔN_{T2}, and/or ΔNₖⱼ is smaller than or equal to the preset rotational speed difference threshold ΔN_{T3}, then it is determined that the load has entered the heavy load operating region. ΔN_{T0}˜ΔN_{T3} satisfy relational expression (2): ΔN_{T0}≥ΔN_{T1}≥ΔN_{T2}≥ΔN_{T3}.

The motor rotational speed threshold may be set for different rotational speed gears and may be set as an absolute value or a proportional value.

Examples for the case where the threshold is set as an absolute value are as follows.
(1) The thresholds for the rotational speed difference are the same for respective gears under the same time interval condition. For example, the preset fixed difference is 1500 RPM. After adding the time limit condition, the rotational speed difference thresholds for the same gear in different time intervals are shown in Table 7 below.

TABLE 7

| Rotational Speed Difference Thresholds | ΔT₀ | ΔT₁ | ΔT₂ | ΔT₃ |
|---|---|---|---|---|
| Low-Gear ΔNT | 1900 | 1500 | 1200 | 1000 |
| Medium-Gear ΔNT | 1900 | 1500 | 1200 | 1000 |
| High-Gear ΔNT | 1900 | 1500 | 1200 | 1000 |

(2) The thresholds for the rotational speed difference are not the same for respective gears under the same time interval condition:

The rotational speed difference threshold is positively correlated to the gear. The low-gear rotational speed difference is 1400 RPM, the medium-gear rotational speed difference is 1500 RPM, and the high-gear rotational speed difference is 1600 RPM. After adding the time limit condition, the rotational speed difference thresholds for the same gear in different time intervals are shown in Table 8 below.

TABLE 8

| Rotational Speed Difference Thresholds | ΔT₀ | ΔT₁ | ΔT₂ | ΔT₃ |
|---|---|---|---|---|
| Low-Gear ΔNT | 1600 | 1300 | 1100 | 1000 |
| Medium-Gear ΔNT | 1700 | 1400 | 1200 | 1100 |
| High-Gear ΔNT | 1800 | 1500 | 1300 | 1200 |

The rotational speed difference threshold is negatively correlated to the gear. The low-gear rotational speed difference is 1550 RPM, the medium-gear rotational speed difference is 1500 RPM, and the high-gear rotational speed difference is 1450 RPM. After adding the time limit condition, the rotational speed difference thresholds for the same gear in different time intervals are shown in Table 9 below.

TABLE 9

| Rotational Speed Difference Thresholds | ΔT₀ | ΔT₁ | ΔT₂ | ΔT₃ |
|---|---|---|---|---|
| Low-Gear ΔNT | 1850 | 1550 | 1350 | 1250 |
| Medium-Gear ΔNT | 1800 | 1500 | 1300 | 1200 |
| High-Gear ΔNT | 1750 | 1450 | 1250 | 1150 |

Examples for the case where the threshold is set as a proportional value are as follows
(1) The same proportional value is set for respective gears under the same time interval condition: The ratio is fixed at 50%. After adding the time limit condition, the rotational speed difference thresholds for the same gear in different time intervals are shown in Table 10 below.

TABLE 10

| Rotational Speed Difference Thresholds | ΔT₀ | ΔT₁ | ΔT₂ | ΔT₃ |
|---|---|---|---|---|
| Low-Gear ΔNT | 1680 | 1400 | 1260 | 1120 |
| Medium-Gear ΔNT | 1800 | 1500 | 1350 | 1200 |
| High-Gear ΔNT | 1920 | 1600 | 1440 | 1280 |

(2) The proportional values for different gears are different under the same time interval condition:

The proportional value is positively correlated with the gear—The low-gear proportional value is 45%, with a low-gear rotational speed difference of 1260 RPM; the medium-gear proportional value is 50%, with a medium-gear rotational speed difference of 1500 RPM; the high-gear proportional value is 55%, with a high-gear rotational speed difference of 1760 RPM. After adding the time limit condition, the rotational speed difference thresholds for the same gear in different time intervals are shown in Table 11 below.

TABLE 11

| Rotational Speed Difference Thresholds | ΔT₀ | ΔT₁ | ΔT₂ | ΔT₃ |
|---|---|---|---|---|
| Low-Gear ΔNT | 1400 | 1260 | 1120 | 980 |
| Medium-Gear ΔNT | 1650 | 1500 | 1350 | 1200 |
| High-Gear ΔNT | 1920 | 1760 | 1600 | 1440 |

The proportional value is negatively correlated with the gear—The low-gear proportional value is 55%, with a low-gear rotational speed difference of 1540 RPM; the medium-gear proportional value is 50%, with a medium-gear rotational speed difference of 1500 RPM; the high-gear ratio is 45%, with a high-gear rotational speed difference of 1440 RPM. After adding the time limit condition, the rotational speed difference thresholds for the same gear in different time intervals are shown in Table 12 below.

TABLE 12

| Rotational Speed Difference Thresholds | ΔT₀ | ΔT₁ | ΔT₂ | ΔT₃ |
|---|---|---|---|---|
| Low-Gear ΔNT | 1680 | 1540 | 1400 | 1260 |
| Medium-Gear ΔNT | 1650 | 1500 | 1350 | 1200 |
| High-Gear ΔNT | 1600 | 1440 | 1280 | 1120 |

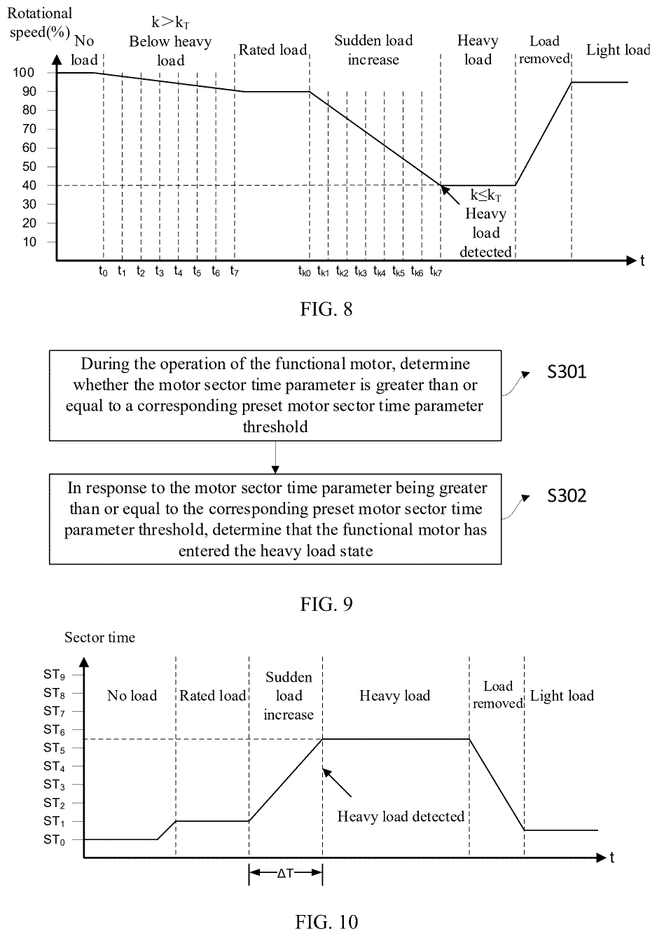

The motor rotational speed rate of change is taken as an example, as shown in FIG. 8, which is a schematic diagram of determining a heavy load mutation based on a motor rotational speed rate-of-change threshold during the operation of the functional motor 211.

The heavy load identification unit 221 may determine whether the current motor rotational speed rate of change of the functional motor 211 is smaller than or equal to a corresponding preset motor rotational speed rate-of-change threshold. In response to the current motor rotational speed rate of change of the functional motor 211 being smaller than or equal to a corresponding preset motor rotational speed rate-of-change threshold, it is determined that the functional motor 211 has entered the heavy load state.

For example, the heavy load identification unit 221 may acquire motor rotational speeds N₀, N₁, N₂ . . . . Nₖ at time instants t₀, t₁, t₂ . . . tₖ, perform linear fitting on N₀, N₁, N₂ . . . . Nₖ, and obtain the corresponding curve slope k. The calculation equation is: k=(Etn−Et*En)/[Et²−(Et)²].

Etn represents the mathematical expectation of the product of a sampling time instant t and a rotational speed, Et represents the mathematical expectation of the sampling time instant t, En represents the mathematical expectation of the rotational speed, Et² represents the mathematical expectation of the square of the sampling time t, and (Et)² represents the square of the mathematical expectation of the sampling time instant t.

Assuming Δt₀=t₁−t₀, Δt₁=t₂−t₁ . . . , Δtₖ=tₖ₊₁−tₖ, for the convenience of software calculation, it is generally designed that Δt₀=Δt₁= . . . =Δtₖ. Therefore, the above equation may be simplified to: k=[n*Σ(t*n)−Σt*Ση]/[n*Σt²−Σt*Σt], where n is a positive integer. To further simplify the calculation process and reduce software computational overhead, n in the simplified formula can be set to 2^{m}, where m is a positive integer.

When the slope k is smaller than or equal to the preset slope threshold k_{T}, it is determined that the load has entered the heavy load operating region.

Furthermore, to achieve better determination results, a rotational speed filtering method may be added based on the above. The main filtering methods added include: fixed window filtering, sliding window filtering, arithmetic mean filtering, extreme value removal mean filtering, median filtering, etc. Different algorithms can be combined to obtain, for example, fixed window arithmetic mean filtering, sliding window median filtering, etc. Thus, the aforementioned rotational speeds N₀, N₁, N₂ . . . . Nₖ are values obtained after filtering. In this way, when using fixed window filtering series methods, the values of Δt₀, Δt₁, Δt₂ . . . Δtₖ are X rotational speed sampling intervals. For example, if the rotational speed is acquired every 1 ms and X=8 is preset, a filtered value is calculated every 8 ms, and Δt₀=Δt₁=Δt₂=Δtₖ=8 ms; when using sliding window filtering series methods under the same preset conditions, Δt₀=Δt₁=Δt₂=Δtₖ=1 ms. After each fixed window filtering or sliding window filtering is completed, formula (3) is used to calculate the slope k, which is the first derivative value of the motor rotational speed with respect to unit time.

Furthermore, if the rotational speed range of the motor operation is relatively large, the values of Δt₀, Δt₁, Δt₂ . . . Δtₖ may be dynamically adjusted according to the current motor rotational speed. This is because if Δt₀, Δt₁, Δt₂ . . . Δtₖ is too small, when the motor rotational speed is relatively low, the rotational speed sampling frequency is much higher than the motor rotational speed filtering frequency, and the rotational speeds sampled at different moments might be the same, unnecessarily consuming computing resources, or when the motor rotational speed fluctuates on a small time scale, it can easily interfere with the calculation results, causing misjudgment. If Δt₀, Δt₁, Δt₂ . . . Δtₖ is too large, when the motor rotational speed is relatively high, the rotational speed sampling frequency is much lower than the actual rotational speed change frequency, resulting in large fluctuations between the obtained data, or it might be that the actual rotational speed change rate already meets the application requirements, but the actual calculation and judgment fail to identify it. Therefore, the adjustment rule for Δt₀, Δt₁, Δt₂ . . . Δtₖ is: when the rotational speed is relatively high, the time interval is relatively small; when the rotational speed is relatively low, the time interval is relatively large. There are three methods for adjusting this time interval. The first is to adjust the aforementioned 1 ms rotational speed sampling interval, for example, adjust it to 0.5 ms or 2 ms. In this case, under fixed window filtering series methods, Δt₀=Δt₁=Δt₂=Δtₖ=4 ms or 16 ms; under sliding window filtering series methods, Δt₀=Δt₁=Δt₂=Δtₖ=0.5 ms or 2 ms. The second method is to adjust the window length (number of sample points X), for example, adjust it to X=4 or X=16. In this case, under fixed window filtering series methods, Δt₀=Δt₁=Δt₂=Δtₖ=4 ms or 16 ms; under sliding window filtering series methods, Δt₀=Δt₁=Δt₂=Δtₖ still equals 1 ms. The third method is to simultaneously adjust the rotational speed sampling interval and the window length (number of sample points X). Additionally, since the speed drop caused by a sudden load change is also relatively fast, during this process, Δt₀, Δt₁, Δt₂ . . . Δtₖ will not be adjusted; adjustment only occurs after the rotational speed has stabilized for a period of time.

Furthermore, after each fixed window filtering or sliding window filtering, the slope is calculated again, to obtain a set of k₀, k₁, k₂ . . . kₖ. Linear fitting is performed again on k₀, k₁, k₂ . . . kₖ to obtain the corresponding slope k′. The calculation equation is: k′=(Etk−Et*Ek)/[Et²−(Et)²].

Herein, Etk represents the mathematical expectation of the product of the time instant t of each acquired rotational speed slope and the rotational speed slope, Et represents the mathematical expectation of the time instant t of each acquired rotational speed slope, Ek represents the mathematical expectation of the rotational speed slope, Et² represents the mathematical expectation of the square of the time instant t of each acquired rotational speed slope, and (Et)² represents the square of the mathematical expectation of the sampling time instant t.

Since the time intervals for acquisitions of k₀, k₁, k₂ . . . kₖ are equal, Δt′₀, Δt′₁, Δt′₂ . . . Δt′ₖ are also equal. Therefore, the above equation may be simplified to: k′=[n′*Σ(t*k)−Σt*Σk]/[n′*Σt²−Σt*Σt], where n′ is a positive integer. To further simplify the calculation process and reduce software computational overhead, n′ in the simplified equation may be set to 2^{m′}, where m′ is a positive integer. When the slope k′ is smaller than or equal to the preset slope threshold k′_{T}, it is determined that the load has entered the heavy load operating region. Here, the slope k′ is the second derivative of the motor rotational speed with respect to unit time.

For the case where the first derivative of the motor rotational speed is determined as the motor rotational speed rate of change, the heavy load identification unit 221 compares the motor rotational speed rate of change with the corresponding preset rotational speed first derivative threshold. If the motor rotational speed rate of change is smaller than or equal to the preset rotational speed first derivative threshold, it may be determined that the functional motor 211 has entered the heavy load state.

For the case where the second derivative of the motor rotational speed is determined as the motor rotational speed rate of change, the heavy load identification unit 221 compares the motor rotational speed rate of change with the corresponding preset rotational speed second derivative threshold. If the motor rotational speed rate of change is smaller than or equal to the preset rotational speed second derivative threshold, it may be determined that the functional motor 211 has entered the heavy load state.

In some embodiments, the heavy load identification unit 221 may acquire a plurality of motor rotational speed parameters and compare the plurality of motor rotational speed parameters with their respective preset motor rotational speed parameter thresholds to determine whether the plurality of motor rotational speed parameters are smaller than or equal to the respective preset motor rotational speed parameter thresholds.

For example, the motor rotational speed is compared with the corresponding preset motor rotational speed threshold, and the motor rotational speed difference is compared with the corresponding preset motor rotational speed difference threshold. In response to the motor rotational speed being smaller than or equal to the preset motor rotational speed threshold, and the motor rotational speed difference being smaller than or equal to the preset motor rotational speed difference threshold, it is determined that the functional motor 211 has entered the heavy load state.

For example, the motor rotational speed, the motor rotational speed difference, and the motor rotational speed rate of change are compared with the corresponding preset motor rotational speed threshold, preset motor rotational speed difference threshold, and preset motor rotational speed rate-of-change threshold, respectively. In response to the motor rotational speed, the motor rotational speed difference, and the motor rotational speed rate of change all being smaller than or equal to the corresponding preset motor rotational speed threshold, preset motor rotational speed difference threshold, and preset motor rotational speed rate-of-change threshold, respectively, it may be determined that the functional motor 211 has entered the heavy load state.

As shown in FIG. 9, in an electric work vehicle according to one or more embodiments of the present disclosure, the rotational speed parameter includes a motor sector time parameter. The method for the heavy load identification unit 221 to determine whether the functional motor enters the heavy load state based on the rotational speed parameter and/or the change of the rotational speed parameter includes the following steps S301 to S302.

At step S301, during the operation of the functional motor, it is determined whether the motor sector time parameter is greater than or equal to a corresponding preset motor sector time parameter threshold.

The motor sector time parameter includes a motor sector time, a motor sector time difference, and a motor sector time rate of change of the functional motor 211. The corresponding preset motor sector time parameter thresholds include a motor sector time threshold, a motor sector time difference threshold, and a motor sector time rate-of-change threshold, respectively.

The electrical cycle of the functional motor 211 includes a plurality of sectors. The motor sector time refers to the duration of each sector. The electrical cycle of the motor (360°) may be divided into a plurality of sectors. Generally, the electrical cycle is evenly divided into 6 sectors, each spanning 60 electrical degrees. The motor sector time refers to the motor operating duration for each sector. Taking a square-wave driven brushless DC motor as an example, when the functional motor 211 runs steadily, the time for respective sectors (Δt₀, Δt₁, Δt₂, Δt₃, Δt₄, Δt₅) of the 360° electrical cycle is relatively close to each other. However, when the load changes drastically, the corresponding motor sector time also undergoes a sudden change.

The motor sector time difference refers to the difference between the motor sector time at two adjacent moments. In some embodiments, the heavy load identification unit 221 may calculate the difference between the sector time Sₖ acquired at the current moment and the sector time Sₖ₋₁ acquired at the previous moment to obtain ΔSₖ. The sector time difference may be an absolute value, meaning the obtained ΔSₖ is positive, thereby facilitating subsequent calculations.

The motor sector time rate of change characterizes the trend of change of the motor sector time. The motor sector time rate of change may include the first derivative and/or the second derivative of the motor sector time as a function of time.

In some embodiments, the motor sector time acquired at a plurality of moments may be fitted to obtain a motor sector time curve, and the slope of the motor sector time curve may be taken as the motor sector time rate of change. The slope of the motor sector time curve is the first derivative of the motor sector time. In other embodiments, the slope of the slope of the motor sector time curve may be taken as the motor sector time rate of change. The slope of the slope of the motor sector time curve is the second derivative of the motor sector time.

In some embodiments, the method for the heavy load identification unit 221 to determine whether the motor sector time parameter is greater than or equal to the corresponding preset motor sector time parameter threshold includes:

Acquiring at least one motor sector time parameter and determining whether the at least one motor sector time parameter is greater than or equal to the corresponding preset motor sector time parameter threshold.

The heavy load identification unit 221 may acquire one motor sector time parameter, such as the motor sector time, compare this motor sector time parameter with the corresponding preset motor sector time parameter threshold, such as the motor sector time threshold, and determine the magnitude relationship between the motor sector time parameter and the corresponding motor sector time parameter threshold.

The heavy load identification unit 221 may acquire two motor sector time parameters, such as the motor sector time and the motor sector time difference, compare these two motor sector time parameters with the corresponding two preset motor sector time parameter thresholds, such as the motor sector time threshold and the motor sector time difference threshold, and determine the magnitude relationship between the two motor sector time parameters and their respective preset motor sector time parameter thresholds.

The heavy load identification unit 221 may acquire the aforementioned three motor sector time parameters, compare the three motor sector time parameters with the corresponding three preset motor sector time parameter thresholds, and determine the magnitude relationship between the three motor sector time parameters and their respective preset motor sector time parameter thresholds.

At step S302, in response to the motor sector time parameter being greater than or equal to the corresponding preset motor sector time parameter threshold, it is determined that the functional motor has entered the heavy load state.

The motor sector time is taken as an example, as shown in FIG. 10, which is a schematic diagram of determining a heavy load mutation based on a motor sector time threshold during the operation of the functional motor 211.

The heavy load identification unit 221 may determine whether the current sector time Sₖ is greater than or equal to a preset sector time threshold S_{T}. In response to the current sector time Sₖ being greater than or equal to the preset sector time threshold S_{T}, it is determined that the functional motor 211 has entered the heavy load state.

Furthermore, a time limit condition may be added. In response to the current sector time Sₖ being greater than or equal to the preset sector time threshold S_{T} within a preset time interval ΔT, which may be for example, 0.01 to 10 seconds, it is determined that the load has entered the heavy load operating region.

Further, the aforementioned time limit may be segmented by presetting X ΔTₓ time intervals. For example, setting X=4, ΔT₀=10 seconds, ΔT₁=1 second, ΔT₂=0.1 seconds, ΔT₃=0.01 seconds. In response to the current sector time Sₖ being greater than or equal to S_{T0} within ΔT₀ (10 seconds), and/or the current sector time Sₖ being greater than or equal to S_{T1} within ΔT₁ (1 second), and/or the current sector time Sₖ being greater than or equal to S_{T2} within ΔT₂ (0.1 seconds), and/or the current sector time Sₖ being greater than or equal to S_{T3} within ΔT₃ (0.01 seconds), it is determined that the load has entered the heavy load operating region. ST₀˜S_{T3} satisfy relational expression (5): S_{T0}≤S_{T1}≤S_{T2}≤S_{T3}, or ST₀≥S_{T1}≥S_{T2}≥S_{T3}.

The motor sector time threshold may be set for different rotational speed gears and may be set as an absolute value or a proportional value.

Examples for the case where the threshold is set as an absolute value are as follows.
(1) The sector time thresholds are the same for all gears under the same time interval condition.

The low-gear sector time threshold is 6667 (μs)/p, the medium-gear sector time threshold is 6667/p, and the high-gear sector time threshold is 6667/p, where p is the number of motor pole pairs. After adding the time limit condition, the motor sector time thresholds for the same gear in different time intervals are shown in Table 13 below.

TABLE 13

| Sector Threshold (μs) | ΔT₀ | ΔT₁ | ΔT₂ | ΔT₃ |
|---|---|---|---|---|
| Low-Gear | 5263/p | 6667/p | 8333/p | 10000/p |
| Medium-Gear | 5263/p | 6667/p | 8333/p | 10000/p |
| High-Gear | 5263/p | 6667/p | 8333/p | 10000/p |

(2) The sector time thresholds are different for respective gears under the same time interval condition.

The sector time threshold is negatively correlated with the gear. The low-gear sector time threshold is 7692/p, the medium-gear sector time threshold is 7143/p, and the high-gear sector time threshold is 6667/p, where p is the number of motor pole pairs. After adding the time limit condition, the sector time thresholds for the same gear in different time intervals are shown in Table 14 below.

TABLE 14

| Sector Threshold (μs) | ΔT₀ | ΔT₁ | ΔT₂ | ΔT₃ |
|---|---|---|---|---|
| Low-Gear | 6250/p | 7692/p | 9091/p | 10000/p |
| Medium-Gear | 5882/p | 7143/p | 8333/p | 9091/p |
| High-Gear | 5556/p | 6667/p | 7692/p | 8333/p |

In another embodiment, the sector time threshold is positively correlated with the gear. The low-gear sector time threshold is 6452/p, the medium-gear sector time threshold is 6897/p, and the high-gear sector time threshold is 7407/p, where p is the number of motor pole pairs. After adding the time limit condition, the sector time thresholds for the same gear under different time intervals are shown in Table 15 below.

TABLE 15

| Sector Threshold (μs) | ΔT₀ | ΔT₁ | ΔT₂ | ΔT₃ |
|---|---|---|---|---|
| Low-Gear | 5714/p | 6452/p | 7407/p | 8696/p |
| Medium-Gear | 6061/p | 6897/p | 8000/p | 9524/p |
| High-Gear | 6452/p | 7407/p | 8696/p | 10526/p |

Examples for the case where the threshold is set as a proportional value are as follows.
(1) The proportional values are the same for all gears under the same time interval condition.

The proportional value is fixed at 50%. The low-gear sector time threshold is 7143/p, the medium-gear sector time threshold is 6667/p, and the high-gear sector time threshold is 6250/p, where p is the number of motor pole pairs. After adding the time limit condition, the sector time thresholds for the same gear in different time intervals are shown in Table 16 below.

TABLE 16

| Sector Threshold (μs) | ΔT₀ | ΔT₁ | ΔT₂ | ΔT₃ |
|---|---|---|---|---|
| Low-Gear | 6494/p | 7143/p | 7937/p | 8929/p |
| Medium-Gear | 6061/p | 6667/p | 7407/p | 8333/p |
| High-Gear | 5682/p | 6250/p | 6944/p | 7813/p |

(2) The proportional values for different gears are different under the same time interval condition:

The proportional value is positively correlated with the gear. The low-gear proportional value is 45%, with a low-gear sector time threshold of 7937/p; the medium-gear proportional value is 50%, with a medium-gear sector time threshold of 6667/p; the high-gear proportional value is 55%, with a high-gear sector time threshold of 5682/p, where p is the number of motor pole pairs. After adding the time limit condition, the sector time thresholds for the same gear in different time intervals are shown in Table 17 below.

TABLE 17

| Sector Threshold (μs) | ΔT₀ | ΔT₁ | ΔT₂ | ΔT₃ |
|---|---|---|---|---|
| Low-Gear | 7143/p | 7937/p | 8929/p | 10204/p |
| Medium-Gear | 6061/p | 6667/p | 7407/p | 8333/p |
| High-Gear | 5208/p | 5682/p | 6250/p | 6944/p |

In another embodiment, the proportional value is negatively correlated with the gear. The low-gear proportional value is 55%, with a low-gear sector time threshold of 6494/p; the medium-gear proportional value is 50%, with a medium-gear sector time threshold of 6667/p; the high-gear ratio is 45%, with a high-gear sector time threshold of 6944/p, where p is the number of motor pole pairs. After adding the time limit condition, the sector time thresholds for the same gear in different time intervals are shown in Table 18 below.

TABLE 18

| Sector Threshold (μs) | ΔT₀ | ΔT₁ | ΔT₂ | ΔT₃ |
|---|---|---|---|---|
| Low-Gear | 5952/p | 6494/p | 7143/p | 7937/p |
| Medium-Gear | 6061/p | 6667/p | 7407/p | 8333/p |
| High-Gear | 6250/p | 6944/p | 7813/p | 8929/p |

The motor sector time difference is taken as an example, as shown in FIG. 11, which is a schematic diagram of determining a heavy load mutation based on a motor sector time difference threshold during the operation of the functional motor 211.

The heavy load identification unit 221 may calculate the difference between the motor sector time Sₖ acquired at the current moment and the motor sector time Sₖ₋₁ acquired at the previous moment to obtain ΔSₖ. In response to ΔSₖ being greater than or equal to a preset sector time difference threshold ΔS_{T}, it is determined that the functional motor 211 has entered the heavy load state.

Furthermore, a time limit condition may be added. In response to the current sector time difference ΔSₖ being greater than or equal to the sector time difference threshold ΔS_{T} within a preset time interval ΔT, which may be, for example, 0.01 to 10 seconds, it is determined that the load has entered the heavy load operating region.

Further, the aforementioned time limit may be segmented by presetting X ΔTₓ time intervals. For example, X=4, ΔT₀=10 seconds, ΔT₁=1 second, ΔT₂=0.1 seconds, ΔT₃=0.01 seconds. The difference between the sector time Sₖ acquired at the current moment and the sector time Sg acquired at a moment ΔT₀ (10 seconds) earlier is calculated to obtain ΔS_{kg}; the difference between Sₖ and the sector time Sₕ acquired at a moment, ΔT₁ (1 second) earlier is calculated to obtain ΔSₖₕ; the difference between Sₖ and the sector time Sᵢ acquired at a moment ΔT₂ (0.1 seconds) earlier is calculated to obtain ΔSₖᵢ; the difference between Sₖ and the sector time Sⱼ acquired at a moment ΔT₃ (0.01 seconds) earlier is calculated to obtain ΔSₖⱼ. In response to ΔS_{kg} being greater than or equal to the preset sector time difference threshold ΔS_{T0}, and/or ΔSₖₕ being greater than or equal to the preset sector time difference threshold ΔS_{T1}, and/or ΔSₖᵢ being greater than or equal to the preset sector time difference threshold ΔS_{T2}, and/or ΔSₖⱼ being greater than or equal to the preset sector time difference threshold ΔS_{T3}, it is determined that the load has entered the heavy load operating region. ΔS_{T0}˜ΔS_{T3} satisfy relational expression (6): ΔS_{T0}≤ΔS_{T1}≤ΔS_{T2}≤ΔS_{T3}.

The motor sector time difference threshold may be set for different rotational speed gears and may be set as an absolute value or a proportional value.

Examples for the case where the threshold is set as an absolute value are as follows.
(1) The sector time difference thresholds are the same for respective gears under the same time interval condition.

For example, the preset fixed difference is 6667/p, where p is the number of motor pole pairs. After adding the time limit condition, the motor sector time difference thresholds for the same gear in different time intervals are shown in Table 19 below.

TABLE 19

| Sector Difference (μs) | ΔT₀ | ΔT₁ | ΔT₂ | ΔT₃ |
|---|---|---|---|---|
| Low-Gear ΔST | 5263/p | 6667/p | 8333/p | 10000/p |
| Medium-Gear ΔST | 5263/p | 6667/p | 8333/p | 10000/p |
| High-Gear ΔST | 5263/p | 6667/p | 8333/p | 10000/p |

(2) The sector time difference thresholds are different for respective gears under the same time interval condition.

The sector time difference threshold is negatively correlated to the gear. The low-gear sector time difference threshold is 7692/p, the medium-gear sector time difference threshold is 7143/p, and the high-gear sector time difference threshold is 6667/p, where p is the number of motor pole pairs. After adding the time limit condition, the motor sector time difference thresholds for the same gear in different time intervals are shown in Table 20 below.

TABLE 20

| Sector Difference (μs) | ΔT₀ | ΔT₁ | ΔT₂ | ΔT₃ |
|---|---|---|---|---|
| Low-Gear ΔST | 6250/p | 7692/p | 9091/p | 10000/p |
| Medium-Gear ΔST | 5882/p | 7143/p | 8333/p | 9091/p |
| High-Gear ΔST | 5556/p | 6667/p | 7692/p | 8333/p |

In another embodiment, the sector time difference threshold is positively correlated with the gear. The low-gear sector time difference threshold is 6452/p, the medium-gear sector time difference threshold is 6667/p, and the high-gear sector time difference threshold is 6897/p, where p is the number of motor pole pairs. After adding the time limit condition, the motor sector time difference thresholds for the same gear in different time intervals are shown in Table 21 below.

TABLE 21

| Sector Difference (μs) | ΔT₀ | ΔT₁ | ΔT₂ | ΔT₃ |
|---|---|---|---|---|
| Low-Gear ΔST | 5405/p | 6452/p | 7407/p | 8000/p |
| Medium-Gear ΔST | 5556/p | 6667/p | 7692/p | 8333/p |
| High-Gear ΔST | 5714/p | 6897/p | 8000/p | 8696/p |

Examples for the case where the threshold is set as a proportional value are as follows.
(1) The proportional value is the same for respective gears under the same time interval condition.

The proportional value is fixed at 50%. After adding the time limit condition, the motor sector time difference thresholds for the same gear in different time intervals are shown in Table 22 below.

TABLE 22

| Sector Difference (μs) | ΔT₀ | ΔT₁ | ΔT₂ | ΔT₃ |
|---|---|---|---|---|
| Low-Gear ΔST | 5952/p | 7143/p | 7937/p | 8929/p |
| Medium-Gear ΔST | 5556/p | 6667/p | 7407/p | 8333/p |
| High-Gear ΔST | 5208/p | 6250/p | 6944/p | 7813/p |

(2) The proportional values for different gears are different under the same time interval condition.

The proportional value is positively correlated with the gear. The low-gear proportional value is 45%, with a low-gear sector time difference threshold of 7143/p; the medium-gear proportional value is 50%, with a medium-gear sector time difference threshold of 6667/p; the high-gear proportional value is 55%, with a high-gear sector time difference threshold of 5682/p, where p is the number of motor pole pairs. After adding the time limit condition, the motor sector time difference thresholds for the same gear under different time intervals are shown in Table 23 below.

TABLE 23

| Sector Difference (μs) | ΔT₀ | ΔT₁ | ΔT₂ | ΔT₃ |
|---|---|---|---|---|
| Low-Gear ΔST | 7143/p | 7937/p | 8929/p | 10204/p |
| Medium-Gear ΔST | 6061/p | 6667/p | 7407/p | 8333/p |
| High-Gear ΔST | 5208/p | 5682/p | 6250/p | 6944/p |

In another embodiment, the proportional value is negatively correlated with the gear. The low-gear proportional value is 55%, with a low-gear sector time difference threshold of 6494/p; the medium-gear proportional value is 50%, with a medium-gear sector time difference threshold of 6667/p; the high-gear proportional value is 45%, with a high-gear sector time difference threshold of 6944/p, where p is the number of motor pole pairs. After adding the time limit condition, the motor sector time difference thresholds for the same gear in different time intervals are shown in Table 24 below.

TABLE 24

| Sector Difference (μs) | ΔT₀ | ΔT₁ | ΔT₂ | ΔT₃ |
|---|---|---|---|---|
| Low-Gear ΔST | 5952/p | 6494/p | 7143/p | 7937/p |
| Medium-Gear ΔST | 6061/p | 6667/p | 7407/p | 8333/p |
| High-Gear ΔST | 6250/p | 6944/p | 7813/p | 8929/p |

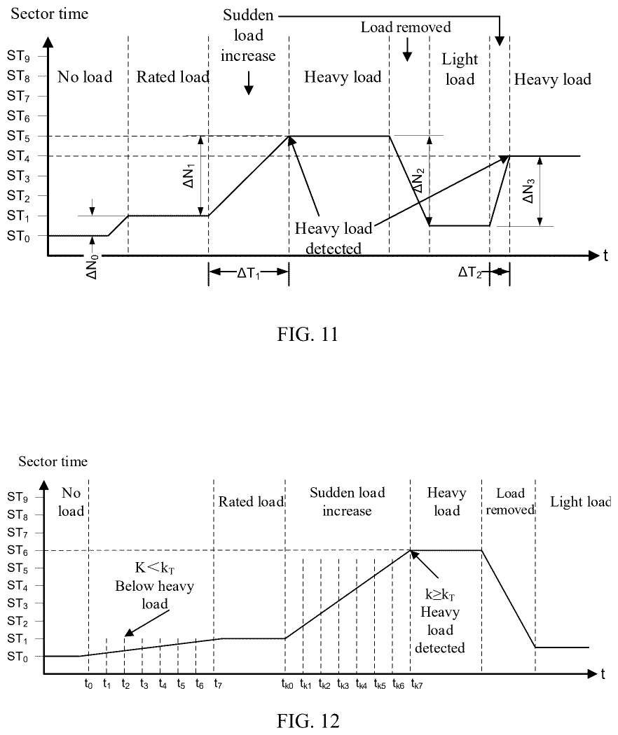

The motor sector time rate of change is taken as an example, as shown in FIG. 12, which is a schematic diagram of determining a heavy load mutation based on a motor rotational speed rate-of-change threshold during the operation of the functional motor 211.

The heavy load identification unit 221 may acquire motor sector times S₀, S₁, S₂ . . . Sₖ at time instants t₀, t₁, t₂ . . . tₖ, perform linear fitting on S₀, S₁, S₂ . . . Sₖ, and obtain the corresponding curve slope k according to the following equation: k=(Ets−Et*Es)/[Et²−(Et)²].

Ets represents the mathematical expectation of the product of the sampling time instant t and the sector time, Et represents the mathematical expectation of the sampling time instant t, Es represents the mathematical expectation of the sector time, Et² represents the mathematical expectation of the square of the sampling time instant t, and (Et)² represents the square of the mathematical expectation of the sampling time instant t.

Assuming Δt₀=t₁−t₀, Δt₁=t₂−t₁ . . . , Δtₖ=tₖ+1−tₖ, for the convenience of software calculation, it is generally designed that Δt₀=Δt₁= . . . =Δtₖ. Therefore, the above equation may be simplified to: k=[n*Σ(t*s)−Σt*Σs]/[n*Σt²−Σt*Σt], where n is a positive integer. To further simplify the calculation process and reduce software computational overhead, n in the simplified equation may be set to 2^{m}, where m is a positive integer. When m=1, the above equation degenerates into the sector time difference described in section 1.7.

When the slope k is greater than or equal to the preset slope threshold k_{T}, it is determined that the load has entered the heavy load operating region.

Furthermore, to achieve better determination results, a sector time filtering method may be adopted based on the above. Thus, the aforementioned sector times S₀, S₁, S₂ . . . Sₖ are values obtained after filtering. In this way, when using fixed window filtering series methods, values of Δt₀, Δt₁, Δt₂ . . . Δtₖ are sampling intervals of X pieces of sector time. For example, when the sector time is acquired every 1 ms and X=8 is preset, a filtered value is calculated every 8 ms, and Δt₀=Δt₁=Δt₂=Δtₖ=8 ms; when using sliding window filtering series methods under the same preset conditions, Δt₀=Δt₁=Δt₂=Δtₖ=1 ms. After each fixed window filtering or sliding window filtering is completed, equation (7) is used to calculate the slope k, which is the first derivative value of the sector time with respect to unit time.

Furthermore, when the sector time range of the motor operation is relatively large, the values of Δt₀, Δt₁, Δt₂ . . . Δtₖ may be dynamically adjusted according to the current motor sector time. This is because when Δt₀, Δt₁, Δt₂ . . . Δtₖ is too small, and the motor sector time is relatively low, the sector time sampling frequency is much higher than the motor sector time filtering frequency, and the sector time sampled at each moment might be the same, unnecessarily consuming computing resources, or when the motor sector time fluctuates on a small time scale, it can easily interfere with the calculation results, causing misjudgment. When Δt₀, Δt₁, Δt₂ . . . Δtₖ is too large, and the motor sector time is relatively high, the sector time sampling frequency is much lower than the actual sector time change frequency, resulting in large fluctuations between the obtained data, or it might be that the actual sector time rate of change already meets the application requirements, but the actual calculation and judgment fail to identify it. Therefore, the adjustment rule for Δt₀, Δt₁, Δt₂ . . . Δtₖ is: when the sector time is relatively high, the time interval is relatively small; when the sector time is relatively low, the time interval is relatively large. There are three methods for adjusting this time interval. The first is to adjust the aforementioned Ims sector time sampling interval, for example, adjust it to 0.5 ms or 2 ms. In this case, under fixed window filtering series methods, Δt₀=Δt₁=Δt₂=Δtₖ=4 ms or 16 ms; under sliding window filtering series methods, Δt₀=Δt₁=Δt₂=Δtₖ=0.5 ms or 2 ms. The second method is to adjust the window length (number of sample points X), for example, adjust it to X=4 or X=16. In this case, under fixed window filtering series methods, Δt₀=Δt₁=Δt₂=Δtₖ=4 ms or 16 ms; under sliding window filtering series methods, Δt₀=Δt₁=Δt₂=Δtₖ still equals 1 ms. The third method is to simultaneously adjust the sector time sampling interval time and the window length (number of sample points X). Additionally, since the sector time drop caused by a sudden load change is also relatively fast, during this process, Δt₀, Δt₁, Δt₂ . . . Δₖ will not be adjusted, and adjustment will only occur after the sector time has stabilized for a period of time.

Furthermore, after each fixed window filtering or sliding window filtering, the slope is calculated again, thus obtaining a set k₀, k₁, k₂ . . . kₖ. Linear fitting is performed again on k₀, k₁, k₂ . . . kₖ to obtain the corresponding slope k′ using the equation: k′=(Etk−Et*Ek)/[Et²−(Et)²].

Here, Etk represents the mathematical expectation of the product of the time instant t of each acquired sector time slope and the sector time slope, Et represents the mathematical expectation of the time instant t of each acquired sector time slope, Ek represents the mathematical expectation of the sector time slope, Et² represents the mathematical expectation of the square of the time instant t of each acquired sector time slope, and (Et)² represents the square of the mathematical expectation of the sampling time instant t.

Since the time intervals for acquisitions of k₀, k₁, k₂ . . . kₖ are equal, Δt′₀, Δt′₁, Δt′₂ . . . Δt′ₖ are also equal. Therefore, the above equation may be simplified to: k′=[n′*>(tₖ)−Σt*Σk]/[n′*Σt²−Σt*Σt], where n′ is a positive integer. To further simplify the calculation process and reduce software computational overhead, n′ in the simplified equation may be set to 2^{m′}, where m′ is a positive integer. When the slope k′ is greater than or equal to the preset slope threshold k′_{T}, it is determined that the load has entered the heavy load operating region. Here, the slope k′ is the second derivative of the sector time with respect to unit time.

For the case where the first derivative of the motor sector time is determined as the motor sector time rate of change, the heavy load identification unit 221 compares the motor sector time rate of change with the corresponding preset motor sector time first derivative threshold. In response to the motor sector time rate of change being greater than or equal to the preset motor sector time first derivative threshold, it may be determined that the functional motor 211 has entered the heavy load state.

For the case where the second derivative of the motor sector time is determined as the motor sector time rate of change, the heavy load identification unit 221 compares the motor sector time rate of change with the corresponding preset motor sector time rate of change second derivative threshold. In response to the motor sector time rate of change being greater than or equal to the preset motor sector time rate of change second derivative threshold, it may be determined that the functional motor 211 has entered the heavy load state.

In some embodiments, the heavy load identification unit 221 may acquire a plurality of motor sector time parameters and compare the plurality of motor sector time parameters with their respective preset motor sector time parameter thresholds to determine whether the plurality of motor sector time parameters are smaller than or equal to the corresponding preset motor sector time parameter thresholds, respectively.

For example, the motor sector time is compared with the corresponding preset motor sector time threshold, and the motor sector time difference is compared with the corresponding preset motor sector time difference threshold. In response to the motor sector time being smaller than or equal to the preset motor sector time threshold, and the motor sector time difference being smaller than or equal to the preset motor sector time difference threshold, it is determined that the functional motor 211 has entered the heavy load state.

For example, the motor sector time, the motor sector time difference, and the motor sector time rate of change are compared with the corresponding preset motor sector time threshold, preset motor sector time difference threshold, and preset motor sector time rate-of-change threshold, respectively. In response to all the three motor sector time parameters being smaller than or equal to their respective thresholds, it may be determined that the functional motor 211 has entered the heavy load state.

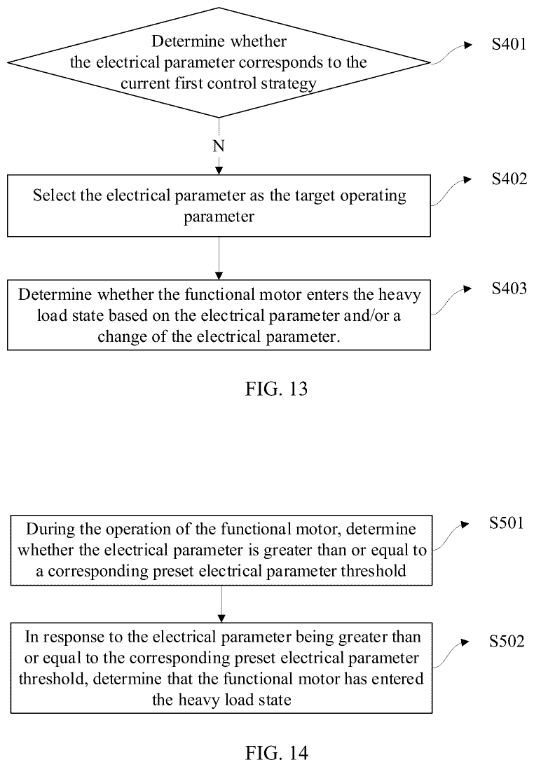

As shown in FIG. 13, in an electric work vehicle according to one or more embodiments of the present disclosure, the heavy load identification unit being configured to select a target operating parameter from the plurality of operating parameters and determine whether the functional motor enters a heavy load state based on the target operating parameter and/or a change of the target operating parameter includes the heavy load identification unit being configured to perform following steps S401 to S403.

S401: Determine whether the electrical parameter corresponds to the current first control strategy.

S402: In response to the electrical parameter not corresponding to the first control strategy, select the electrical parameter as the target operating parameter.

The control strategy corresponding to the electrical parameter is the current closed-loop control strategy. In response to the control strategy currently adopted by the controller assembly 22 for the functional motor 211 being a non-current closed-loop control strategy, such as the rotational speed closed-loop control strategy, the power closed-loop control strategy, the torque closed-loop control strategy, or the PWM duty cycle open-loop control strategy, the heavy load identification unit 221 may select the electrical parameter as the target operating parameter.

Selection of the target operating parameter is actually determined based on the current first control strategy. In response to the first control strategy being a non-current closed-loop control strategy, the heavy load identification unit 221 may select the electrical parameter as the target operating parameter.

S403: Determine whether the functional motor enters the heavy load state based on the electrical parameter and/or a change of the electrical parameter. The heavy load identification unit 221 selects the electrical parameter as the target operating parameter and further monitors the electrical parameter. The change of the electrical parameter may include, for example, a difference obtained by comparing the electrical parameter acquired at different time instants, a rate of increase or decrease of the electrical parameter, etc.

As shown in FIG. 14, in an electric work vehicle according to one or more embodiments of the present disclosure, the method for the heavy load identification unit 221 to determine whether the functional motor 211 enters the heavy load state based on the electrical parameter and/or the change of the electrical parameter includes the following steps S501 and S502.

At step S501, during the operation of the functional motor, it is determined whether the electrical parameter is greater than or equal to a corresponding preset electrical parameter threshold.

At step S502, in response to the electrical parameter being greater than or equal to the corresponding preset electrical parameter threshold, it is determined that the functional motor has entered the heavy load state.

In some embodiments, the electrical parameter includes a bus current parameter. The bus current parameter includes a bus current, a bus current difference, and a bus current rate of change. The preset electrical parameter thresholds corresponding to the bus current, the bus current difference, and the bus current rate of change are a bus current threshold, a bus current difference threshold, and a bus current rate-of-change threshold, respectively.

The bus current may be determined by sampling using a current sampling resistor provided in a corresponding control circuit of the functional motor 211, or by sampling using a current sensor provided in the control circuit.

The bus current difference refers to the difference in the bus current of the functional motor at two adjacent moments. The heavy load identification unit 221 may calculate the difference between the bus current Bx acquired at a current moment and the bus current Bₖ₋₁ acquired at a previous moment to obtain ΔBₖ. The bus current difference may be an absolute value, meaning the obtained ΔBₖ is a positive number, thereby facilitating subsequent calculations.

The bus current rate of change characterizes the trend of change of the bus current of the functional motor 211 at corresponding moments. The bus current rate of change may include a first derivative and a second derivative of the bus current as a function of time. The rate of change may be obtained by fitting bus current values determined by sampling at a plurality of moments to obtain a bus current change curve, and taking the slope of this change curve as the bus current rate of change. The slope of this change curve is the first derivative of the bus current. In another embodiment, the slope of the slope of the bus current change curve may be taken as the bus current rate of change. The slope of the slope of the change curve is the second derivative of the bus current.

The method for the heavy load identification unit 221 to determine whether the electrical parameter is greater than or equal to the corresponding preset electrical parameter threshold includes: acquiring at least one bus current parameter and determining whether the at least one bus current parameter is greater than or equal to the corresponding preset electrical parameter threshold.

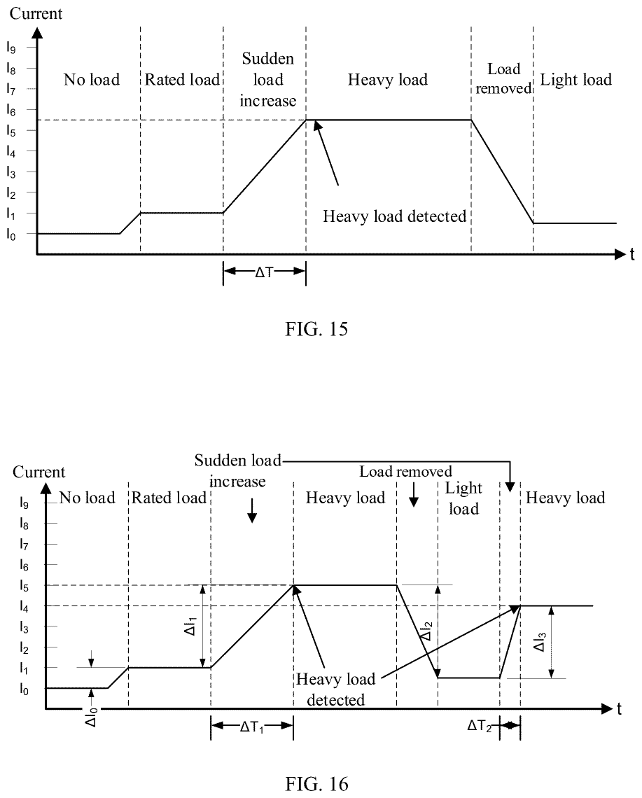

The bus current is taken as an example, as shown in FIG. 15, which is a schematic diagram of determining a heavy load mutation based on a bus current threshold during the operation of the functional motor 211.

The heavy load identification unit 221 may determine whether the current bus current Iₖ is greater than or equal to a preset bus current threshold I_{T}. In response to the current bus current Iₖ being greater than or equal to a preset bus current threshold I_{T}, it is determined that the functional motor 211 has entered the heavy load state.

Furthermore, a time constraint condition may be added. In response to the current bus current Iₖ being greater than or equal to the preset bus current threshold I_{T} within a preset time interval ΔT, which may be, for example, 0.01 to 10 seconds, it is determined that the load has entered the heavy load operating region.

Further still, the aforementioned added time constraint may be segmented by presetting X ΔTₓ time intervals. For example, X=4, ΔT₀=10 seconds, ΔT₁=1 second, ΔT₂=0.1 seconds, ΔT₃=0.01 seconds. In response to the current bus current Iₖ being greater than or equal to I_{T0} within ΔT₀ (10 seconds), and/or the current bus current Iₖ being greater than or equal to I_{T1} within ΔT₁ (1 second), and/or the current bus current Iₖ being greater than or equal to IT₂ within ΔT₂ (0.1 seconds), and/or the current bus current Iₖ being greater than or equal to IT₃ within ΔT₃ (0.01 seconds), it is determined that the load has entered the heavy load operating region. I_{T0} to I_{T3} satisfy relational expression (9): I_{T0}≤I_{T1}≤I_{T2}≤I_{T3}.

The bus current threshold may be set for different rotational speed gears and may be set as an absolute value or a proportional value.

Examples for the case where the threshold is set as an absolute value are as follows.
(1) The bus current thresholds are the same for all gears under the same time interval condition.

After adding the time constraint condition, the bus current thresholds for the same gear in different time intervals are shown in Table 25 below.

TABLE 25

| Current Threshold (A) | ΔT₀ | ΔT₁ | ΔT₂ | ΔT₃ |
|---|---|---|---|---|
| Low-Gear | I_{AL0} | I_{AL1} | I_{AL2} | I_{AL3} |
| Medium-Gear | I_{AM0} | I_{AM1} | I_{AM2} | I_{AM3} |
| High-Gear | I_{AH0} | I_{AH1} | I_{AH2} | I_{AH3} |

(2) The bus current thresholds are different for respective gears under the same time interval condition:

The bus current threshold is positively correlated with the gear. After adding the time constraint condition, the bus current thresholds for the same gear in different time intervals are shown in Table 26 below.

TABLE 26

| Current Threshold (A) | ΔT₀ | ΔT₁ | ΔT₂ | ΔT₃ |
|---|---|---|---|---|
| Low-Gear | I_{BL0} | I_{BL1} | I_{BL2} | I_{BL3} |
| Medium-Gear | I_{BM0} | I_{BM1} | I_{BM2} | I_{BM3} |
| High-Gear | I_{BH0} | I_{BH1} | I_{BH2} | I_{BH3} |

In another embodiment, the bus current threshold is negatively correlated with the gear. After adding the time constraint condition, the bus current thresholds for the same gear in different time intervals are shown in Table 27 below.

TABLE 27

| Current Threshold (A) | ΔT₀ | ΔT₁ | ΔT₂ | ΔT₃ |
|---|---|---|---|---|
| Low-Gear | I_{CL0} | I_{CL1} | I_{CL2} | I_{CL3} |
| Medium-Gear | I_{CM0} | I_{CM1} | I_{CM2} | I_{CM3} |
| High-Gear | I_{CH0} | I_{CH1} | I_{CH2} | I_{CH3} |

Examples for the case where the threshold is set as a proportional value are as follows.
(1) The proportional value is the same for all gears under the same time interval condition. After adding the time constraint condition, the bus current thresholds for the same gear in different time intervals are shown in Table 28 below.

TABLE 28

| Current | | | | |
|---|---|---|---|---|
| Threshold | | | | |
| (A) | ΔT₀ | ΔT₁ | ΔT₂ | ΔT₃ |
| Low-Gear | I_{DL0} | I_{DL1} | I_{DL2} | I_{DL3} |
| Medium-Gear | I_{DM0} | I_{DM1} | I_{DM2} | I_{DM3} |
| High-Gear | I_{DH0} | I_{DH1} | I_{DH2} | I_{DH3} |

(2) The proportional values for different gears are different under the same time interval condition.

The proportional value is positively correlated with the gear. After adding the time constraint condition, the bus current thresholds for the same gear in different time intervals are shown in Table 29 below.

TABLE 29

| Current | | | | |
|---|---|---|---|---|
| Threshold | | | | |
| (A) | ΔT₀ | ΔT₁ | ΔT₂ | ΔT₃ |
| Low-Gear | I_{EL0} | I_{EL1} | I_{EL2} | I_{EL3} |
| Medium-Gear | I_{EM0} | I_{EM1} | I_{EM2} | I_{EM3} |
| High-Gear | I_{EH0} | I_{EH1} | I_{EH2} | I_{EH3} |

In another embodiment, the proportional value is negatively correlated with the gear. After adding the time constraint condition, the bus current thresholds for the same gear under different time intervals are shown in Table 30 below.

TABLE 30

| Current | | | | |
|---|---|---|---|---|
| Threshold | | | | |
| (A) | ΔT₀ | ΔT₁ | ΔT₂ | ΔT₃ |
| Low-Gear | I_{FL0} | I_{FL1} | I_{FL2} | I_{FL3} |
| Medium-Gear | I_{FM0} | I_{FM1} | I_{FM2} | I_{FM3} |
| High-Gear | I_{FH0} | I_{FH1} | I_{FH2} | I_{FH3} |

The bus current difference is taken as an example, as shown in FIG. 16, which is a schematic diagram of determining a heavy load mutation based on a bus current difference threshold during the operation of the functional motor 211.

The heavy load identification unit 221 may calculate the difference between the bus current Iₖ acquired at the current moment and the bus current Iₖ₋₁ acquired at the previous moment to obtain ΔIₖ. In response to ΔIₖ being greater than or equal to a preset bus current difference threshold ΔI_{T}, it is determined that the load has entered the heavy load operating region.

Furthermore, a time constraint condition may be added. In response to the current bus current difference ΔIₖ being greater than or equal to the bus current difference threshold ΔI_{T} within a preset time interval ΔT, which may be, for example, 0.01 to 10 seconds, it is determined that the load has entered the heavy load operating region.

Further still, the aforementioned added time constraint may be segmented by presetting X ΔTx time intervals. For example, X=4, ΔT₀=10 seconds, ΔT₁=1 second, ΔT₂=0.1 seconds, ΔT₃=0.01 seconds. The difference between the bus current Iₖ acquired at the current moment and the bus current Ig acquired at the previous moment, ΔT₀ (10 seconds) earlier, is calculated to obtain ΔI_{kg}; the difference between Iₖ and the bus current Iₕ acquired at the previous moment, ΔT₁ (1 second) earlier, is calculated to obtain ΔIₖₕ; the difference between Iₖ and the bus current Iᵢ acquired at the moment ΔT₂ (0.1 seconds) earlier, is calculated to obtain ΔIₖᵢ; the difference between Iₖ and the bus current Iⱼ acquired at the previous moment, ΔT₃ (0.01 seconds) earlier, is calculated to obtain ΔIₖⱼ. In response to ΔI_{kg} being greater than or equal to the preset bus current difference threshold ΔI_{T0}, and/or ΔIₖₕ being greater than or equal to the preset bus current difference threshold ΔI_{T1}, and/or ΔIₖᵢ being greater than or equal to the preset bus current difference threshold ΔI_{T2}, and/or ΔIₖⱼ being greater than or equal to the preset bus current difference threshold ΔI_{T3}, it is determined that the load has entered the heavy load operating region. ΔI_{T0} to ΔI_{T3} satisfy relational expression (10): ΔI_{T0}≥ΔI_{T1}≥ΔI_{T2}≥ΔI_{T3}.

The bus current difference threshold may be set for different rotational speed gears and may be set as an absolute value or a proportional value.

Examples for the case where the threshold is set as an absolute value are as follows.
(1) The thresholds for the bus current difference are the same for respective gears under the same time interval condition.

After adding the time constraint condition, the bus current difference thresholds for the same gear in different time intervals are shown in Table 31 below.

TABLE 31

| Current | | | | |
|---|---|---|---|---|
| Difference | | | | |
| (A) | ΔT₀ | ΔT₁ | ΔT₂ | ΔT₃ |
| Low-Gear ΔI_{T} | ΔI_{AL0} | ΔI_{AL1} | ΔI_{AL2} | ΔI_{AL3} |
| Medium-GearΔI_{T} | ΔI_{AM0} | ΔI_{AM1} | ΔI_{AM2} | ΔI_{AM3} |
| Medium-GearΔI_{T} | ΔI_{AH0} | ΔI_{AH1} | ΔI_{AH2} | ΔI_{AH3} |

(2) The thresholds for the bus current difference are different for all gears under the same time interval condition.

The bus current difference threshold is positively correlated with the gear. After adding the time constraint condition, the bus current difference thresholds for the same gear in different time intervals are shown in Table 32 below.

TABLE 32

| Current | | | | |
|---|---|---|---|---|
| Difference | | | | |
| (A) | ΔT₀ | ΔT₁ | ΔT₂ | ΔT₃ |
| Low-Gear ΔI_{T} | ΔI_{BL0} | ΔI_{BL1} | ΔI_{BL2} | ΔI_{BL3} |
| Medium-Gear ΔI_{T} | ΔI_{BM0} | ΔI_{BM1} | ΔI_{BM2} | ΔI_{BM3} |
| Medium-Gear ΔI_{T} | ΔI_{BH0} | ΔI_{BH1} | ΔI_{BH2} | ΔI_{BH3} |

In another embodiment, the bus current difference threshold is negatively correlated with the gear. After adding the time constraint condition, the bus current difference thresholds for the same gear in different time intervals are shown in Table 33 below.

TABLE 33

| Current | | | | |
|---|---|---|---|---|
| Difference | | | | |
| (A) | ΔT₀ | ΔT₁ | ΔT₂ | ΔT₃ |
| Low-Gear ΔI_{T} | ΔI_{CL0} | ΔI_{CL1} | ΔI_{CL2} | ΔI_{CL3} |
| Medium-Gear ΔI_{T} | ΔI_{CM0} | ΔI_{CM1} | ΔI_{CM2} | ΔI_{CM3} |
| Medium-Gear ΔI_{T} | ΔI_{CH0} | ΔI_{CH1} | ΔI_{CH2} | ΔI_{CH3} |

Examples for the case where the threshold is set as a proportional value are as follows.
(1) The proportional value is the same for respective gears under the same time interval condition.

After adding the time constraint condition, the bus current difference thresholds for the same gear in different time intervals are shown in Table 34 below.

TABLE 34

| Current | | | | |
|---|---|---|---|---|
| Difference | | | | |
| (A) | ΔT₀ | ΔT₁ | ΔT₂ | ΔT₃ |
| Low-Gear ΔI_{T} | ΔI_{DL0} | ΔI_{DL1} | ΔI_{DL2} | ΔI_{DL3} |
| Medium-GearΔI_{T} | ΔI_{DM0} | ΔI_{DM1} | ΔI_{DM2} | ΔI_{DM3} |
| Medium-GearΔI_{T} | ΔI_{DH0} | ΔI_{DH1} | ΔI_{DH2} | ΔI_{DH3} |

(2) The proportional values for different gears are different under the same time interval condition.

The proportional value is positively correlated to the gear. After adding the time constraint condition, the bus current difference thresholds for the same gear in different time intervals are shown in Table 35 below.

TABLE 35

| Current | | | | |
|---|---|---|---|---|
| Difference | | | | |
| (A) | ΔT₀ | ΔT₁ | ΔT₂ | ΔT₃ |
| Low-Gear ΔI_{T} | ΔI_{EL0} | ΔI_{EL1} | ΔI_{EL2} | ΔI_{EL3} |
| Medium-Gear ΔI_{T} | ΔI_{EM0} | ΔI_{EM1} | ΔI_{EM2} | ΔI_{EM3} |
| Medium-Gear ΔI_{T} | ΔI_{EH0} | ΔI_{EH1} | ΔI_{EH2} | ΔI_{EH3} |

In another embodiment, the proportional value is negatively correlated with the gear. After adding the time constraint condition, the bus current difference thresholds for the same gear in different time intervals are shown in Table 36 below.

TABLE 36

| Current | | | | |
|---|---|---|---|---|
| Difference | | | | |
| (A) | ΔT₀ | ΔT₁ | ΔT₂ | ΔT₃ |
| Low-Gear ΔI_{T} | ΔI_{FL0} | ΔI_{FL1} | ΔI_{FL2} | ΔI_{FL3} |
| Medium-Gear ΔI_{T} | ΔI_{FM0} | ΔI_{FM1} | ΔI_{FM2} | ΔI_{FM3} |
| Medium-Gear ΔI_{T} | ΔI_{FH0} | ΔI_{FH1} | ΔI_{FH2} | ΔI_{FH3} |

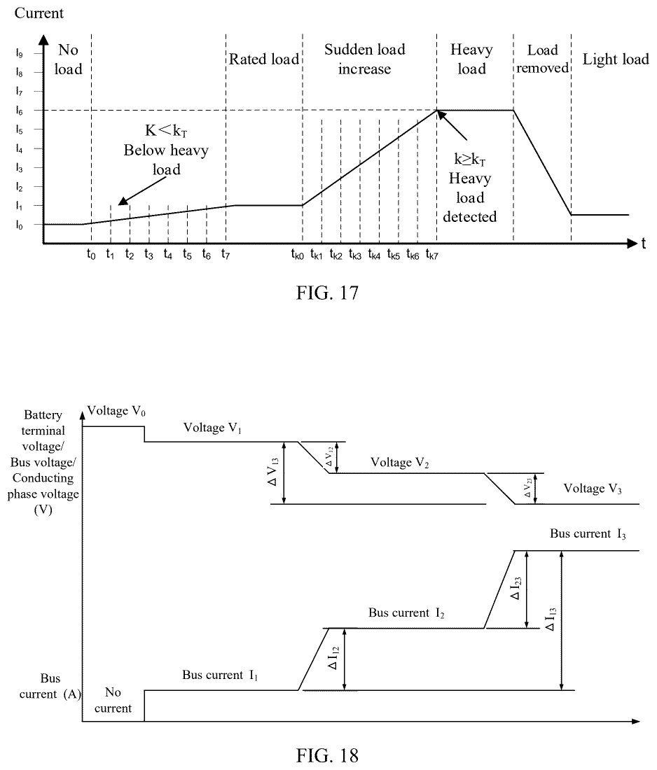

The bus current rate of change is taken as an example, as shown in FIG. 17, which is a schematic diagram for determining a heavy load mutation based on a bus current rate-of-change threshold during the operation of the functional motor 211.

The heavy load identification unit 221 acquires bus currents I₁, I₁, I₂ . . . Iₖ at time instants t₀, t₁, t₂ . . . tₖ, performs linear fitting on I₁, I₁, I₂ . . . Iₖ, and obtains the corresponding curve slope k using the equation: k=(Eti−Et*Ei)/[Et²−(Et)²].

Here, Eti represents the mathematical expectation of the product of the sampling time instant t and the bus current, Et represents the mathematical expectation of the sampling time instant t, Ei represents the mathematical expectation of the bus current, Et² represents the mathematical expectation of the square of the sampling time instant t, and (Et)² represents the square of the mathematical expectation of the sampling time instant t.

Assuming Δt₀=t₁−t₀, Δt₁=t₂−t₁ . . . , Δtₖ=tₖ₊₁−tₖ, for the convenience of software calculation, it is generally designed that Δt₀=Δt₁= . . . =Δtₖ. Therefore, the above equation may be simplified to: k=[n*Σ(t*i)−Σt*Σi]/[n*Σt²−Σt*Σt], where n is a positive integer. To further simplify the calculation process and reduce software computational overhead, n in the simplified equation may be set to 2^{m}, where m is a positive integer.

When the slope k is greater than or equal to the preset slope threshold k_{T}, it is determined that the load has entered the heavy load operating region.

Furthermore, to achieve better determination results, a bus current filtering method may be adopted based on the above. Thus, the aforementioned bus currents I₁, I₁, I₂ . . . Iₖ are values obtained after filtering. In this way, when using fixed window filtering series methods, values of Δt₀, Δt₁, Δt₂ . . . Δtₖ are sampling intervals of X pieces of bus current data. For example, when the bus current is acquired every 1 ms and X=8 is preset, a filtered value is calculated every 8 ms, and Δt₀=Δt₁=Δt₂=Δtₖ=8 ms; when using sliding window filtering series methods under the same preset conditions, Δt₀=Δt₁=Δt₂=Δtₖ=1 ms. After each fixed window filtering or sliding window filtering is completed, use the above calculation equation to calculate and determine the slope k, which is the first derivative value of the bus current with respect to unit time.

Furthermore, when the bus current range of the motor operation is relatively large, the values of Δt₀, Δt₁, Δt₂ . . . Δtₖ may be dynamically adjusted according to the current motor bus current. This is because when Δt₀, Δt₁, Δt₂ . . . Δtₖ is too small, and the motor bus current is relatively low, the bus current sampling frequency is much higher than the motor bus current filtering frequency, and the bus current sampled at each moment might be the same, unnecessarily consuming computing resources, or when the motor bus current fluctuates on a small time scale, it may easily interfere with the calculation results, causing misjudgment. When Δt₀, Δt₁, Δt₂ . . . Δtₖ is too large, and the motor bus current is relatively high, the bus current sampling frequency is much lower than the actual bus current change frequency, resulting in large fluctuations between the obtained data, or it might be that the actual bus current rate of change already meets the application requirements, but the actual calculation and judgment fail to identify it. Therefore, the adjustment rule for Δt₀, Δt₁, Δt₂ . . . Δtₖ is: when the bus current is relatively high, the time interval is relatively small; when the bus current is relatively low, the time interval is relatively large. There are three methods for adjusting this time interval: The first is to adjust the aforementioned Ims bus current sampling interval, for example, adjust it to 0.5 ms or 2 ms. In this case, under fixed window filtering series methods, Δt0=Δt1=Δt2=Δtk=4 ms or 16 ms; under sliding window filtering series methods, Δt0=Δt1=Δt2=Δtk=0.5 ms or 2 ms. The second method is to adjust the window length (number of sample points X), for example, adjust it to X=4 or X=16. In this case, under fixed window filtering series methods, Δt0=Δt1=Δt2=Δtk=4 ms or 16 ms; under sliding window filtering series methods, Δt0=Δt1=Δt2=Δtk still equals 1 ms. The third method is to simultaneously adjust the bus current sampling interval time and the window length (number of sample points X). Additionally, since the bus current drop caused by a sudden load change is also relatively fast, during this process, Δt0, Δt1, Δt2 . . . Δtk are not adjusted, and adjustment will only occur after the bus current has stabilized for a period of time.

Furthermore, after each fixed window filtering or sliding window filtering, the aforementioned calculation equation is used to calculate the slope, thus obtaining a set k₀, k₁, k₂ . . . kₖ. Linear fitting is performed again on k₀, k₁, k₂ . . . kₖ to obtain the corresponding slope k′ using the equation: k′=(Etk−Et*Ek)/[Et²−(Et)²].

Here, Etk represents the mathematical expectation of the product of the time instant t of each acquired bus current slope and the bus current slope, Et represents the mathematical expectation of the time instant t of each acquired bus current slope, Ek represents the mathematical expectation of the bus current slope, Et² represents the mathematical expectation of the square of the time instant t of each acquired bus current slope, and (Et)² represents the square of the mathematical expectation of the sampling time instant t.

Since the time intervals for acquisitions of k₀, k₁, k₂ . . . kₖ are equal, Δt′₀, Δt′₁, Δt′₂ . . . Δt′ₖ are also equal. Therefore, the above equation may be simplified to: k′=[n′*>(tk)−Σt*Σk]/[n′*Et²−Σt*Σt], where n′ is a positive integer. To further simplify the calculation process and reduce software computational overhead, n′ in the simplified equation may be set to 2^{m′}, where m′ is a positive integer. When the slope k′ is greater than or equal to the preset slope threshold k′_{T}, it is determined that the load has entered the heavy load operating region. Here, the slope k′ is the second derivative of the bus current with respect to unit time.

For the case where the first derivative of the bus current is determined as the bus current rate of change, the heavy load identification unit 221 compares the bus current rate of change with the corresponding preset bus current first derivative threshold. in response to the bus current rate of change being smaller than or equal to the preset bus current first derivative threshold, it may be determined that the functional motor 211 has entered the heavy load state.

For the case where the second derivative of the bus current is selected as the bus current rate of change, the heavy load identification unit 221 compares the bus current rate of change with the corresponding preset bus current second derivative threshold. In response to the bus current rate of change being smaller than or equal to the preset bus current second derivative threshold, it may be determined that the functional motor 211 has entered the heavy load state.

In some embodiments, the heavy load identification unit 221 may acquire a plurality of bus current parameters and compare the plurality of bus current parameters with their respective preset bus current parameter thresholds to determine whether the plurality of bus current parameters are smaller than or equal to the corresponding preset bus current parameter thresholds, respectively.

For example, the bus current is compared with the corresponding preset bus current threshold, and the bus current difference is compared with the corresponding preset bus current difference threshold. In response to the bus current being greater than or equal to the preset bus current threshold, and the bus current difference being greater than or equal to the preset bus current difference threshold, it is determined that the functional motor 211 has entered the heavy load state.

For example, the bus current, the bus current difference, and the bus current rate of change are compared with the corresponding preset bus current threshold, preset bus current difference threshold, and preset bus current rate-of-change threshold, respectively. In response to all the three bus current parameters being greater than or equal to their respective thresholds, it may be determined that the functional motor 211 has entered the heavy load state.

In some embodiments, the electrical parameter includes a phase current parameter. The phase current parameter includes a phase current, a phase current difference, and a phase current rate of change. The preset electrical parameter thresholds corresponding to the phase current, the phase current difference, and the phase current rate of change are a phase current threshold, a phase current difference threshold, and a phase current rate-of-change threshold, respectively.

The phase current refers to the current of the conducting phase of the functional motor 211. A current sensor or a current sampling resistor may be used to sample and determine the phase current. Considering the AC characteristics of the phase current, the amplitude, peak-to-peak value, or root mean square (RMS) of the conducting phase current may be determined as the phase current.

The phase current may be determined by sampling using a current sampling resistor provided in the corresponding control circuit of the functional motor 211, or by sampling using a current sensor provided in the control circuit.

The phase current difference refers to the difference in the phase current of the functional motor at two adjacent moments. The heavy load identification unit 221 may calculate the difference between the phase current Cₖ acquired at the current moment and the phase current Cₖ₋₁ acquired at the previous moment to obtain ΔCₖ. The phase current difference may be an absolute value, meaning the obtained ΔCₖ is a positive number, thereby facilitating subsequent calculations.

The phase current rate of change characterizes the trend of change of the phase current of the functional motor 211 at corresponding moments. The phase current rate of change may include a first derivative and a second derivative of the phase current as a function of time. The rate of change may be obtained by fitting phase current values determined by sampling at a plurality of moments to obtain a phase current change curve, and taking the slope of this change curve as the phase current rate of change. The slope of this change curve is the first derivative of the phase current. In another embodiment, the slope of the slope of the phase current change curve may be taken as the phase current rate of change. The slope of the slope of the change curve is the second derivative of the phase current.

In some embodiments, the method for the heavy load identification unit 221 to determine whether the electrical parameter is greater than or equal to the corresponding preset electrical parameter threshold includes: acquiring at least one phase current parameter and determining whether the at least one phase current parameter is greater than or equal to the corresponding preset electrical parameter threshold.

In some embodiments, the heavy load identification unit 221 may acquire a plurality of phase current parameters and compare the plurality of phase current parameters with their respective preset phase current parameter thresholds to determine whether the multiple phase current parameters are greater than or equal to the corresponding preset phase current parameter thresholds, respectively.

For example, the phase current is compared with the corresponding preset phase current threshold, and the phase current difference is compared with the corresponding preset phase current difference threshold. In response to the phase current being greater than or equal to the preset phase current threshold, and the phase current difference being greater than or equal to the preset phase current difference threshold, it is determined that the functional motor 211 has entered the heavy load state.

For example, the phase current, the phase current difference, and the phase current rate of change are compared with the corresponding preset phase current threshold, preset phase current difference threshold, and preset phase current rate-of-change threshold, respectively. In response to all the three phase current parameters being greater than or equal to their respective thresholds, it may be determined that the functional motor 211 has entered the heavy load state.

In some embodiments, the electrical parameter includes a bus voltage parameter. The bus voltage parameter includes a bus voltage drop, a bus voltage drop difference, and a bus voltage drop rate of change. The preset electrical parameter thresholds corresponding to the bus voltage drop, the bus voltage drop difference, and the bus voltage drop rate of change are a bus voltage drop threshold, a bus voltage drop difference threshold, and a bus voltage drop rate-of-change threshold, respectively.

The bus voltage drop refers to the relative value of the voltage drop on the bus side of the functional motor 211, i.e., the drop value of the bus voltage during the operation of the functional motor 211 compared to the bus voltage before starting work.

The bus voltage drop difference refers to the difference in the bus voltage drop of the functional motor at two adjacent moments.

The bus voltage drop rate of change characterizes the trend of change of the bus voltage drop of the functional motor 211 at corresponding moments. The bus voltage drop rate of change may include a first derivative and a second derivative of the bus voltage drop as a function of time. The rate of change may be obtained by fitting bus voltage drop values determined by sampling at a plurality of moments to obtain a bus voltage drop change curve, and taking the slope of this change curve as the bus voltage drop rate of change. The slope of this change curve is the first derivative of the bus voltage drop. In another embodiment, the slope of the slope of the bus voltage drop change curve may be taken as the bus voltage drop rate of change. The slope of the slope of the change curve is the second derivative of the bus voltage drop.

In some embodiments, the method for the heavy load identification unit 221 to determine whether the electrical parameter is greater than or equal to the corresponding preset electrical parameter threshold includes: acquiring at least one bus voltage parameter and determining whether the at least one bus voltage parameter is greater than or equal to the corresponding preset electrical parameter threshold.

In some embodiments, the heavy load identification unit 221 may acquire a plurality of bus voltage parameters and compare the plurality of bus voltage parameters with their respective preset bus voltage parameter thresholds to determine whether the plurality of bus voltage parameters are greater than or equal to the corresponding preset bus voltage parameter thresholds, respectively.

For example, the bus voltage drop is compared with the corresponding preset bus voltage drop threshold, and the bus voltage drop difference is compared with the corresponding preset bus voltage drop difference threshold. In response to the bus voltage drop being greater than or equal to the preset bus voltage drop threshold, and the bus voltage drop difference being greater than or equal to the preset bus voltage drop difference threshold, it is determined that the functional motor 211 has entered the heavy load state.

For example, the bus voltage drop, the bus voltage drop difference, and the bus voltage drop rate of change are compared with the corresponding preset bus voltage drop threshold, preset bus voltage drop difference threshold, and preset bus voltage drop rate-of-change threshold, respectively. In response to all the three bus voltage parameters being greater than or equal to their respective thresholds, it may be determined that the functional motor 211 has entered the heavy load state.

The bus voltage drop is taken as an example, as shown in FIG. 18, which is a schematic diagram of determining a heavy load mutation based on a bus voltage drop threshold during the operation of the functional motor 211.

The heavy load identification unit 221 may determine the load condition based on the relative change of the voltage on the bus side. A greater load corresponds to a greater relative voltage drop, and vice versa. In battery-powered electric work vehicles, a greater load corresponds to a more obvious drop of the terminal voltage of the battery pack. The terminal voltage corresponds to the bus voltage, and the bus voltage may reflect the battery pack terminal voltage. The relationship between the bus voltage and the current is shown in FIG. 18.

In some embodiments, the electrical parameter includes a conducting phase voltage parameter. The conducting phase voltage parameter includes a conducting phase voltage drop, a conducting phase voltage drop difference, and a conducting phase voltage drop rate of change. The preset electrical parameter thresholds corresponding to the conducting phase voltage drop, the conducting phase voltage drop difference, and the conducting phase voltage drop rate of change are a conducting phase voltage drop threshold, a conducting phase voltage drop difference threshold, and a conducting phase voltage drop rate-of-change threshold, respectively.

The conducting phase voltage drop refers to the relative value of the voltage drop on the bus side of the functional motor 211, i.e., the drop value of the bus voltage during the operation of the functional motor 211 compared to the bus voltage before starting work.

The conducting phase voltage drop difference refers to the difference in the conducting phase voltage drop of the functional motor at two adjacent moments.

The conducting phase voltage drop rate of change characterizes the trend of change of the conducting phase voltage drop of the functional motor 211 at corresponding moments. The conducting phase voltage drop rate of change may include a first derivative and a second derivative of the conducting phase voltage drop as a function of time. The rate of change may be obtained by fitting conducting phase voltage drops determined by sampling at a plurality of moments to obtain a conducting phase voltage drop change curve, and determining the slope of this change curve as the conducting phase voltage drop rate of change. The slope of this change curve is the first derivative of the conducting phase voltage drop. In another embodiment, the slope of the slope of the conducting phase voltage drop change curve may be determined as the conducting phase voltage drop rate of change. The slope of the slope of the change curve is the second derivative of the conducting phase voltage drop.

In some embodiments, the method for the heavy load identification unit 221 to determine whether the electrical parameter is greater than or equal to the corresponding preset electrical parameter threshold includes: acquiring at least one conducting phase voltage parameter and determining whether the at least one conducting phase voltage parameter is greater than or equal to the corresponding preset electrical parameter threshold.

In some embodiments, the heavy load identification unit 221 may acquire a plurality of conducting phase voltage parameters and compare the plurality of conducting phase voltage parameters with their respective preset conducting phase voltage parameter thresholds to determine whether the plurality of conducting phase voltage parameters are greater than or equal to the corresponding preset conducting phase voltage parameter thresholds, respectively.

For example, the conducting phase voltage drop is compared with the corresponding preset conducting phase voltage drop threshold, and the conducting phase voltage drop difference is compared with the corresponding preset conducting phase voltage drop difference threshold. In response to the conducting phase voltage drop being greater than or equal to the preset conducting phase voltage drop threshold, and the conducting phase voltage drop difference being greater than or equal to the preset conducting phase voltage drop difference threshold, it is determined that the functional motor 211 has entered the heavy load state.

For example, the conducting phase voltage drop, the conducting phase voltage drop difference, and the conducting phase voltage drop rate of change are compared with the corresponding preset conducting phase voltage drop threshold, preset conducting phase voltage drop difference threshold, and preset conducting phase voltage drop rate-of-change threshold, respectively. In response to all the three conducting phase voltage parameters being greater than or equal to their respective thresholds, it may be determined that the functional motor 211 has entered the heavy load state.

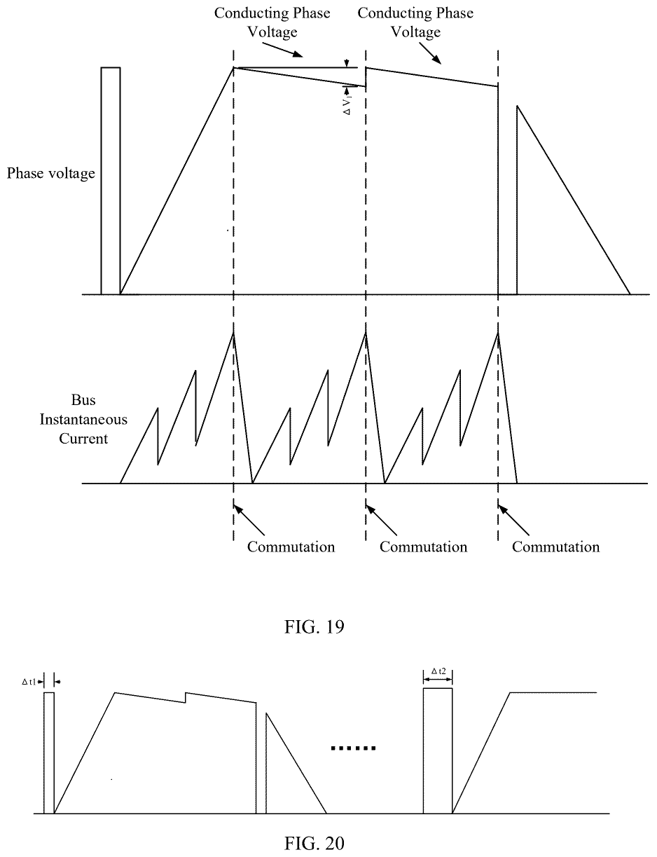

The conducting phase voltage drop is taken as an example, as shown in FIG. 19, which is a schematic diagram of determining a heavy load mutation based on a conducting phase voltage drop threshold during the operation of the functional motor 211.

The heavy load identification unit 221 may determine based on the relative value of the voltage change of the conducting phase within one commutation cycle. When the load increases, the instantaneous current (bus instantaneous current or phase instantaneous current) will increase, causing the phase voltage to change within one commutation cycle. The magnitude of the voltage change is the conducting phase voltage drop. As shown in FIG. 19, ΔV₁ represents the conducting phase voltage drop. The heavy load identification unit 221 compares the conducting phase voltage drop with the corresponding preset conducting phase voltage drop threshold. In response to the conducting phase voltage drop being greater than or equal to the conducting phase voltage drop difference, it may be determined that the functional motor 211 has entered the heavy load state.

In some embodiments, the electrical parameter includes a freewheeling time parameter. The freewheeling time parameter includes freewheeling time, a freewheeling time difference, and a freewheeling time rate of change. The preset electrical parameter thresholds corresponding to the freewheeling time, the freewheeling time difference, and the freewheeling time rate of change are a freewheeling time threshold, a freewheeling time difference threshold, and a freewheeling time rate-of-change threshold, respectively.

The freewheeling time may be directly measured by a timer. The timer is started at each commutation to calculate the freewheeling time. The freewheeling time may characterize the load size, where a larger load corresponds to longer freewheeling time.

The freewheeling time difference refers to the difference in the freewheeling time of the functional motor at two adjacent moments.

The freewheeling time rate of change characterizes the trend of change of the freewheeling time of the functional motor 211 at corresponding moments. The freewheeling time rate of change may include a first derivative and a second derivative of the freewheeling time as a function of time. The rate of change may be obtained by fitting freewheeling time values determined by sampling at a plurality of moments to obtain a freewheeling time change curve, and taking the slope of this change curve as the freewheeling time rate of change. The slope of this change curve is the first derivative of the freewheeling time. In another embodiment, the slope of the slope of the freewheeling time change curve may be taken as the freewheeling time rate of change. The slope of the slope of the change curve is the second derivative of the freewheeling time.

In some embodiments, the method for the heavy load identification unit 221 to determine whether the electrical parameter is greater than or equal to the corresponding preset electrical parameter threshold includes: acquiring at least one freewheeling time parameter and determining whether the at least one freewheeling time parameter is greater than or equal to the corresponding preset electrical parameter threshold.

In some embodiments, the heavy load identification unit 221 may acquire a plurality of freewheeling time parameters and compare the plurality of freewheeling time parameters with their respective preset freewheeling time parameter thresholds to determine whether the plurality of freewheeling time parameters are greater than or equal to the corresponding preset freewheeling time parameter thresholds, respectively.

For example, the freewheeling time is compared with the corresponding preset freewheeling time threshold, and the freewheeling time difference is compared with the corresponding preset freewheeling time difference threshold. In response to the freewheeling time being greater than or equal to the preset freewheeling time threshold, and the freewheeling time difference being greater than or equal to the preset freewheeling time difference threshold, it is determined that the functional motor 211 has entered the heavy load state.

For example, the freewheeling time, the freewheeling time difference, and the freewheeling time rate of change are compared with the corresponding preset freewheeling time threshold, preset freewheeling time difference threshold, and preset freewheeling time rate-of-change threshold, respectively. In response to all the three freewheeling time parameters being greater than or equal to their respective thresholds, it may be determined that the functional motor 211 has entered the heavy load state.

The freewheeling time is taken as an example, as shown in FIG. 20, which is a schematic diagram of the freewheeling time during the operation of the functional motor 211 is provided. The freewheeling time of the functional motor 211 during commutation can characterize the load size. A larger load corresponds to longer freewheeling time, and vice versa. As shown in FIG. 20, Δt₁, Δt₂ represent the freewheeling time. The heavy load identification unit 221 compares the freewheeling time with the corresponding preset freewheeling time threshold. In response to determining that the freewheeling time being greater than or equal to the freewheeling time threshold, it may be determined that the functional motor 211 has entered the heavy load state.

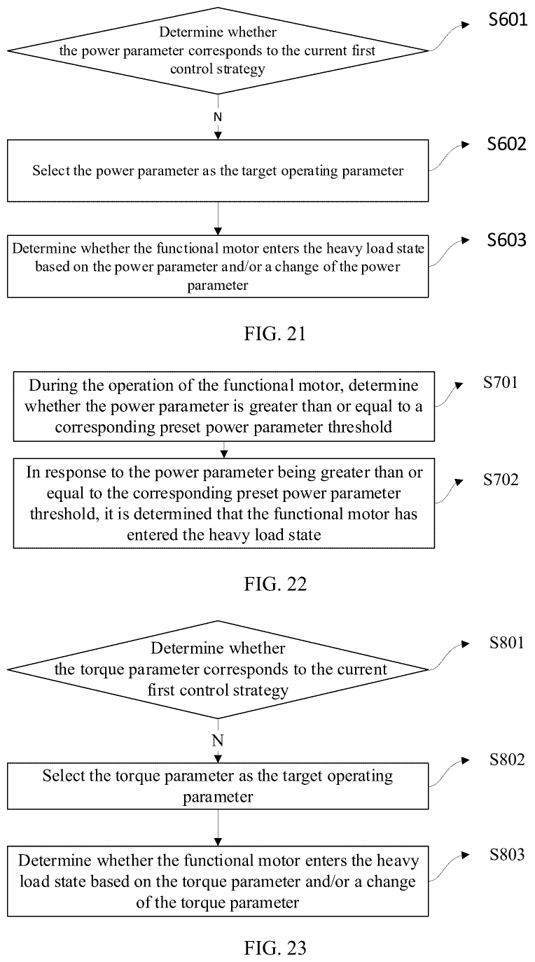

As shown in FIG. 21, in an electric work vehicle according to one or more embodiments of the present disclosure, the heavy load identification unit being configured to select a target operating parameter from the plurality of operating parameters and determine whether the functional motor enters a heavy load state based on the target operating parameter and/or a change of the target operating parameter includes the heavy load identification unit being configured to perform following steps S601 to S603.

S601: Determine whether the power parameter corresponds to the current first control strategy.

S602: In response to the power parameter not corresponding to the first control strategy, select the power parameter as the target operating parameter.

The control strategy corresponding to the power parameter is the power closed-loop control strategy. In response to the control strategy currently adopted by the controller assembly 22 for the functional motor 211 being a non-power closed-loop control strategy, such as the rotational speed closed-loop control strategy, the current closed-loop control strategy, the torque closed-loop control strategy, or the PWM duty cycle open-loop control strategy, the heavy load identification unit 221 may select the power parameter as the target operating parameter.

Selection of the target operating parameter is determined based on the current first control strategy. In response to the first control strategy being a non-power closed-loop control strategy, the heavy load identification unit 221 may select the power parameter as the target operating parameter.

S603: Determine whether the functional motor enters the heavy load state based on the power parameter and/or a change of the power parameter. The heavy load identification unit 221 selects the power parameter as the target operating parameter and further monitors the power parameter. The change of the power parameter may include, for example, a difference obtained by comparing the power parameter acquired at different time instants, a rate of increase or decrease of the power parameter, etc.

As shown in FIG. 22, in an electric work vehicle according to one or more embodiments of the present disclosure, the method for the heavy load identification unit 221 to determine whether the functional motor 211 enters the heavy load state based on the electrical parameter and/or a change of the electrical parameter includes following steps S701 and S702.

At step S701, during the operation of the functional motor, it is determined whether the power parameter is greater than or equal to a corresponding preset power parameter threshold.

At step S702, in response to the power parameter being greater than or equal to the corresponding preset power parameter threshold, it is determined that the functional motor has entered the heavy load state.

In some embodiments, the power parameter includes motor power, a motor power difference, and a motor power rate of change. The preset electrical parameter thresholds corresponding to the motor power, the motor power difference, and the motor power rate of change are a motor power threshold, a motor power difference threshold, and a motor power rate-of-change threshold, respectively.

The heavy load identification unit 221 may calculate the motor power of the functional motor 211 based on the bus voltage and bus current output from the corresponding DC side of the functional motor 211.

The motor power difference refers to the difference in the motor power of the functional motor at two adjacent moments.

The motor power rate of change characterizes the trend of change of the motor power of the functional motor 211 at corresponding moments. The motor power rate of change may include a first derivative and a second derivative of the motor power as a function of time. The rate of change may be obtained by fitting motor power values determined by sampling at a plurality of moments to obtain a motor power change curve, and taking the slope of this change curve as the motor power rate of change. The slope of this change curve is the first derivative of the motor power. In another embodiment, the slope of the slope of the motor power change curve may be taken as the motor power rate of change. The slope of the slope of the change curve is the second derivative of the motor power.

The method for the heavy load identification unit 221 to determine whether the electrical parameter is greater than or equal to the corresponding preset electrical parameter threshold includes: acquiring at least one power parameter and determining whether the at least one power parameter is greater than or equal to the corresponding preset power parameter threshold.

In some embodiments, the heavy load identification unit 221 may acquire a plurality of power parameters and compare the plurality of power parameters with their respective preset power parameter thresholds to determine whether the plurality of power parameters are greater than or equal to the corresponding preset power parameter thresholds, respectively.

For example, the motor power is compared with the corresponding preset motor power threshold, and the motor power difference is compared with the corresponding preset motor power difference threshold. In response to the motor power being greater than or equal to the preset motor power threshold, and the motor power difference being greater than or equal to the preset motor power difference threshold, it is determined that the functional motor 211 has entered the heavy load state.

For example, the motor power, the motor power difference, and the motor power rate of change are compared with the corresponding preset motor power threshold, preset motor power difference threshold, and preset motor power rate-of-change threshold, respectively. In response to all the three power parameters being greater than or equal to their respective thresholds, it may be determined that the functional motor 211 has entered the heavy load state.

As shown in FIG. 23, in an electric work vehicle according to one or more embodiments of the present disclosure, the heavy load identification unit being configured to select a target operating parameter from the plurality of operating parameters and determine whether the functional motor enters a heavy load state based on the target operating parameter and/or a change of the target operating parameter includes the heavy load identification unit being configured to perform following steps S801 to S803.

S801: Determine whether the torque parameter corresponds to the current first control strategy.

S802: In response to the torque parameter not corresponding to the first control strategy, select the torque parameter as the target operating parameter.

The control strategy corresponding to the torque parameter is the torque closed-loop control strategy. In response to the control strategy currently adopted by the controller assembly 22 for the functional motor 211 being a non-torque closed-loop control strategy, such as the rotational speed closed-loop control strategy, the power closed-loop control strategy, the current closed-loop control strategy, or the PWM duty cycle open-loop control strategy, the heavy load identification unit 221 may select the torque parameter as the target operating parameter.

Selection of the target operating parameter is determined based on the current first control strategy. In response to the first control strategy being a non-torque closed-loop control strategy, the heavy load identification unit 221 may select the torque parameter as the target operating parameter.

S803: Determine whether the functional motor enters the heavy load state based on the torque parameter and/or a change of the torque parameter. The heavy load identification unit 221 selects the torque parameter as the target operating parameter and further monitors the torque parameter. The change of the torque parameter may include, for example, a difference obtained by comparing the torque parameter acquired at different time instants, a rate of increase or decrease of the torque parameter, etc.

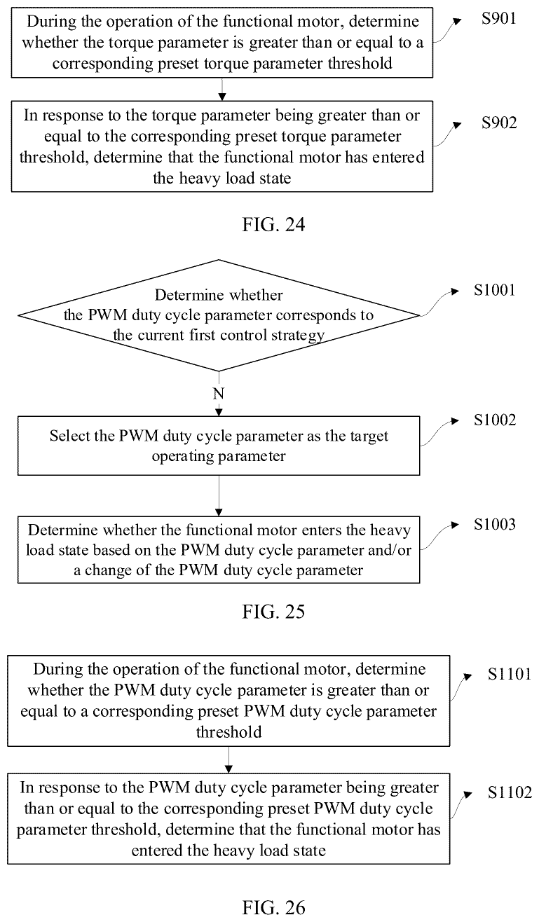

As shown in FIG. 24, in an electric work vehicle according to one or more embodiments of the present disclosure, the method for the heavy load identification unit 221 to determine whether the functional motor 211 enters the heavy load state based on the torque parameter and/or the change of the torque parameter includes following steps S901 to S902.

At step S901, during the operation of the functional motor, it is determined whether the torque parameter is greater than or equal to a corresponding preset torque parameter threshold.

At step S902, in response to the torque parameter being greater than or equal to the corresponding preset torque parameter threshold, it is determined that the functional motor has entered the heavy load state.

In some embodiments, the torque parameter includes a motor torque, a motor torque difference, and a motor torque rate of change. The preset torque parameter thresholds corresponding to the motor torque, the motor torque difference, and the motor torque rate of change are a motor torque threshold, a motor torque difference threshold, and a motor torque rate-of-change threshold, respectively.

The motor torque difference refers to the difference in the motor torque of the functional motor at two adjacent moments.

The motor torque rate of change characterizes the trend of change of the motor torque of the functional motor 211 at corresponding moments. The motor torque rate of change may include a first derivative and a second derivative of the motor torque as a function of time. The rate of change may be obtained by fitting the motor torque values determined by sampling at a plurality of moments to obtain a motor torque change curve, and taking the slope of this change curve as the motor torque rate of change. The slope of this change curve is the first derivative of the motor torque. In another embodiment, the slope of the slope of the motor torque change curve may be taken as the motor torque rate of change. The slope of the slope of the change curve is the second derivative of the motor torque.

The method for the heavy load identification unit 221 to determine whether the torque parameter is greater than or equal to the corresponding preset torque parameter threshold includes: acquiring at least one motor torque parameter and determining whether the at least one motor torque parameter is greater than or equal to the corresponding preset torque parameter threshold.

In some embodiments, the heavy load identification unit 221 may acquire a plurality of torque parameters and compare the plurality of torque parameters with their respective preset torque parameter thresholds to determine whether the plurality of torque parameters are greater than or equal to the corresponding preset torque parameter thresholds, respectively.

For example, the motor torque is compared with the corresponding preset motor torque threshold, and the motor torque difference is compared with the corresponding preset motor torque difference threshold. In response to the motor torque being greater than or equal to the preset motor torque threshold, and the motor torque difference being greater than or equal to the preset motor torque difference threshold, it is determined that the functional motor 211 has entered the heavy load state.

For example, the motor torque, the motor torque difference, and the motor torque rate of change are compared with the corresponding preset motor torque threshold, preset motor torque difference threshold, and preset motor torque rate-of-change threshold, respectively. In response to all the three torque parameters being greater than or equal to their respective thresholds, it may be determined that the functional motor 211 has entered the heavy load state.

As shown in FIG. 25, in an electric work vehicle according to one or more embodiments of the present disclosure, the heavy load identification unit being configured to select a target operating parameter from the plurality of operating parameters and determine whether the functional motor enters a heavy load state based on the target operating parameter and/or a change of the target operating parameter includes the heavy load identification unit being configured to perform following steps S1001 to S1003.

S1001: Determine whether the PWM duty cycle parameter corresponds to the current first control strategy.

S1002: In response to the PWM duty cycle parameter not corresponding to the first control strategy, select the PWM duty cycle parameter as the target operating parameter.

The control strategy matching the PWM duty cycle parameter is the PWM duty cycle open-loop control strategy. In response to the control strategy currently adopted by the controller assembly 22 for the functional motor 211 being a non-PWM duty cycle open-loop control strategy, such as the rotational speed closed-loop control strategy, the current closed-loop control strategy, the torque closed-loop control strategy, or the power closed-loop control strategy, the heavy load identification unit 221 may select the PWM duty cycle parameter as the target operating parameter.

Selection of the target operating parameter is determined based on the current first control strategy. In response to the first control strategy being a non-PWM duty cycle open-loop control strategy, the heavy load identification unit 221 may select the PWM duty cycle parameter as the target operating parameter.

S1003: Determine whether the functional motor enters the heavy load state based on the PWM duty cycle parameter and/or a change of the PWM duty cycle parameter. The heavy load identification unit 221 selects the PWM duty cycle parameter as the target operating parameter and further monitors the PWM duty cycle parameter. The change of the PWM duty cycle parameter may include, for example, a difference obtained by comparing the PWM duty cycle parameter acquired at different time instants, a rate of increase or decrease of the PWM duty cycle parameter, etc.

As shown in FIG. 26, in an electric work vehicle according to one or more embodiments of the present disclosure, the method for the heavy load identification unit 221 to determine whether the functional motor 211 enters the heavy load state based on the electrical parameter and/or a change of the electrical parameter includes following steps S1101 to S1102.

At step S1101, during the operation of the functional motor, it is determined whether the PWM duty cycle parameter is greater than or equal to a corresponding preset PWM duty cycle parameter threshold.

At step S1102, in response to the PWM duty cycle parameter being greater than or equal to the corresponding preset PWM duty cycle parameter threshold, it is determined that the functional motor has entered the heavy load state.

In some embodiments, the PWM duty cycle parameter includes the duty cycle of the corresponding control signal of the functional motor, the duty cycle difference, and the duty cycle rate of change. The preset duty cycle parameter thresholds corresponding to the duty cycle, the duty cycle difference, and the duty cycle rate of change are a duty cycle threshold, a duty cycle difference threshold, and a duty cycle rate-of-change threshold, respectively.

The duty cycle refers to the duty cycle of the PWM control signal for the functional motor 211.

The duty cycle difference refers to the difference in the duty cycle of the functional motor 211 at two adjacent moments.

The duty cycle rate of change characterizes the trend of change of the duty cycle of the functional motor 211 at corresponding moments. The duty cycle rate of change may include a first derivative and a second derivative of the duty cycle as a function of time. The rate of change may be obtained by fitting duty cycle values determined by sampling at a plurality of moments to obtain a duty cycle change curve, and taking the slope of this change curve as the duty cycle rate of change. The slope of this change curve is the first derivative of the duty cycle. In another embodiment, the slope of the slope of the duty cycle change curve may be taken as the duty cycle rate of change. The slope of the slope of the change curve is the second derivative of the duty cycle.

The method for the heavy load identification unit 221 to determine whether the PWM duty cycle parameter is greater than or equal to the corresponding preset duty cycle parameter threshold includes: acquiring at least one PWM duty cycle parameter and determining whether the at least one PWM duty cycle parameter is greater than or equal to the corresponding preset duty cycle parameter threshold.

In some embodiments, the heavy load identification unit 221 may acquire a plurality of PWM duty cycle parameters and compare the plurality of PWM duty cycle parameters with their respective preset duty cycle parameter thresholds to determine whether the plurality of PWM duty cycle parameters are greater than or equal to the corresponding preset duty cycle parameter thresholds, respectively.

For example, the duty cycle is compared with the corresponding preset duty cycle threshold, and the duty cycle difference is compared with the corresponding preset duty cycle difference threshold. In response to the duty cycle being greater than or equal to the preset duty cycle threshold, and the duty cycle difference being greater than or equal to the preset duty cycle difference threshold, it is determined that the functional motor 211 has entered the heavy load state.

For example, the duty cycle, the duty cycle difference, and the duty cycle rate of change are compared with the corresponding preset duty cycle threshold, preset duty cycle difference threshold, and preset duty cycle rate-of-change threshold, respectively. In response to all the three PWM duty cycle parameters being greater than or equal to their respective thresholds, it may be determined that the functional motor 211 has entered the heavy load state.

In the aforementioned embodiments, the heavy load identification unit 221 selects one type of operating parameter from the plurality of operating parameters as the target operating parameter and determines whether the functional motor 211 enters the heavy load state based on the target operating parameter and/or the change of the target operating parameter. In further embodiments, the heavy load identification unit 221 may select a plurality of operating parameters that do not match the current first control strategy as target operating parameters and determine whether the functional motor 211 enters the heavy load state based on the ratio of the plurality of selected operating parameters and the change of the ratio.

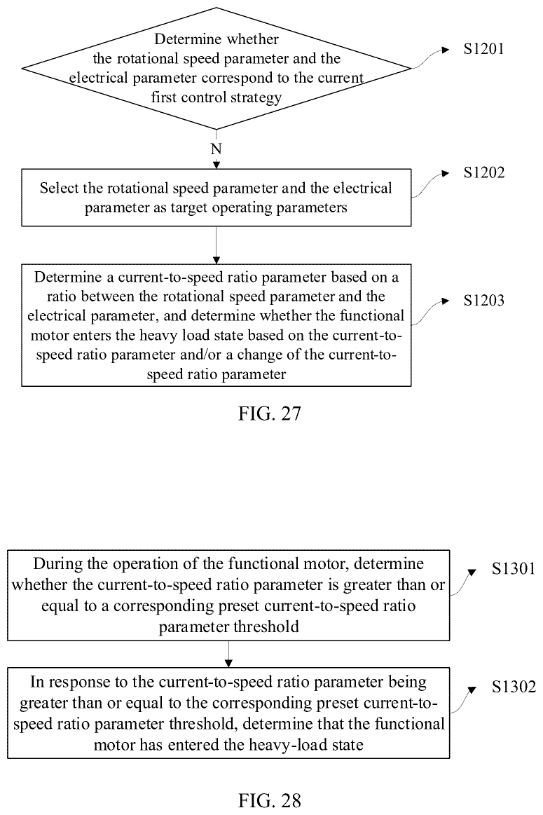

As shown in FIG. 27, in an electric work vehicle according to one or more embodiments of the present disclosure, the heavy load identification unit being configured to select a target operating parameter from the plurality of operating parameters and determine whether the functional motor enters a heavy load state based on the target operating parameter and/or a change of the target operating parameter includes the heavy load identification unit being configured to perform following steps S1201 to S1203.

S1201: Determine whether the rotational speed parameter and the electrical parameter correspond to the current first control strategy.

S1202: In response to the rotational speed parameter and the electrical parameter not corresponding to the first control strategy, select the rotational speed parameter and the electrical parameter as target operating parameters.

Selection of the target operating parameters is determined based on the current first control strategy. In response to the first control strategy being a non-rotational-speed closed-loop control strategy and a non-current closed-loop control strategy, the heavy load identification unit 221 may select the rotational speed parameter and the electrical parameter as the target operating parameters.

S1203: Determine a current-to-speed ratio parameter based on a ratio between the rotational speed parameter and the electrical parameter, and determine whether the functional motor enters the heavy load state based on the current-to-speed ratio parameter and/or a change of the current-to-speed ratio parameter.

The change of the current-to-speed ratio parameter may include, for example, a difference obtained by comparing the ratio of the rotational speed parameter to the electrical parameter acquired at different time instants, a rate of increase or decrease, etc.

In some embodiments, the current-to-speed ratio parameter includes a current-to-speed ratio, a current-to-speed ratio difference, and a current-to-speed ratio rate of change. The preset current-to-speed ratio parameter thresholds corresponding to the current-to-speed ratio, the current-to-speed ratio difference, and the current-to-speed ratio rate of change are a current-to-speed ratio threshold, a current-to-speed ratio difference threshold, and a current-to-speed ratio rate-of-change threshold, respectively.

The current-to-speed ratio refers to the ratio of the electrical parameter to the rotational speed parameter. The electrical parameter may include the bus current parameter, the phase current parameter, the bus voltage parameter, the conducting phase voltage parameter, and the freewheeling time parameter. The rotational speed parameter may include the motor rotational speed parameter and the motor sector time parameter.

The current-to-speed ratio difference refers to the difference in the current-to-speed ratio at two adjacent moments.

The current-to-speed ratio rate of change characterizes the trend of change of the current-to-speed ratio at corresponding moments. The current-to-speed ratio rate of change may include a first derivative and a second derivative of the current-to-speed ratio as a function of time. The rate of change may be obtained by fitting current-to-speed ratio values determined by sampling at a plurality of moments to obtain a current-to-speed ratio change curve, and taking the slope of this change curve as the current-to-speed ratio rate of change. The slope of this change curve is the first derivative of the current-to-speed ratio. In another embodiment, the slope of the slope of the current-to-speed ratio change curve may be taken as the current-to-speed ratio rate of change. The slope of the slope of the change curve is the second derivative of the current-to-speed ratio.

In some embodiments, the ratio of the rotational speed parameter to the electrical parameter is determined as the current-to-speed ratio parameter. Those skilled in the art can understand that the ratio of the electrical parameter to the rotational speed parameter may also be taken as the current-to-speed ratio parameter.

As shown in FIG. 28, in an electric work vehicle according to one or more embodiments of the present disclosure, for the case where the motor speed parameter is selected as the speed parameter, the method for the heavy load identification unit 221 to determine whether the functional motor 211 has entered the heavy load state based on the current-to-speed ratio parameter and/or the change in the current-to-speed ratio parameter includes following steps S1301 to S1302.

At step S1301, during the operation of the functional motor, it is determined whether the current-to-speed ratio parameter is greater than or equal to a corresponding preset current-to-speed ratio parameter threshold.

At step S1302, in response to the current-to-speed ratio parameter being greater than or equal to the corresponding preset current-to-speed ratio parameter threshold, it is determined that the functional motor has entered the heavy load state.

In some embodiments, the ratio of the rotational speed parameter to the electrical parameter is determined as the flow ratio parameter. Those skilled in the art may understand that the ratio of the electrical parameter to the rotational speed parameter may also be used as the flow ratio parameter.

The method for the heavy load identification unit 221 to determine whether the current-to-speed ratio parameter is greater than or equal to the corresponding preset current-to-speed ratio parameter threshold includes: acquiring at least one current-to-speed ratio parameter and determining whether the at least one current-to-speed ratio parameter is greater than or equal to the corresponding preset current-to-speed ratio parameter threshold.

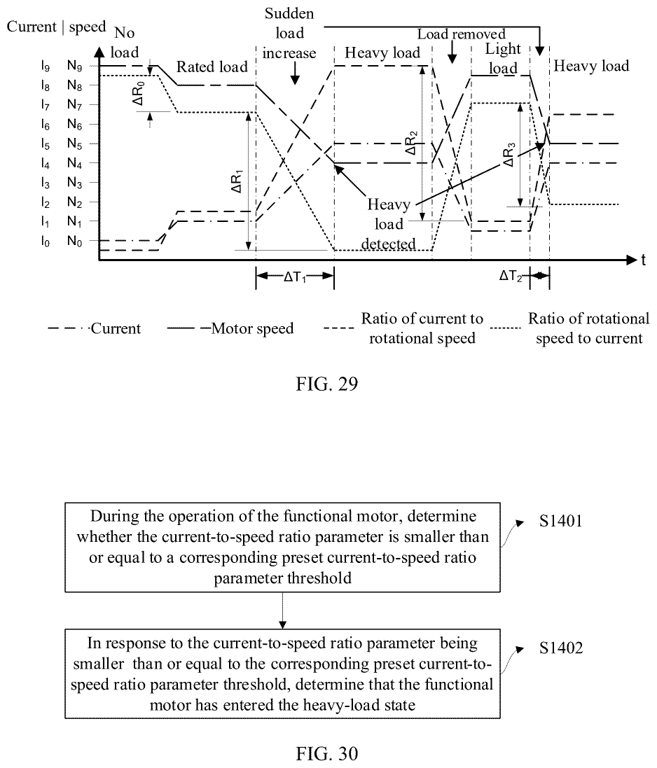

FIG. 29 is a schematic diagram of determining a heavy load mutation based on a current-to-speed ratio threshold during operation of the functional motor 211. Taking the motor speed as the selected rotational speed parameter and the bus current as the selected electrical parameter as an example, the current-to-speed ratio is determined based on the ratio of the motor speed and the bus current. Here, when the ratio of the bus current to the motor speed is used as the current-to-speed ratio, and the current-to-speed ratio is greater than or equal to the corresponding current-to-speed ratio threshold, it may be determined that the functional motor 211 has entered the heavy load state; when the ratio of the motor speed to the bus current is determined as the current-to-speed ratio, and the current-to-speed ratio is smaller than or equal to the corresponding current-to-speed ratio threshold, it may be determined that the functional motor 211 has entered the heavy load state.

In some embodiments, the heavy load identification unit 221 may acquire a plurality of current-to-speed ratio parameters, compare the plurality of current-to-speed ratio parameters with their respective preset current-to-speed ratio parameter thresholds, and determine whether the plurality of current-to-speed ratio parameters are greater than or equal to the corresponding preset current-to-speed ratio parameter thresholds, respectively.

For example, the current-to-speed ratio is compared with the corresponding preset current-to-speed ratio threshold, and the current-to-speed ratio difference is compared with the corresponding preset current-to-speed ratio difference threshold. In response to the current-to-speed ratio being greater than or equal to the preset current-to-speed ratio threshold, and the current-to-speed ratio difference being greater than or equal to the preset current-to-speed ratio difference threshold, it is determined that the functional motor 211 has entered the heavy load state.

For example, the current-to-speed ratio, the current-to-speed ratio difference, and the current-to-speed ratio rate of change are compared with the corresponding preset current-to-speed ratio threshold, preset current-to-speed ratio difference threshold, and preset current-to-speed ratio rate-of-change threshold, respectively. In response to all the three current-to-speed ratio parameters being greater than or equal to their respective thresholds, it may be determined that the functional motor 211 has entered the heavy load state.

As shown in FIG. 30, in an electric work vehicle according to one or more embodiments of the present disclosure, for the case where the motor sector time parameter is selected as the speed parameter, the method for the heavy load identification unit 221 to determine whether the functional motor 211 has entered the heavy load state based on the current-to-speed ratio parameter and/or the change in the current-to-speed ratio parameter includes following steps S1401 to S1402.

At step S1401, during the operation of the functional motor, it is determined whether the current-to-speed ratio parameter is smaller than or equal to a corresponding preset current-to-speed ratio parameter threshold.

At step S1402, in response to the current-to-speed ratio parameter being smaller than or equal to the corresponding preset current-to-speed ratio parameter threshold, it is determined that the functional motor has entered the heavy load state.

Correspondingly, the method for the heavy load identification unit 221 to determine whether the current-to-speed ratio parameter is smaller than or equal to the corresponding preset current-to-speed ratio parameter threshold includes: acquiring at least one current-to-speed ratio parameter and determining whether the at least one current-to-speed ratio parameter is smaller than or equal to the corresponding preset current-to-speed ratio parameter threshold.

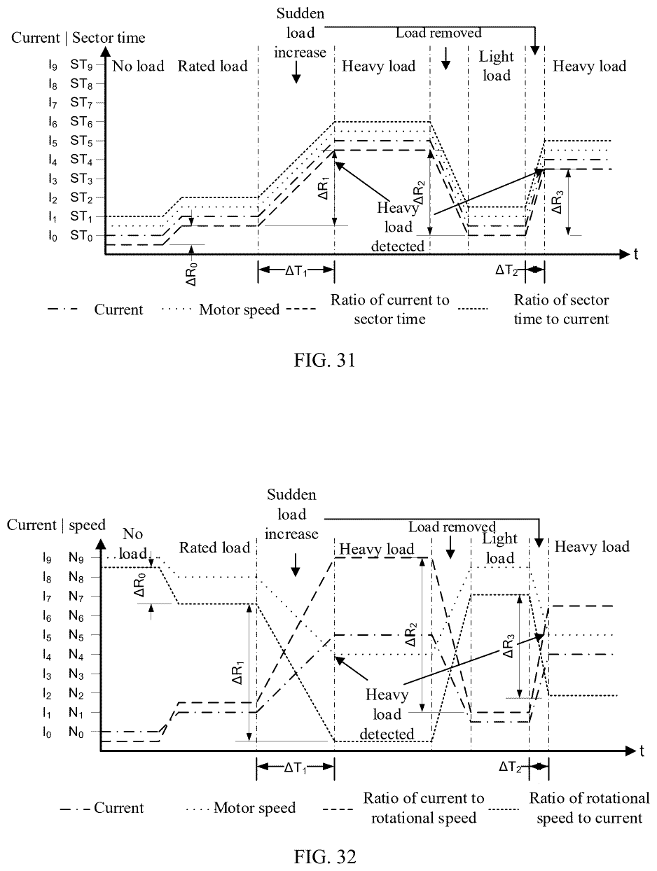

FIG. 31 is a schematic diagram of determining heavy load mutation based on a current-to-speed ratio threshold during operation of the functional motor 211. Taking the motor sector time as the selected rotational speed parameter and the bus current as the selected electrical parameter as an example, the current-to-speed ratio is determined based on the ratio of the motor sector time and the bus current.

The following uses the ratio of bus current to motor speed and the ratio of motor speed to bus current as the current-to-speed ratio to illustrate the method embodiment for determining heavy load mutation. The logic and method for judgment using the ratio of bus current to motor sector time and the ratio of motor sector time to current as the current-to-speed ratio are the same.

The heavy load identification unit 221 may determine whether the current ratio Rₖ (the ratio of the current to the rotational speed or the ratio of the rotational speed to the current) is greater than or equal to (for the ratio of the current to the rotational speed) or smaller than or equal to (for ratio of the rotational speed to the current) a preset ratio threshold RT. In the case of positive determination, it is determined that the load has entered the heavy load operating region.

Furthermore, a time constraint may be added. In response to the current ratio Rₖ (the ratio of the current to the rotational speed or the ratio of the rotational speed to the current) being greater than or equal to (for the ratio of the current to the rotational speed) or smaller than or equal to (for the ratio of the rotational speed to the current) the preset ratio threshold R_{T} within a preset time interval ΔT, which may be 0.01 to 10 seconds, it is determined that the load has entered the heavy load operating region.

Further still, the added time constraint may be segmented by presetting X ΔTₓ time intervals, for example, X=4, ΔT₀=10 seconds, ΔT₁=1 second, ΔT₂=0.1 second, ΔT₃=0.01 second. When within ΔT₀ (10 seconds) the current ratio Rₖ (the ratio of the current to the rotational speed or the ratio of the rotational speed to the current) is greater than or equal to (for the ratio of the current to the rotational speed) or smaller than or equal to (for the ratio of the rotational speed to the current) R_{T0}, and/or within ΔT₁ (1 second) the current ratio Rₖ is greater than or equal to (for the ratio of the current to the rotational speed) or smaller than or equal to (for the ratio of the rotational speed to the current) R_{T1}, and/or within ΔT₂ (0.1 second) the current ratio Rₖ is greater than or equal to (for the ratio of the current to the rotational speed) or smaller than or equal to (for the ratio of the rotational speed to the current) R_{T2}, and/or within ΔT₃ (0.01 second) the current ratio Rₖ is greater than or equal to (for the ratio of the current to the rotational speed) or smaller than or equal to (for the ratio of the rotational speed to the current) R_{T3}, it is determined that the load has entered the heavy load operating region. R_{T0} to R_{T3} satisfy the relational expression (13): R_{T0}≥R_{T1}≥R_{T2}≥R_{T3}, or R_{T0}≤R_{T1}≤R_{T2}≤R_{T3}.

The relationship for determining entry into heavy-load between the ratio threshold and the preset rotational speed of each gear also includes the aforementioned time conditions.

The preset current-to-speed ratio threshold corresponding to the current-to-speed ratio may be set as an absolute value or as a proportional value.

For the case where the threshold is set as an absolute value, examples are as follows.
(1) The ratio thresholds for respective gears are the same under the same time interval condition.

After adding the time constraint, the ratio thresholds for the same gear in different time intervals are shown in Table 37 below.

TABLE 37

| Ratio | | | | |
|---|---|---|---|---|
| Threshold | ΔT₀ | ΔT₁ | ΔT₂ | ΔT₃ |
| Low Gear | R_{AL0} | R_{AL1} | R_{AL2} | R_{AL3} |
| Medium Gear | R_{AM0} | R_{AM1} | R_{AM2} | R_{AM3} |
| High Gear | R_{AH0} | R_{AH1} | R_{AH2} | R_{AH3} |

(2) The ratio thresholds for each gear are different under the same time interval condition.

The ratio threshold is positively correlated with the gear. After adding the time constraint, the ratio thresholds for the same gear in different time intervals are shown in Table 38 below.

TABLE 38

| Ratio | | | | |
|---|---|---|---|---|
| Threshold | ΔT₀ | ΔT₁ | ΔT₂ | ΔT₃ |
| Low Gear | R_{BL0} | R_{BL1} | R_{BL2} | R_{BL3} |
| Medium Gear | R_{BM0} | R_{BM1} | R_{BM2} | R_{BM3} |
| High Gear | R_{BH0} | R_{BH1} | R_{BH2} | R_{BH3} |

In another embodiment, the ratio threshold is negatively correlated with the gear. After adding the time constraint, the ratio thresholds for the same gear in different time intervals are shown in Table 39 below.

TABLE 39

| Ratio | | | | |
|---|---|---|---|---|
| Threshold | ΔT₀ | ΔT₁ | ΔT₂ | ΔT₃ |
| Low Gear | R_{CL0} | R_{CL1} | R_{CL2} | R_{CL3} |
| Medium Gear | R_{CM0} | R_{CM1} | R_{CM2} | R_{CM3} |
| High Gear | R_{CH0} | R_{CH1} | R_{CH2} | R_{CH3} |

For the case where the threshold is set as a proportional value, examples are as follows.
(1) The proportional values for respective gears are the same within the same time interval condition.

After adding the time constraint, the ratio thresholds for the same gear in different time intervals are shown in Table 40 below.

TABLE 40

| Ratio | | | | |
|---|---|---|---|---|
| Threshold | ΔT₀ | ΔT₁ | ΔT₂ | ΔT₃ |
| Low Gear | R_{DL0} | R_{DL1} | R_{DL2} | R_{DL3} |
| Medium Gear | R_{DM0} | R_{DM1} | R_{DM2} | R_{DM3} |
| High Gear | R_{DH0} | R_{DH1} | R_{DH2} | R_{DH3} |

(2) The proportional values for respective gears are different under the same time interval condition.

The proportional value is positively correlated with the gear. After adding the time constraint, the ratio thresholds for the same gear in different time intervals are shown in Table 41 below.

TABLE 41

| Ratio | | | | |
|---|---|---|---|---|
| Threshold | ΔT₀ | ΔT₁ | ΔT₂ | ΔT₃ |
| Low Gear | R_{EL0} | R_{EL1} | R_{EL2} | R_{EL3} |
| Medium Gear | R_{EM0} | R_{EM1} | R_{EM2} | R_{EM3} |
| High Gear | R_{EH0} | R_{EH1} | R_{EH2} | R_{EH3} |

In another embodiment, the proportional value is negatively correlated with the gear. After adding the time constraint, the proportional values for the same gear in different time intervals are shown in Table 42 below.

TABLE 42

| Ratio | | | | |
|---|---|---|---|---|
| Threshold | ΔT₀ | ΔT₁ | ΔT₂ | ΔT₃ |
| Low Gear | R_{FL0} | R_{FL1} | R_{FL2} | R_{FL3} |
| Medium Gear | R_{FM0} | R_{FM1} | R_{FM2} | R_{FM3} |
| High Gear | R_{FH0} | R_{FH1} | R_{FH2} | R_{FH3} |

FIG. 32 is a schematic diagram of determining a heavy load mutation based on a current-to-speed ratio difference threshold during operation of the functional motor 211. The ratio of the bus current to the motor speed or the ratio of the motor speed to the bus current is used as the current-to-speed ratio. By comparing the current-to-speed ratio difference with the corresponding preset current-to-speed ratio difference threshold, it is determined whether the functional motor 211 has entered the heavy load state.

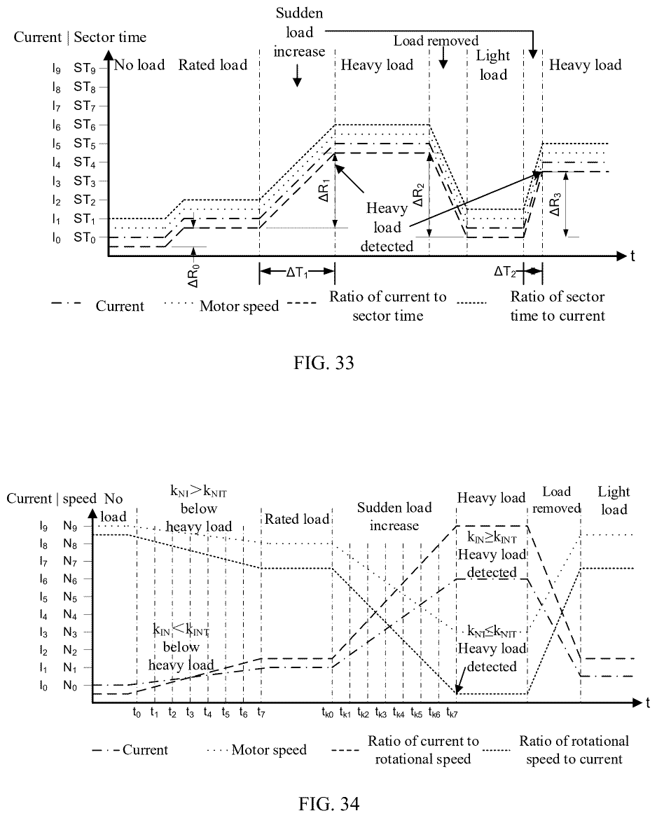

FIG. 33 is a schematic diagram of determining a heavy load mutation based on a current-to-speed ratio difference threshold during operation of the functional motor 211. The ratio of the bus current to the motor sector time or the ratio of the motor sector time to the bus current is used as the current-to-speed ratio. By comparing the current-to-speed ratio difference with the corresponding preset current-to-speed ratio difference threshold, it is determined whether the functional motor 211 has entered the heavy load state.

The following uses the ratio of the bus current to the motor speed and the ratio of the motor speed to the bus current as the current-to-speed ratio for explanation.

The heavy load identification unit 221 may calculate the difference ΔRₖ between the ratio Rₖ (the ratio of the current to the rotational speed or the ratio of the rotational speed to the current) acquired at the current moment and the ratio Rₖ₋₁ acquired at the previous moment. If ΔRₖ is greater than or equal to the preset ratio difference threshold ΔR_{T}, it is determined that the load has entered the heavy load operating region.

Furthermore, a time constraint may be added. In response to the current ratio difference ΔRₖ is greater than or equal to the ratio difference threshold ΔR_{T} within a preset time interval ΔT, which may be, for example, 0.01 to 10 seconds, it is determined that the load has entered the heavy load operating region.

Further still, the added time constraint may be segmented by presetting X ΔTₓ time intervals. For example, X=4, ΔT₀=10 seconds, ΔT₁=1 second, ΔT₂=0.1 second, ΔT₃=0.01 second. The difference ΔR_{kg} between the ratio Rₖ acquired at the current moment and the ratio R_{g} acquired at a moment ΔT0 (10 seconds) earlier is calculated, the difference ΔRₖₕ between Rₖ and the ratio Rh acquired at a moment ΔT₁ (1 second) earlier is calculated, the difference ΔRₖᵢ between Rₖ and the ratio Rᵢ acquired at a moment ΔT₂ (0.1 second) earlier is calculated, and the difference ΔRₖⱼ between Rₖ and the ratio Rⱼ acquired at a moment ΔT₃ (0.01 second) earlier is calculated. If ΔR_{kg} is greater than or equal to the preset ratio difference threshold ΔR_{T0}, and/or ΔRₖₕ is greater than or equal to the preset ratio difference threshold ΔR_{T1}, and/or ΔRₖᵢ is greater than or equal to the preset ratio difference threshold ΔR_{T}2, and/or ΔRₖⱼ is greater than or equal to the preset ratio difference threshold ΔR_{T}3, it is determined that the load has entered the heavy load operating region. ΔR_{T0} to ΔR_{T3} satisfy the relational expression (14): ΔR_{T0}≥ΔR_{T1}≥ΔR_{T2}≥ΔR_{T3}.

The relationship for determining entry into heavy load between the ratio difference and the preset ratio for each gear also includes the aforementioned time conditions.

Similarly, the preset current-to-speed ratio threshold corresponding to the current-to-speed ratio may be set as an absolute value or as a proportional value.

FIG. 34 is a schematic diagram of determining a heavy load mutation based on a current-to-speed ratio rate-of-change threshold during operation of the functional motor 211. The ratio of the bus current to the motor speed or the ratio of the motor speed to the bus current is used as the current-to-speed ratio. By comparing the current-to-speed ratio rate of change with the corresponding preset current-to-speed ratio rate-of-change threshold, it is determined whether the functional motor 211 has entered the heavy load state.

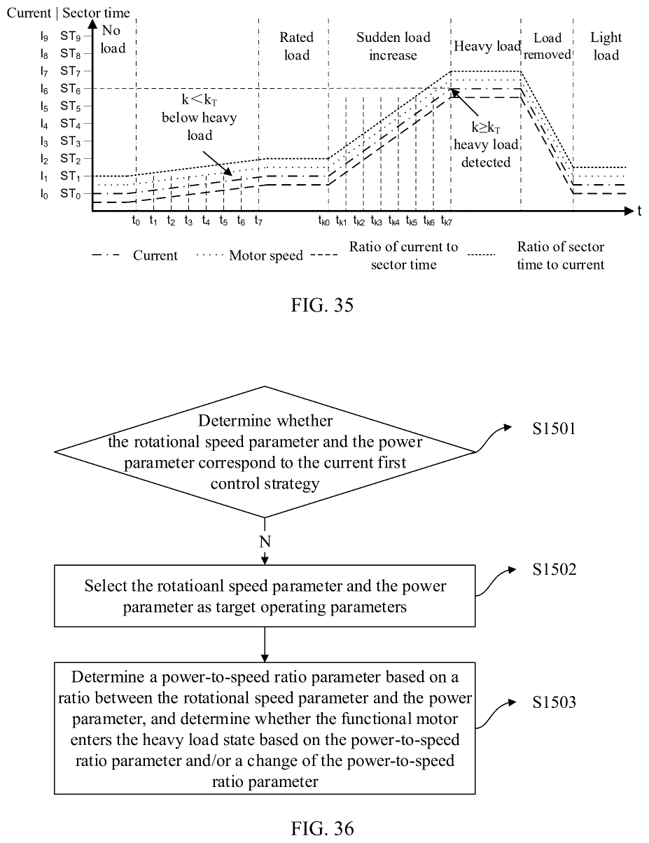

FIG. 35 is a schematic diagram of determining a heavy load mutation based on a current-to-speed ratio rate-of-change threshold during operation of the functional motor 211. The ratio of the bus current to the motor sector time or the ratio of the motor sector time to the bus current is used as the current-to-speed ratio. By comparing the current-to-speed ratio rate of change with the corresponding preset current-to-speed ratio rate-of-change threshold, it is determined whether the functional motor 211 has entered the heavy load state.

The following uses the ratio of the bus current to the motor speed and the ratio of the motor speed to the bus current as the current-to-speed ratio for explanation.

The heavy load identification unit 221 may acquire ratios R₀, R₁, R₂ . . . Rₖ at time instants t₀, t₁, t₂ . . . tₖ, perform linear fitting on R₀, R₁, R₂ . . . Rₖ, and obtain the corresponding curve slope k using the equation: k=(Eti−Et*Ei)/[Et²−(Et)²].

Etr represents the mathematical expectation of the product of the sampling time instant t and the ratio r, Et represents the mathematical expectation of the sampling time instant t, Er represents the mathematical expectation of the ratio, Et² represents the mathematical expectation of the square of the sampling time instant t, and (Et)² represents the square of the mathematical expectation of the sampling time instant t.

Assuming Δt₀=t₁−t₀, Δt₁=t₂−t₁ . . . , Δtₖ=tₖ. 1−tₖ, for the convenience of software calculation, it is generally designed that Δt₀=Δt₁= . . . =Δtₖ. Therefore, the above equation may be simplified to: k=[n*Σ(t*r)−Σt*Σr]/[n*Σt²−Σt*Σt], where n is a positive integer. To further simplify the calculation process and reduce software computational overhead, n in this simplified equation may be set to 2^{m}, where m is a positive integer.

When the slope k is greater than or equal to (for the ratio of the current to the rotational speed, k_{IN}≥k_{INT} in FIG. 34) or smaller than or equal to (for the ratio of the rotational speed to the current, k_{NI}≤k_{NIT} in FIG. 34) the preset slope threshold k_{T}, it is determined that the load has entered the heavy load operating region.

Furthermore, to achieve better determination results, a ratio filtering method may be adopted on the basis of the above. Thus, the aforementioned ratios R₀, R₁, R₂ . . . Rₖ are values obtained after filtering. When using fixed-window filtering series methods, the values of Δt₀, Δt₁, Δt₂ . . . Δtₖ are the time intervals for X ratio samples. For example, if the ratio is acquired every 1 ms and X=8 is preset, then a filtered value is calculated every 8 ms, so Δt₀=Δt₁=Δt₂=Δtₖ=8 ms; when using sliding window filtering series methods, with the same preset conditions, Δt₀=Δt₁=Δt₂=Δtₖ=1 ms. After each fixed-window or sliding-window filtering is completed, equation (15) is used to calculate the slope k, which is the first-order derivative value of the ratio with respect to unit time.

Furthermore, when the operating ratio range of the motor is large, the values of Δt0, Δt₁, Δt₂ . . . Δtₖ may be dynamically adjusted according to the current motor ratio. This is because when Δt₀, Δt₁, Δt₂ . . . Δtₖ are too small, and the motor ratio is relatively low, the ratio sampling frequency is much higher than the motor ratio filtering frequency, and the sampled ratio at each moment might be the same, unnecessarily consuming computing resources, or when the motor ratio fluctuates on a small time scale, it can easily interfere with the calculation results, leading to misjudgment; when Δt₀, Δt₁, Δt₂ . . . Δtₖ are too large, and the motor ratio is relatively high, the ratio sampling is much lower than the actual ratio change frequency, resulting in relatively large fluctuations between the obtained data, or it is possible that the actual ratio rate of change already meets the application requirements, but the actual calculation and judgment fail to identify it. Therefore, the adjustment rule for Δt₀, Δt₁, Δt₂ . . . Δtₖ is: when the ratio is relatively high, the time interval is relatively small; when the ratio is relatively low, the time interval is relatively large. There are three methods for adjusting this time interval: The first is to adjust the aforementioned Ims ratio sampling interval, for example, adjust it to 0.5 ms or 2 ms. Thus, under fixed-window filtering series methods, Δt₀=Δt₁=Δt₂=Δtₖ=4 ms or 16 ms, and under sliding window filtering series methods, Δt₀=Δt₁=Δt₂=Δtₖ=0.5 ms or 2 ms. The second is to adjust the window length (number of sample points X), for example, adjust to X=4 or X=16. Thus, under fixed-window filtering series methods, Δt₀=Δt₁=Δt₂=Δtₖ=4 ms or 16 ms, and under sliding window filtering series methods, Δt₀=Δt₁=Δt₂=Δtₖ still equals Ims. The third is to adjust both the ratio sampling interval time and the window length (number of sample points X) simultaneously. Additionally, since the change in ratio drop caused by a sudden load change is also relatively fast, during this process, Δt₀, Δt₁, Δt₂ . . . Δtₖ will not be adjusted, and adjustment will only occur after the ratio has stabilized for a period of time.

Furthermore, after each fixed-window or sliding-window filtering, the slope is calculated using the above equation, thus obtaining a set of k₀, k₁, k₂ . . . kₖ. Linear fitting is performed again on k₀, k₁, k₂ . . . kₖ to obtain the corresponding slope k′ using the equation: k′=(Etk−Et*Ek)/[Et²−(Et)²].

Here, Etk is the mathematical expectation of the product of the time instant t each ratio slope is acquired and the ratio slope k, Et is the mathematical expectation of the time instant t each ratio slope is acquired, Ek is the mathematical expectation of the ratio slope, Et² is the mathematical expectation of the square of the time instant t each ratio slope is acquired, and (Et)² is the square of the mathematical expectation of the sampling time instant t.

Since the time intervals for acquiring k₀, k₁, k₂ . . . kₖ are equal, Δt₀, Δt′₁, Δt′₂ . . . Δt′ₖ are also equal. Therefore, the above equation may be simplified to: k′=[n′*Σ(t*k)−Σt*Σk]/[n′*Σt²−Σt*Σt], where n′ is a positive integer. To further simplify the calculation process and reduce software computational overhead, n′ in this simplified equation may be set to 2\hat{ }m′, where m′ is a positive integer. When the slope k′ is greater than or equal to (for current-to-speed ratio) or smaller than or equal to (for speed-to-current ratio) the preset slope threshold k′r, it is determined that the load has entered the heavy load operating region. Here, the slope k′ is the second-order derivative of the ratio with respect to unit time.

As shown in FIG. 36, in an electric work vehicle according to one or more embodiments of the present disclosure, the heavy load identification unit being configured to select a target operating parameter from the plurality of operating parameters, and determine whether the functional motor enters a heavy load state based on the target operating parameter and/or a change of the target operating parameter includes the heavy load identification unit being configured to perform following steps S1501 to S1503.

S1501: Determine whether the rotational speed parameter and the power parameter correspond to the current first control strategy.

S1502: In response to the rotational speed parameter and the power parameter not corresponding to the first control strategy, select the rotational speed parameter and the power parameter as target operating parameters.

Selection of the target operating parameters is based on the current first control strategy. In response to the first control strategy being not a rotational speed closed-loop control strategy and not a power closed-loop control strategy, the heavy load identification unit 221 may select the rotational speed parameter and the power parameter as the target operating parameters.

S1503: Determine a power-to-speed ratio parameter based on a ratio between the rotational speed parameter and the power parameter, and determine whether the functional motor enters the heavy load state based on the power-to-speed ratio parameter and/or a change of the power-to-speed ratio parameter.

The change of the power-to-speed ratio parameter may include, for example, the difference obtained by comparing the ratio of the rotational speed parameter to the power parameter acquired at different time instants, the rate of increase or decrease, etc.

In some embodiments, the power-to-speed ratio parameter includes a power-to-speed ratio, a power-to-speed ratio difference, and a power-to-speed ratio rate of change. The preset power-to-speed ratio parameter thresholds corresponding to the power-to-speed ratio, the power-to-speed ratio difference, and the power-to-speed ratio rate of change are a power-to-speed ratio threshold, a power-to-speed ratio difference threshold, and a power-to-speed ratio rate-of-change threshold, respectively.

The power-to-speed ratio refers to the ratio of the power parameter to the rotational speed parameter. The power parameter may include motor power, a motor power difference, and a motor power rate of change. The rotational speed parameter may include the motor speed parameter and the motor sector time parameter.

The power-to-speed ratio difference refers to the difference in the power-to-speed ratio between two adjacent moments.

The power-to-speed ratio rate of change characterizes the change trend of the power-to-speed ratio at corresponding moments. The power-to-speed ratio rate of change may include a first-order derivative and a second-order derivative of the function of the power-to-speed ratio over time. The change curve of the power-to-speed ratio may be obtained by fitting power-to-speed ratio values determined by sampling at a plurality of moments, and taking the slope of this change curve as the power-to-speed ratio rate of change. The slope of this change curve is the first-order derivative of the power-to-speed ratio. In another embodiment, the slope of the slope of the power-to-speed ratio change curve may be used as the power-to-speed ratio rate of change. The slope of the slope of the change curve is the second-order derivative of the power-to-speed ratio.

In some embodiments, the ratio of the rotational speed parameter to the power parameter is determined as the power-to-speed ratio parameter. Those skilled in the art may understand that the ratio of the power parameter to the rotational speed parameter may also be used as the power-to-speed ratio parameter.

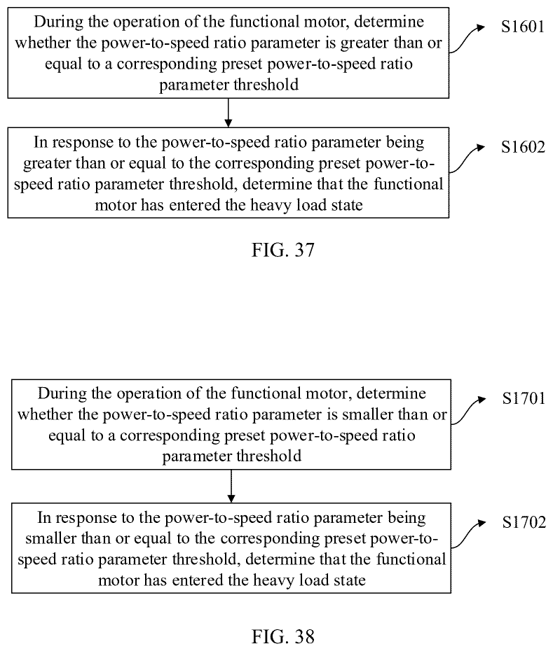

As shown in FIG. 37, in an electric work vehicle according to one or more embodiments of the present disclosure, for the case where the motor speed parameter is selected as the rotational speed parameter, the method for the heavy load identification unit 221 to determine whether the functional motor 211 enters the heavy load state based on the power-to-speed ratio parameter and/or the change of the power-to-speed ratio parameter includes following steps S1601 to S1602.

At step S1601, during the operation of the functional motor, it is determined whether the power-to-speed ratio parameter is greater than or equal to a corresponding preset power-to-speed ratio parameter threshold.

At step S1602, in response to the power-to-speed ratio parameter being greater than or equal to the corresponding preset power-to-speed ratio parameter threshold, it is determined that the functional motor has entered the heavy load state.

In some embodiments, the ratio of the rotational speed parameter to the power parameter is determined as the power-to-speed ratio parameter. Those skilled in the art can understand that the ratio of the power parameter to the rotational speed parameter may also be used as the power-to-speed ratio parameter.

The method for the heavy load identification unit 221 to determine whether the power-to-speed ratio parameter is greater than or equal to the corresponding preset power-to-speed ratio parameter threshold includes: acquiring at least one power-to-speed ratio parameter and determining whether the at least one power-to-speed ratio parameter is greater than or equal to the corresponding preset power-to-speed ratio parameter threshold.

Taking the motor speed as the selected rotational speed parameter and the motor power as the selected power parameter as an example, the power-to-speed ratio is determined based on the ratio of the motor speed and the motor power. Here, when the ratio of the motor power to the motor speed is used as the power-to-speed ratio, and the power-to-speed ratio is greater than or equal to the corresponding power-to-speed ratio threshold, it may be determined that the functional motor 211 has entered the heavy load state; when the ratio of the motor speed to the motor power is used as the power-to-speed ratio, and the power-to-speed ratio is smaller than or equal to the corresponding power-to-speed ratio threshold, it may be determined that the functional motor 211 has entered the heavy load state.

In some embodiments, the heavy load identification unit 221 may acquire a plurality of power-to-speed ratio parameters, compare the plurality of power-to-speed ratio parameters with their respective preset power-to-speed ratio parameter thresholds, and determine whether the plurality of power-to-speed ratio parameters are greater than or equal to the corresponding preset power-to-speed ratio parameter thresholds, respectively.

For example, the power-to-speed ratio is compared with the corresponding preset power-to-speed ratio threshold, and the power-to-speed ratio difference is compared with the corresponding preset power-to-speed ratio difference threshold. If the power-to-speed ratio is greater than or equal to the preset power-to-speed ratio threshold, and the power-to-speed ratio difference is greater than or equal to the preset power-to-speed ratio difference threshold, it is determined that the functional motor 211 has entered the heavy load state.

For example, the power-to-speed ratio, the power-to-speed ratio difference, and the power-to-speed ratio rate of change are compared with the corresponding preset power-to-speed ratio threshold, preset power-to-speed ratio difference threshold, and preset power-to-speed ratio rate-of-change threshold, respectively. In response to all the three power-to-speed ratio parameters being greater than or equal to their respective thresholds, it may be determined that the functional motor 211 has entered the heavy load state.

As shown in FIG. 38, in an electric work vehicle according to one or more embodiments of the present disclosure, for the case where the motor sector time parameter is selected as the rotational speed parameter, the method for the heavy load identification unit 221 to determine whether the functional motor 211 enters the heavy load state based on the power-to-speed ratio parameter and/or the change of the power-to-speed ratio parameter includes following steps S1701 to S1702.

At step S1701, during operation of the functional motor, it is determined whether the power-to-speed ratio parameter is smaller than or equal to a corresponding preset power-to-speed ratio parameter threshold.

At step S1702, in response to the power-to-speed ratio parameter being smaller than or equal to the corresponding preset power-to-speed ratio parameter threshold, it is determined that the functional motor has entered the heavy load state.

Correspondingly, the method for the heavy load identification unit 221 to determine whether the power-to-speed ratio parameter is smaller than or equal to the corresponding preset power-to-speed ratio parameter threshold includes: acquiring at least one power-to-speed ratio parameter and determining whether the at least one power-to-speed ratio parameter is smaller than or equal to the corresponding preset power-to-speed ratio parameter threshold.

In some embodiments, taking the motor sector time as the selected speed parameter and the motor power as the selected power parameter as an example, the power-to-speed ratio is determined based on the ratio of the motor sector time and the motor power.

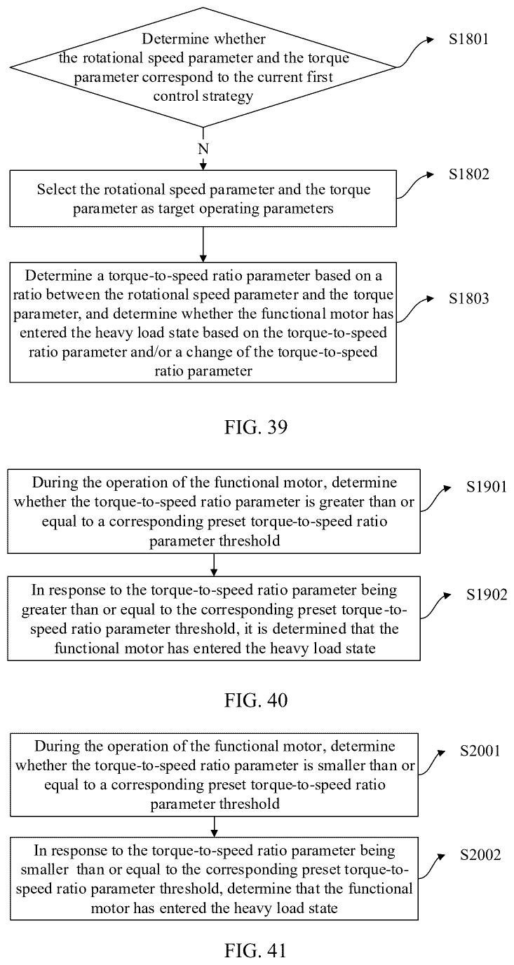

As shown in FIG. 39, in an electric work vehicle according to one or more embodiments of the present disclosure, the heavy load identification unit being configured to select a target operating parameter from the plurality of operating parameters, and determine whether the functional motor enters a heavy load state based on the target operating parameter and/or a change of the target operating parameter includes the heavy load identification unit being configured to perform following steps S1801 to S1803.

S1801: Determine whether the rotational speed parameter and the torque parameter correspond to the current first control strategy.

S1802: In response to the rotational speed parameter and the torque parameter not corresponding to the first control strategy, select the rotational speed parameter and the torque parameter as target operating parameters;

Selection of the target operating parameter is based on the current first control strategy. In response to the first control strategy being not a speed closed-loop control strategy and not a torque closed-loop control strategy, the heavy load identification unit 221 may select the rotational speed parameter and the torque parameter as the target operating parameters.

S1803: Determine a torque-to-speed ratio parameter based on a ratio between the rotational speed parameter and the torque parameter, and determine whether the functional motor has entered the heavy load state based on the torque-to-speed ratio parameter and/or a change of the torque-to-speed ratio parameter.

The change of the torque-to-speed ratio parameter may include, for example, a difference obtained by comparing the ratio of the rotational speed parameter to the torque parameter acquired at different time instants, the rate of increase or decrease, etc.

In some embodiments, the torque-to-speed ratio parameter includes a torque-to-speed ratio, a torque-to-speed ratio difference, and a torque-to-speed ratio rate of change. The preset torque-to-speed ratio parameter thresholds corresponding to the torque-to-speed ratio, the torque-to-speed ratio difference, and the torque-to-speed ratio rate of change are a torque-to-speed ratio threshold, a torque-to-speed ratio difference threshold, and a torque-to-speed ratio rate-of-change threshold, respectively.

The torque-to-speed ratio refers to the ratio of the torque parameter to the rotational speed parameter. The torque parameter may include a motor torque, a motor torque difference, and a motor torque rate of change. The rotational speed parameter may include the motor speed parameter and the motor sector time parameter.

The torque-to-speed ratio difference refers to the difference in the torque-to-speed ratio between two adjacent moments.

The torque-to-speed ratio rate of change characterizes the change trend of the torque-to-speed ratio at corresponding moments. The torque-to-speed ratio rate of change may include a first-order derivative and a second-order derivative of the function of the torque-to-speed ratio over time. The change curve of the torque-to-speed ratio may be obtained by fitting torque-to-speed ratio values determined by sampling at a plurality of moments, and taking the slope of this change curve as the torque-to-speed ratio rate of change. The slope of this change curve is the first-order derivative of the torque-to-speed ratio. In another embodiment, the slope of the slope of the torque-to-speed ratio change curve may be used as the torque-to-speed ratio rate of change. The slope of the slope of the change curve is the second-order derivative of the torque-to-speed ratio.

In some embodiments, the ratio of the rotational speed parameter to the torque parameter is determined as the torque-to-speed ratio parameter. Those skilled in the art may understand that the ratio of the torque parameter to the rotational speed parameter may also be used as the torque-to-speed ratio parameter.

As shown in FIG. 40, in an electric work vehicle according to one or more embodiments of the present disclosure, for the case where the motor speed parameter is selected as the rotational speed parameter, the method for the heavy load identification unit 221 to determine whether the functional motor 211 enters the heavy load state based on the torque-to-speed ratio parameter and/or the change of the torque-to-speed ratio parameter includes following steps S1901 to S1902.

At step S1901, during the operation of the functional motor, it is determined whether the torque-to-speed ratio parameter is greater than or equal to a corresponding preset torque-to-speed ratio parameter threshold.

At step S1902, in response to the torque-to-speed ratio parameter being greater than or equal to the corresponding preset torque-to-speed ratio parameter threshold, it is determined that the functional motor has entered the heavy load state.

In some embodiments, the ratio of the rotational speed parameter to the torque parameter is determined as the torque-to-speed ratio parameter. Those skilled in the art may understand that the ratio of the torque parameter to the rotational speed parameter may also be used as the torque-to-speed ratio parameter.

The method for the heavy load identification unit 221 to determine whether the torque-to-speed ratio parameter is greater than or equal to the corresponding preset torque-to-speed ratio parameter threshold includes: acquiring at least one torque-to-speed ratio parameter and determining whether the at least one torque-to-speed ratio parameter is greater than or equal to the corresponding preset torque-to-speed ratio parameter threshold.

Taking the motor speed as the selected rotational speed parameter and the motor torque as the selected torque parameter as an example, the torque-to-speed ratio is determined based on the ratio of the motor speed and the motor torque. Here, when the ratio of the motor torque to the motor speed is used as the torque-to-speed ratio, and the torque-to-speed ratio is greater than or equal to the corresponding torque-to-speed ratio threshold, it may be determined that the functional motor 211 has entered the heavy load state; when the ratio of the motor speed to the motor torque is used as the torque-to-speed ratio, and the torque-to-speed ratio is smaller than or equal to the corresponding torque-to-speed ratio threshold, it may be determined that the functional motor 211 has entered the heavy load state.

In some embodiments, the heavy load identification unit 221 may acquire a plurality of torque-to-speed ratio parameters, compare the plurality of torque-to-speed ratio parameters with their respective preset torque-to-speed ratio parameter thresholds, and determine whether the plurality of torque-to-speed ratio parameters are greater than or equal to the corresponding preset torque-to-speed ratio parameter thresholds, respectively.

For example, the torque-to-speed ratio is compared with the corresponding preset torque-to-speed ratio threshold, and the torque-to-speed ratio difference is compared with the corresponding preset torque-to-speed ratio difference threshold. In response to the torque-to-speed ratio being greater than or equal to the preset torque-to-speed ratio threshold, and the torque-to-speed ratio difference being greater than or equal to the preset torque-to-speed ratio difference threshold, it is determined that the functional motor 211 has entered the heavy load state.

For example, the torque-to-speed ratio, the torque-to-speed ratio difference, and the torque-to-speed ratio rate of change are compared with the corresponding preset torque-to-speed ratio threshold, preset torque-to-speed ratio difference threshold, and preset torque-to-speed ratio rate-of-change threshold, respectively. In response to all the three torque-to-speed ratio parameters being greater than or equal to their respective thresholds, then it may be determined that the functional motor 211 has entered the heavy load state.

As shown in FIG. 41, in an electric work vehicle according to one or more embodiments of the present disclosure, for the case where the motor sector time parameter is selected as the rotational speed parameter, the method for the heavy load identification unit 221 to determine whether the functional motor 211 enters the heavy load state based on the torque-to-speed ratio parameter and/or the change of the torque-to-speed ratio parameter includes following steps S2001 to S2002.

At step S2001, during the operation of the functional motor, it is determined whether the torque-to-speed ratio parameter is smaller than or equal to a corresponding preset torque-to-speed ratio parameter threshold.

At step S2002, in response to the torque-to-speed ratio parameter being smaller than or equal to the corresponding preset torque-to-speed ratio parameter threshold, it is determined that the functional motor has entered the heavy load state.

Correspondingly, the method for the heavy load identification unit 221 to determine whether the torque-to-speed ratio parameter is smaller than or equal to the corresponding preset torque-to-speed ratio parameter threshold includes: acquiring at least one torque-to-speed ratio parameter and determining whether the at least one torque-to-speed ratio parameter is smaller than or equal to the corresponding preset torque-to-speed ratio parameter threshold.

In some embodiments, taking the motor sector time as the selected rotational speed parameter and the motor torque as the selected torque parameter as an example, the torque-to-speed ratio is determined based on the ratio of the motor sector time and the motor torque.

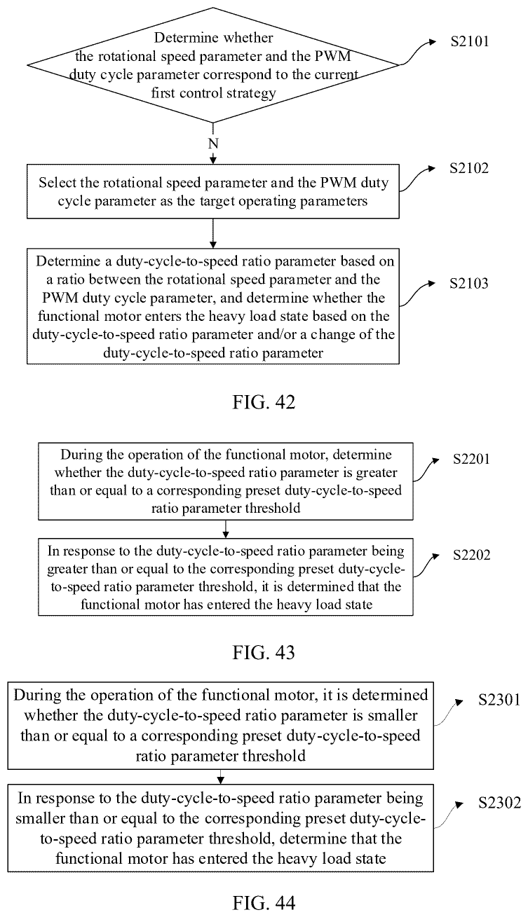

As shown in FIG. 42, in an electric work vehicle according to one or more embodiments of the present disclosure, the heavy load identification unit being configured to select a target operating parameter from the plurality of operating parameters, and determine whether the functional motor enters a heavy load state based on the target operating parameter and/or a change of the target operating parameter includes the heavy load identification unit being configured to perform following steps S2101 to S2103.

S2101: Determine whether the rotational speed parameter and the PWM duty cycle parameter correspond to the current first control strategy.

S2102: In response to the rotational speed parameter and the PWM duty cycle parameter not corresponding to the first control strategy, select the rotational speed parameter and the PWM duty cycle parameter as the target operating parameters.

Selection of the target operating parameters is based on the current first control strategy. In response to the first control strategy being not a rotational speed closed-loop control strategy and not a PWM duty cycle open-loop control strategy, the heavy load identification unit 221 may select the rotational speed parameter and the PWM duty cycle parameter as the target operating parameters.

S2103: Determine a duty-cycle-to-speed ratio parameter based on a ratio between the rotational speed parameter and the PWM duty cycle parameter, and determine whether the functional motor enters the heavy load state based on the duty-cycle-to-speed ratio parameter and/or a change of the duty-cycle-to-speed ratio parameter.

The change of the duty-cycle-to-speed ratio parameter may include, for example, the difference obtained by comparing the ratio of the rotational speed parameter to the PWM duty cycle parameter acquired at different time instants, the rate of increase or decrease, etc.

In some embodiments, the duty-cycle-to-speed ratio parameter includes a duty-cycle-to-speed ratio, a duty-cycle-to-speed ratio difference, and a duty-cycle-to-speed ratio rate of change. The preset duty-cycle-to-speed ratio parameter thresholds corresponding to the duty-cycle-to-speed ratio, the duty-cycle-to-speed ratio difference, and the duty-cycle-to-speed ratio rate of change are a duty-cycle-to-speed ratio threshold, a duty-cycle-to-speed ratio difference threshold, and a duty-cycle-to-speed ratio rate-of-change threshold, respectively.

The duty-cycle-to-speed ratio refers to the ratio of the PWM duty cycle parameter to the rotational speed parameter. The PWM duty cycle parameter may include the duty cycle, the duty cycle difference, and the duty cycle rate of change. The rotational speed parameter may include the motor speed parameter and the motor sector time parameter.

The duty-cycle-to-speed ratio difference refers to the difference in the duty-cycle-to-speed ratio between two adjacent moments.

The duty-cycle-to-speed ratio rate of change characterizes the change trend of the duty-cycle-to-speed ratio at corresponding moments. The duty-cycle-to-speed ratio rate of change may include a first-order derivative and a second-order derivative of the function of the duty-cycle-to-speed ratio over time. The change curve of the duty-cycle-to-speed ratio may be obtained by fitting duty-cycle-to-speed ratio values determined by sampling at a plurality of moments, and taking the slope of this change curve as the duty-cycle-to-speed ratio rate of change. The slope of this change curve is the first-order derivative of the duty-cycle-to-speed ratio. In another embodiment, the slope of the slope of the duty-cycle-to-speed ratio change curve may be used as the duty-cycle-to-speed ratio rate of change. The slope of the slope of the change curve is the second-order derivative of the duty-cycle-to-speed ratio.

In some embodiments, the ratio of the rotational speed parameter to the PWM duty cycle parameter is determined as the duty-cycle-to-speed ratio parameter. Those skilled in the art may understand that the ratio of the PWM duty cycle parameter to the rotational speed parameter may also be used as the duty-cycle-to-speed ratio parameter.

As shown in FIG. 43, in an electric work vehicle according to one or more embodiments of the present disclosure, for the case where the motor speed parameter is selected as the rotational speed parameter, the method for the heavy load identification unit 221 to determine whether the functional motor 211 enters the heavy load state based on the duty-cycle-to-speed ratio parameter and/or the change of the duty-cycle-to-speed ratio parameter includes following steps S2201 to S2202.

At step S2201, during operation of the functional motor, it is determined whether the duty-cycle-to-speed ratio parameter is greater than or equal to a corresponding preset duty-cycle-to-speed ratio parameter threshold.

At step S2202, in response to the duty-cycle-to-speed ratio parameter being greater than or equal to the corresponding preset duty-cycle-to-speed ratio parameter threshold, it is determined that the functional motor has entered the heavy load state.

In some embodiments, the ratio of the rotational speed parameter to the PWM duty cycle parameter is determined as the duty-cycle-to-speed ratio parameter. Those skilled in the art may understand that the ratio of the PWM duty cycle parameter to the rotational speed parameter may also be used as the duty-cycle-to-speed ratio parameter.

The method for the heavy load identification unit 221 to determine whether the duty-cycle-to-speed ratio parameter is greater than or equal to the corresponding preset duty-cycle-to-speed ratio parameter threshold includes: acquiring at least one duty-cycle-to-speed ratio parameter and determining whether the at least one duty-cycle-to-speed ratio parameter is greater than or equal to the corresponding preset duty-cycle-to-speed ratio parameter threshold.

Taking the motor speed as the selected rotational speed parameter and the duty cycle as the selected PWM duty cycle parameter as an example, the duty-cycle-to-speed ratio is determined based on the ratio of the motor speed and the duty cycle. Here, when the ratio of the duty cycle to the motor speed is used as the duty-cycle-to-speed ratio, and the duty-cycle-to-speed ratio is greater than or equal to the corresponding duty-cycle-to-speed ratio threshold, it may be determined that the functional motor 211 has entered the heavy load state; when the ratio of the motor speed to the duty cycle is used as the duty-cycle-to-speed ratio, and the duty-cycle-to-speed ratio is smaller than or equal to the corresponding duty-cycle-to-speed ratio threshold, it may be determined that the functional motor 211 has entered the heavy load state.

In some embodiments, the heavy load identification unit 221 may acquire a plurality of duty-cycle-to-speed ratio parameters, compare the plurality of duty-cycle-to-speed ratio parameters with their respective preset duty-cycle-to-speed ratio parameter thresholds, and determine whether the plurality of duty-cycle-to-speed ratio parameters are greater than or equal to the corresponding preset duty-cycle-to-speed ratio parameter thresholds, respectively.

For example, the duty-cycle-to-speed ratio is compared with the corresponding preset duty-cycle-to-speed ratio threshold, and the duty-cycle-to-speed ratio difference is compared with the corresponding preset duty-cycle-to-speed ratio difference threshold. If the duty-cycle-to-speed ratio is greater than or equal to the preset duty-cycle-to-speed ratio threshold, and the duty-cycle-to-speed ratio difference is greater than or equal to the preset duty-cycle-to-speed ratio difference threshold, it is determined that the functional motor 211 has entered the heavy load state.

For example, the duty-cycle-to-speed ratio, the duty-cycle-to-speed ratio difference, and the duty-cycle-to-speed ratio rate of change are compared with the corresponding preset duty-cycle-to-speed ratio threshold, preset duty-cycle-to-speed ratio difference threshold, and preset duty-cycle-to-speed ratio rate-of-change threshold, respectively. In response to all the three duty-cycle-to-speed ratio parameters being greater than or equal to their respective thresholds, then it may be determined that the functional motor 211 has entered the heavy load state.

As shown in FIG. 44, in an electric work vehicle according to one or more embodiments of the present disclosure, for the case where the motor sector time parameter is selected as the rotational speed parameter, the method for the heavy load identification unit 221 to determine whether the functional motor 211 enters the heavy load state based on the duty-cycle-to-speed ratio parameter and/or the change of the duty-cycle-to-speed ratio parameter includes following steps S2301 to S2302.

At step S2301, during operation of the functional motor, it is determined whether the duty-cycle-to-speed ratio parameter is smaller than or equal to a corresponding preset duty-cycle-to-speed ratio parameter threshold.

At step S2302, in response to the duty-cycle-to-speed ratio parameter being smaller than or equal to the corresponding preset duty-cycle-to-speed ratio parameter threshold, it is determined that the functional motor has entered the heavy load state.

Correspondingly, the method for the heavy load identification unit 221 to determine whether the duty-cycle-to-speed ratio parameter is smaller than or equal to the corresponding preset duty-cycle-to-speed ratio parameter threshold includes: acquiring at least one duty-cycle-to-speed ratio parameter and determining whether the at least one duty-cycle-to-speed ratio parameter is smaller than or equal to the corresponding preset duty-cycle-to-speed ratio parameter threshold.

In some embodiments, taking the motor sector time as the selected rotational speed parameter and the duty cycle as the selected PWM duty cycle parameter as an example, the duty-cycle-to-speed ratio is determined based on the ratio of the motor sector time and the duty cycle.

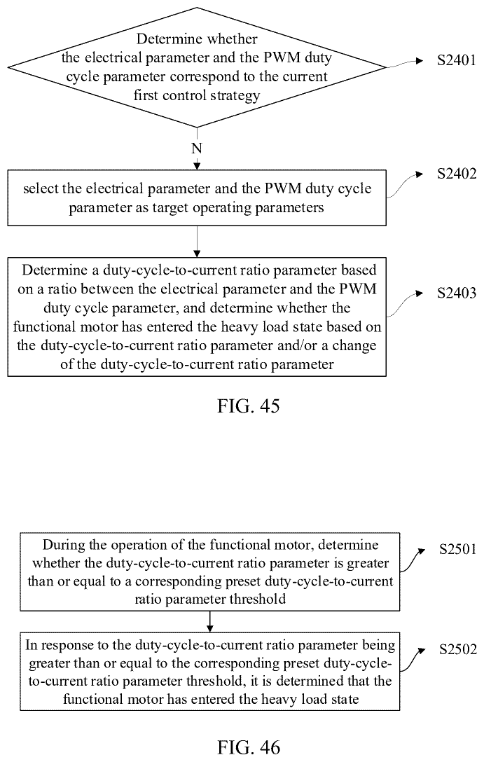

As shown in FIG. 45, in an electric work vehicle according to one or more embodiments of the present disclosure, the heavy load identification unit being configured to select a target operating parameter from the plurality of operating parameters, and determine whether the functional motor enters a heavy load state based on the target operating parameter and/or a change of the target operating parameter includes the heavy load identification unit being configured to perform following steps S2401 to S2403.

S2401: Determine whether the electrical parameter and the PWM duty cycle parameter correspond to the current first control strategy.

S2402: In response to the electrical parameter and the PWM duty cycle parameter not corresponding to the first control strategy, select the electrical parameter and the PWM duty cycle parameter as target operating parameters.

Selection of the target operating parameters is based on the current first control strategy. In response to the first control strategy being not a current closed-loop control strategy and not a PWM duty cycle open-loop control strategy, the heavy load identification unit 221 may select the electrical parameter and the PWM duty cycle parameter as the target operating parameters.

S2403: Determine a duty-cycle-to-current ratio parameter based on a ratio between the electrical parameter and the PWM duty cycle parameter, and determine whether the functional motor has entered the heavy load state based on the duty-cycle-to-current ratio parameter and/or a change of the duty-cycle-to-current ratio parameter.

The change of the duty-cycle-to-current ratio parameter may include, for example, a difference obtained by comparing the ratio of the electrical parameter to the PWM duty cycle parameter acquired at different time instants, the rate of increase or decrease, etc.

In some embodiments, the duty-cycle-to-current ratio parameter includes a duty-cycle-to-current ratio, a duty-cycle-to-current ratio difference, and a duty-cycle-to-current ratio rate of change. The preset duty-cycle-to-current ratio parameter thresholds corresponding to the duty-cycle-to-current ratio, the duty-cycle-to-current ratio difference, and the duty-cycle-to-current ratio rate of change are a duty-cycle-to-current ratio threshold, a duty-cycle-to-current ratio difference threshold, and a duty-cycle-to-current ratio rate-of-change threshold, respectively.

The duty-cycle-to-current ratio refers to the ratio of the PWM duty cycle parameter to the electrical parameter. The PWM duty cycle parameter may include the duty cycle, the duty cycle difference, and the duty cycle rate of change. The electrical parameter may include the bus current parameter, the phase current parameter, the bus voltage parameter, the conducting phase voltage parameter, and the freewheeling time parameter.

The duty-cycle-to-current ratio difference refers to the difference in the duty-cycle-to-current ratio between two adjacent moments.

The duty-cycle-to-current ratio rate of change characterizes the change trend of the duty-cycle-to-current ratio at corresponding moments. The duty-cycle-to-current ratio rate of change may include a first-order derivative and a second-order derivative of the function of the duty-cycle-to-current ratio over time. The change curve of the duty-cycle-to-current ratio may be obtained by fitting duty-cycle-to-current ratio values determined by sampling at a plurality of moments, and taking the slope of this change curve as the duty-cycle-to-current ratio rate of change. The slope of this change curve is the first-order derivative of the duty-cycle-to-current ratio. In another embodiment, the slope of the slope of the duty-cycle-to-current ratio change curve may be used as the duty-cycle-to-current ratio rate of change. The slope of the slope of the change curve is the second-order derivative of the duty-cycle-to-current ratio.

In some embodiments, the ratio of the electrical parameter to the PWM duty cycle parameter is determined as the duty-cycle-to-current ratio parameter. Those skilled in the art may understand that the ratio of the PWM duty cycle parameter to the electrical parameter may also be used as the duty-cycle-to-current ratio parameter.

As shown in FIG. 46, in an electric work vehicle according to one or more embodiments of the present disclosure, the method for the heavy load identification unit 221 to determine whether the functional motor 211 enters the heavy load state based on the duty-cycle-to-current ratio parameter and/or the change of the duty-cycle-to-current ratio parameter includes following steps S2501 to S2502.

At step S2501, during the operation of the functional motor, it is determined whether the duty-cycle-to-current ratio parameter is greater than or equal to a corresponding preset duty-cycle-to-current ratio parameter threshold.

At step S2502, in response to the duty-cycle-to-current ratio parameter being greater than or equal to the corresponding preset duty-cycle-to-current ratio parameter threshold, it is determined that the functional motor has entered the heavy load state.

In some embodiments, the ratio of the PWM duty cycle parameter to the electrical parameter is determined as the duty-cycle-to-current ratio parameter. Those skilled in the art may understand that the ratio of the electrical parameter to the PWM duty cycle parameter may also be used as the duty-cycle-to-current ratio parameter.

The method for the heavy load identification unit 221 to determine whether the duty-cycle-to-current ratio parameter is greater than or equal to the corresponding preset duty-cycle-to-current ratio parameter threshold includes: acquiring at least one duty-cycle-to-current ratio parameter and determining whether the at least one duty-cycle-to-current ratio parameter is greater than or equal to the corresponding preset duty-cycle-to-current ratio parameter threshold.

Taking the bus current as the selected electrical parameter and the duty cycle as the selected PWM duty cycle parameter as an example, the duty-cycle-to-current ratio is determined based on the ratio of the bus current and the duty cycle. Here, when the ratio of the duty cycle to the bus current is used as the duty-cycle-to-current ratio, and the duty-cycle-to-current ratio is greater than or equal to the corresponding duty-cycle-to-current ratio threshold, it may be determined that the functional motor 211 has entered the heavy load state; when the ratio of the bus current to the duty cycle is used as the duty-cycle-to-current ratio, and the duty-cycle-to-current ratio is smaller than or equal to the corresponding duty-cycle-to-current ratio threshold, it may be determined that the functional motor 211 has entered the heavy load state.

In some embodiments, the heavy load identification unit 221 may acquire a plurality of duty-cycle-to-current ratio parameters, compare the plurality of duty-cycle-to-current ratio parameters with their respective preset duty-cycle-to-current ratio parameter thresholds, and determine whether the plurality of duty-cycle-to-current ratio parameters are greater than or equal to the corresponding preset duty-cycle-to-current ratio parameter thresholds, respectively.

For example, the duty-cycle-to-current ratio is compared with the corresponding preset duty-cycle-to-current ratio threshold, and the duty-cycle-to-current ratio difference is compared with the corresponding preset duty-cycle-to-current ratio difference threshold. If the duty-cycle-to-current ratio is greater than or equal to the preset duty-cycle-to-current ratio threshold, and the duty-cycle-to-current ratio difference is greater than or equal to the preset duty-cycle-to-current ratio difference threshold, it is determined that the functional motor 211 has entered the heavy load state.

For example, the duty-cycle-to-current ratio, the duty-cycle-to-current ratio difference, and the duty-cycle-to-current ratio rate of change are compared with the corresponding preset duty-cycle-to-current ratio threshold, preset duty-cycle-to-current ratio difference threshold, and preset duty-cycle-to-current ratio rate-of-change threshold, respectively. In response to all the three duty-cycle-to-current ratio parameters being greater than or equal to their respective thresholds, it may be determined that the functional motor 211 has entered the heavy load state.

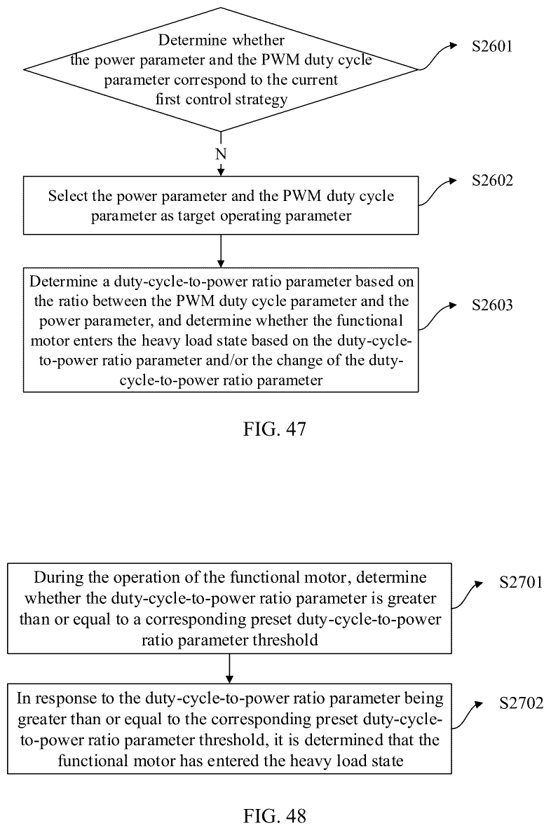

As shown in FIG. 47, in an electric work vehicle according to one or more embodiments of the present disclosure, the heavy load identification unit being configured to select a target operating parameter from the plurality of operating parameters, and determine whether the functional motor enters a heavy load state based on the target operating parameter and/or a change of the target operating parameters includes the heavy load identification unit being configured to perform following steps S2601 to S2603.

S2601: Determine whether the power parameter and the PWM duty cycle parameter correspond to the current first control strategy.

S2602: In response to the power parameter and the PWM duty cycle parameter not corresponding to the first control strategy, select the power parameter and the PWM duty cycle parameter as target operating parameter.

Selection of the target operating parameters is based on the current first control strategy. In response to the first control strategy being not a current closed-loop control strategy and not a PWM duty cycle open-loop control strategy, the heavy load identification unit 221 may select the power parameter and the PWM duty cycle parameter as the target operating parameters.

S2603: Determine a duty-cycle-to-power ratio parameter based on the ratio between the PWM duty cycle parameter and the power parameter, and determine whether the functional motor enters the heavy load state based on the duty-cycle-to-power ratio parameter and/or the change of the duty-cycle-to-power ratio parameter.

The change of the duty-cycle-to-power ratio parameter may include, for example, a difference obtained by comparing the ratio of the PWM duty cycle parameter to the power parameter acquired at different time instants, the rate of increase or decrease, etc.

In some embodiments, the duty-cycle-to-power ratio parameter includes a duty-cycle-to-power ratio, a duty-cycle-to-power ratio difference, and a duty-cycle-to-power ratio rate of change. The preset duty-cycle-to-power ratio parameter thresholds corresponding to the duty-cycle-to-power ratio, the duty-cycle-to-power ratio difference, and the duty-cycle-to-power ratio rate of change are a duty-cycle-to-power ratio threshold, a duty-cycle-to-power ratio difference threshold, and a duty-cycle-to-power ratio rate-of-change threshold, respectively.

The duty-cycle-to-power ratio refers to the ratio of the PWM duty cycle parameter to the power parameter. The PWM duty cycle parameter may include the duty cycle, the duty cycle difference, and the duty cycle rate of change. The power parameter may include the motor power, the motor power difference, and the motor power rate of change.

The duty-cycle-to-power ratio difference refers to the difference in the duty-cycle-to-power ratio between two adjacent moments.

The duty-cycle-to-power ratio rate of change characterizes the change trend of the duty-cycle-to-power ratio at corresponding moments. The duty-cycle-to-power ratio rate of change may include a first-order derivative and a second-order derivative of the function of the duty-cycle-to-power ratio over time. The change curve of the duty-cycle-to-power ratio may be obtained by fitting duty-cycle-to-power ratio values determined by sampling at a plurality of moments, and taking the slope of this change curve as the duty-cycle-to-power ratio rate of change. The slope of this change curve is the first-order derivative of the duty-cycle-to-power ratio. In another embodiment, the slope of the slope of the duty-cycle-to-power ratio change curve may be used as the duty-cycle-to-power ratio rate of change. The slope of the slope of the change curve is the second-order derivative of the duty-cycle-to-power ratio.

In some embodiments, the ratio of the power parameter to the PWM duty cycle parameter is determined as the duty-cycle-to-power ratio parameter. Those skilled in the art may understand that the ratio of the PWM duty cycle parameter to the power parameter may also be used as the duty-cycle-to-power ratio parameter.

As shown in FIG. 48, in an electric work vehicle according to one or more embodiments of the present disclosure, the method for the heavy load identification unit 221 to determine whether the functional motor 211 enters the heavy load state based on the duty-cycle-to-power ratio parameter and/or the change of the duty-cycle-to-power ratio parameter includes following steps S2701 to S2702.

At step S2701, during the operation of the functional motor, it is determined whether the duty-cycle-to-power ratio parameter is greater than or equal to a corresponding preset duty-cycle-to-power ratio parameter threshold.

At step S2702, in response to the duty-cycle-to-power ratio parameter being greater than or equal to the corresponding preset duty-cycle-to-power ratio parameter threshold, it is determined that the functional motor has entered the heavy load state.

In some embodiments, the ratio of the PWM duty cycle parameter to the power parameter is determined as the duty-cycle-to-power ratio parameter. Those skilled in the art may understand that the ratio of the power parameter to the PWM duty cycle parameter may also be used as the duty-cycle-to-power ratio parameter.

The method for the heavy load identification unit 221 to determine whether the duty-cycle-to-power ratio parameter is greater than or equal to the corresponding preset duty-cycle-to-power ratio parameter threshold includes: acquiring at least one duty-cycle-to-power ratio parameter and determining whether the at least one duty-cycle-to-power ratio parameter is greater than or equal to the corresponding preset duty-cycle-to-power ratio parameter threshold.

Taking the motor power as the selected power parameter and the duty cycle as the selected PWM duty cycle parameter as an example, the duty-cycle-to-power ratio is determined based on the ratio of the motor power and the duty cycle. Here, when the ratio of the duty cycle to the motor power is used as the duty-cycle-to-power ratio, and the duty-cycle-to-power ratio is greater than or equal to the corresponding duty-cycle-to-power ratio threshold, it may be determined that the functional motor 211 has entered the heavy load state; when the ratio of the motor power to the duty cycle is used as the duty-cycle-to-power ratio, and the duty-cycle-to-power ratio is smaller than or equal to the corresponding duty-cycle-to-power ratio threshold, it may be determined that the functional motor 211 has entered the heavy load state.

In some embodiments, the heavy load identification unit 221 may acquire a plurality of duty-cycle-to-power ratio parameters, compare the plurality of duty-cycle-to-power ratio parameters with their respective preset duty-cycle-to-power ratio parameter thresholds, and determine whether the plurality of duty-cycle-to-power ratio parameters are greater than or equal to the corresponding preset duty-cycle-to-power ratio parameter thresholds, respectively.

For example, the duty-cycle-to-power ratio is compared with the corresponding preset duty-cycle-to-power ratio threshold, and the duty-cycle-to-power ratio difference is compared with the corresponding preset duty-cycle-to-power ratio difference threshold. In response to the duty-cycle-to-power ratio being greater than or equal to the preset duty-cycle-to-power ratio threshold, and the duty-cycle-to-power ratio difference being greater than or equal to the preset duty-cycle-to-power ratio difference threshold, it is determined that the functional motor 211 has entered the heavy load state.

For example, the duty-cycle-to-power ratio, the duty-cycle-to-power ratio difference, and the duty-cycle-to-power ratio rate of change are compared with the corresponding preset duty-cycle-to-power ratio threshold, preset duty-cycle-to-power ratio difference threshold, and preset duty-cycle-to-power ratio rate-of-change threshold, respectively. In response to all the three duty-cycle-to-power ratio parameters are greater than or equal to their respective thresholds, then it may be determined that the functional motor 211 has entered the heavy load state.

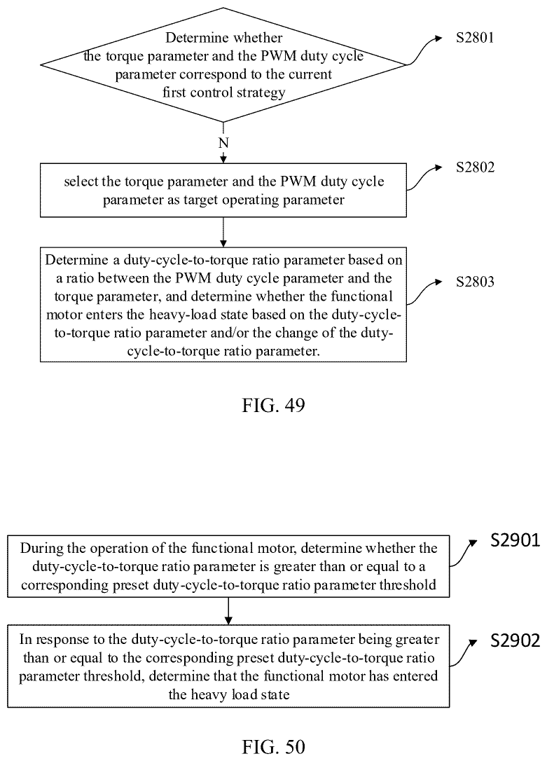

As shown in FIG. 49, in an electric work vehicle provided by one or more embodiments of the present disclosure, the heavy load identification unit being configured to select a target operating parameter from the plurality of operating parameters, and determine whether the functional motor enters a heavy load state based on the target operating parameter and/or a change of the target operating parameters includes the heavy load identification unit being configured to perform following steps S2801 to S2803.

S2801: Determine whether the torque parameter and the PWM duty cycle parameter correspond to the current first control strategy.

S2802: In response to the torque parameter and the PWM duty cycle parameter not corresponding to the first control strategy, select the torque parameter and the PWM duty cycle parameter as target operating parameter.

Selection of the target operating parameters is based on the current first control strategy. In response to the first control strategy being not a current closed-loop control strategy and not a PWM duty cycle open-loop control strategy, the heavy load identification unit 221 may select the torque parameter and the PWM duty cycle parameter as the target operating parameters.

S2803: Determine a duty-cycle-to-torque ratio parameter based on a ratio between the PWM duty cycle parameter and the torque parameter, and determine whether the functional motor enters the heavy load state based on the duty-cycle-to-torque ratio parameter and/or the change of the duty-cycle-to-torque ratio parameter.

The change of the duty-cycle-to-torque ratio parameter may include, for example, a difference obtained by comparing the ratio of the PWM duty cycle parameter to the torque parameter acquired at different time instants, the rate of increase or decrease, etc.

In some embodiments, the duty-cycle-to-torque ratio parameter includes a duty-cycle-to-torque ratio, a duty-cycle-to-torque ratio difference, and a duty-cycle-to-torque ratio rate of change. The preset duty-cycle-to-torque ratio parameter thresholds corresponding to the duty-cycle-to-torque ratio, the duty-cycle-to-torque ratio difference, and the duty-cycle-to-torque ratio rate of change are a duty-cycle-to-torque ratio threshold, a duty-cycle-to-torque ratio difference threshold, and a duty-cycle-to-torque ratio rate-of-change threshold, respectively.

The duty-cycle-to-torque ratio refers to the ratio of the PWM duty cycle parameter to the torque parameter. The PWM duty cycle parameter may include the duty cycle, the duty cycle difference, and the duty cycle rate of change. The torque parameter may include the motor torque, the motor torque difference, and the motor torque rate of change.

The duty-cycle-to-torque ratio difference refers to the difference in the duty-cycle-to-torque ratio between two adjacent moments.

The duty-cycle-to-torque ratio rate of change characterizes the change trend of the duty-cycle-to-torque ratio at corresponding moments. The duty-cycle-to-torque ratio rate of change may include a first-order derivative and a second-order derivative of the function of the duty-cycle-to-torque ratio over time. The change curve of the duty-cycle-to-torque ratio may be obtained by fitting duty-cycle-to-torque ratio values determined by sampling at a plurality of moments, and taking the slope of this change curve as the duty-cycle-to-torque ratio rate of change. The slope of this change curve is the first-order derivative of the duty-cycle-to-torque ratio. In another embodiment, the slope of the slope of the duty-cycle-to-torque ratio change curve may be used as the duty-cycle-to-torque ratio rate of change. The slope of the slope of the change curve is the second-order derivative of the duty-cycle-to-torque ratio.

In some embodiments, the ratio of the torque parameter to the PWM duty cycle parameter is determined as the duty-cycle-to-torque ratio parameter. Those skilled in the art may understand that the ratio of the PWM duty cycle parameter to the torque parameter may also be used as the duty-cycle-to-torque ratio parameter.

As shown in FIG. 50, in an electric work vehicle provided by one or more embodiments of the present disclosure, the method for the heavy load identification unit 221 to determine whether the functional motor 211 enters the heavy load state based on the duty-cycle-to-torque ratio parameter and/or the change of the duty-cycle-to-torque ratio parameter includes following steps S2901 to S2902.

At step S2901, during the operation of the functional motor, it is determined whether the duty-cycle-to-torque ratio parameter is greater than or equal to a corresponding preset duty-cycle-to-torque ratio parameter threshold.

At step S2902, in response to the duty-cycle-to-torque ratio parameter being greater than or equal to the corresponding preset duty-cycle-to-torque ratio parameter threshold, it is determined that the functional motor has entered the heavy load state.

In some embodiments, the ratio of the PWM duty cycle parameter to the torque parameter is determined as the duty-cycle-to-torque ratio parameter. Those skilled in the art may understand that the ratio of the torque parameter to the PWM duty cycle parameter may also be used as the duty-cycle-to-torque ratio parameter.

The method for the heavy load identification unit 221 to determine whether the duty-cycle-to-torque ratio parameter is greater than or equal to the corresponding preset duty-cycle-to-torque ratio parameter threshold includes: acquiring at least one duty-cycle-to-torque ratio parameter and determining whether the at least one duty-cycle-to-torque ratio parameter is greater than or equal to the corresponding preset duty-cycle-to-torque ratio parameter threshold.

Taking the motor torque as the selected torque parameter and the duty cycle as the selected PWM duty cycle parameter as an example, the duty-cycle-to-torque ratio is determined based on the ratio of the motor torque and the duty cycle. Here, when the ratio of the duty cycle to the motor torque is used as the duty-cycle-to-torque ratio, and the duty-cycle-to-torque ratio is greater than or equal to the corresponding duty-cycle-to-torque ratio threshold, it may be determined that the functional motor 211 has entered the heavy load state; when the ratio of the motor torque to the duty cycle is used as the duty-cycle-to-torque ratio, and the duty-cycle-to-torque ratio is smaller than or equal to the corresponding duty-cycle-to-torque ratio threshold, it may be determined that the functional motor 211 has entered the heavy load state.

In some embodiments, the heavy load identification unit 221 may acquire a plurality of duty-cycle-to-torque ratio parameters, compare the plurality of duty-cycle-to-torque ratio parameters with their respective preset duty-cycle-to-torque ratio parameter thresholds, and determine whether the plurality of duty-cycle-to-torque ratio parameters are greater than or equal to their corresponding preset duty-cycle-to-torque ratio parameter thresholds, respectively.

For example, the duty-cycle-to-torque ratio is compared with the corresponding preset duty-cycle-to-torque ratio threshold, and the duty-cycle-to-torque ratio difference is compared with the corresponding preset duty-cycle-to-torque ratio difference threshold. In response to the duty-cycle-to-torque ratio being greater than or equal to the preset duty-cycle-to-torque ratio threshold, and the duty-cycle-to-torque ratio difference being greater than or equal to the preset duty-cycle-to-torque ratio difference threshold, it is determined that the functional motor 211 has entered the heavy load state.

For example, the duty-cycle-to-torque ratio, the duty-cycle-to-torque ratio difference, and the duty-cycle-to-torque ratio rate of change are compared with the corresponding preset duty-cycle-to-torque ratio threshold, preset duty-cycle-to-torque ratio difference threshold, and preset duty-cycle-to-torque ratio rate-of-change threshold, respectively. If all the three duty-cycle-to-torque ratio parameters are greater than or equal to their respective thresholds, then it may be determined that the functional motor 211 has entered the heavy load state.

In the electric work vehicle, after the heavy load identification unit 221 in the controller assembly 22 identifies and determines that the functional motor 211 has entered the heavy load state, the heavy load control unit 222 performs responsive control, selecting a second control strategy to adjust the operating state related to the functional motor 211 to cause the functional motor to exit the heavy load state, thereby avoiding potential impacts of an excessive load on the functional motor 211.

In an electric work vehicle according to one or more embodiments of the present disclosure, the heavy load control unit being configured to control, based on the second control strategy, the functional motor includes:
the heavy load control unit being configured to control, in response to the second control strategy being the same as the first control strategy, the operating parameter corresponding to the second control strategy to decrease to a target value, the target value being smaller than a value of the operating parameter corresponding to the second control strategy under a normal operating state of the functional motor.

In an electric work vehicle according to one or more embodiments of the present disclosure, the heavy load control unit being configured to select a second control strategy from the plurality of control strategies and control, based on the second control strategy, the functional motor includes:
the heavy load control unit being configured to control, in response to the second control strategy being different from the first control strategy, the operating parameter corresponding to the second control strategy to decrease to a target value, the target value being smaller than or equal to an upper limit threshold of the operating parameter corresponding to the second control strategy under the normal operating state of the functional motor.

The first control strategy being the PWM duty cycle open-loop control strategy is described as an example. FIG. 51 is a block diagram of the PWM duty cycle open-loop control logic. When the heavy load control unit 222 also selects the PWM duty cycle open-loop control strategy as the second control strategy, assuming the duty cycle set for normal operation of the functional motor 211 is d0, in response to the heavy load identification unit 221 identifying entry into the heavy load state, the heavy load control unit 222 sets the target duty cycle to d1, and d1<d0.

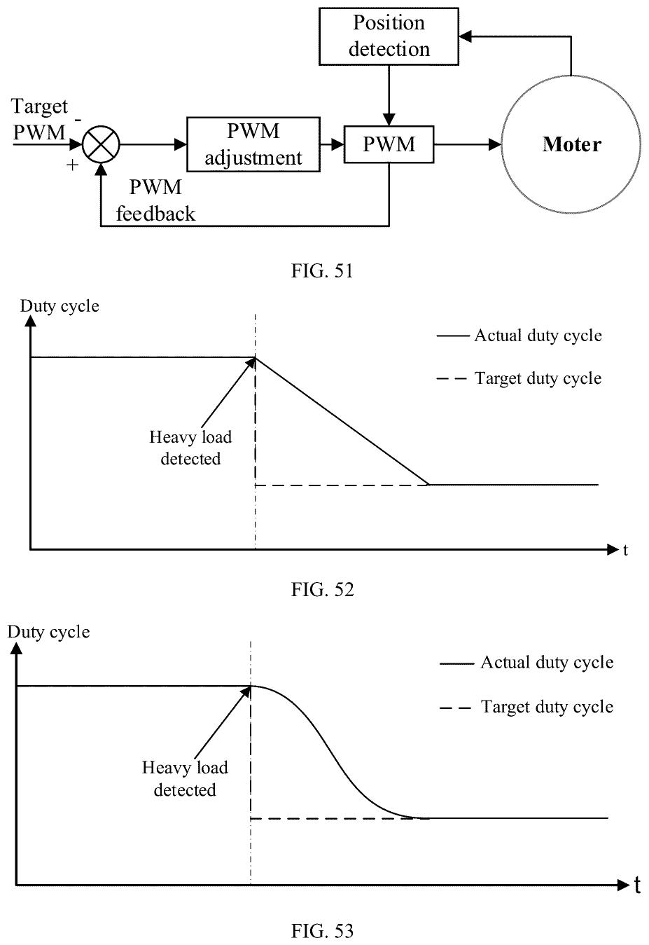

When reducing the control duty cycle, a linear decrease method or a curved decrease method may be used. FIG. 52 and FIG. 53 are schematic diagrams of duty cycle changes using the linear decrease method and the curved decrease method, respectively, under the control of the heavy load control unit 222.

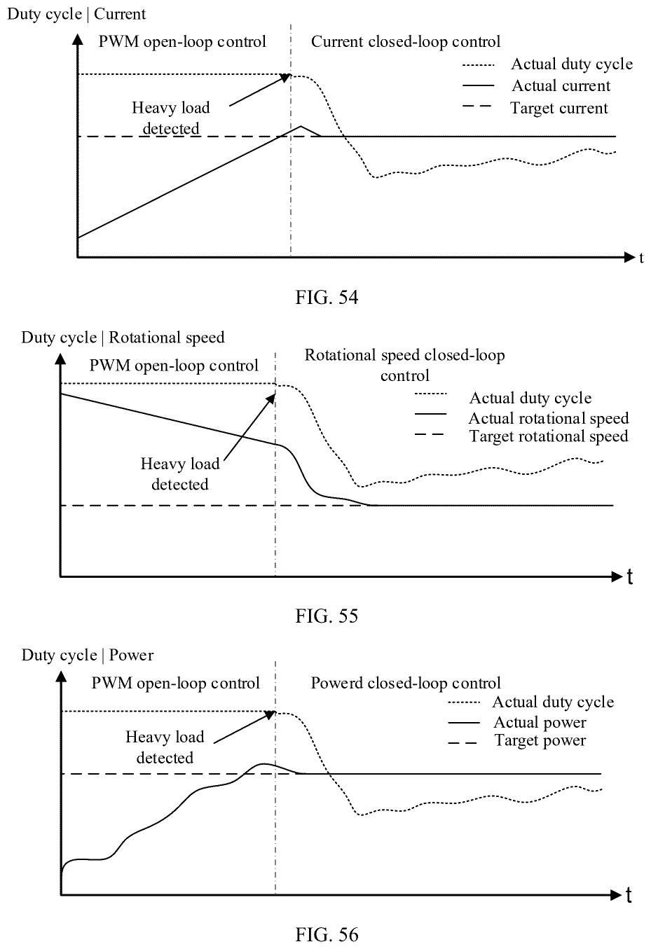

When the heavy load control unit 222 selects a current-speed control strategy as the second control strategy, under this current closed-loop control strategy, the heavy load control unit 222 may reduce the bus current of the functional motor 211 to a target value and maintain it. The target value is less than or equal to the upper limit threshold of the bus current under the normal operating state of the functional motor 211. FIG. 54 is a schematic diagram of bus current change when switching from the PWM duty cycle open-loop control strategy to the current closed-loop control strategy.

When the heavy load control unit 222 selects a speed closed-loop control strategy as the second control strategy, under this speed closed-loop control strategy, the heavy load control unit 222 may reduce the motor speed of the functional motor 211 to a target value and maintain it. This target value is less than or equal to the upper limit threshold of the motor speed under the normal operating state of the functional motor 211. FIG. 55 is a schematic diagram of motor speed change when switching from the PWM duty cycle open-loop control strategy to the rotational speed closed-loop control strategy.

When the heavy load control unit 222 selects a power closed-loop control strategy as the second control strategy, under this power closed-loop control strategy, the heavy load control unit 222 may reduce the motor power of the functional motor 211 to a target value and maintain it. This target value is less than or equal to the upper limit threshold of the motor power under the normal operating state of the functional motor 211. FIG. 56 is a schematic diagram of motor power change when switching from the PWM duty cycle open-loop control strategy to the power closed-loop control strategy.

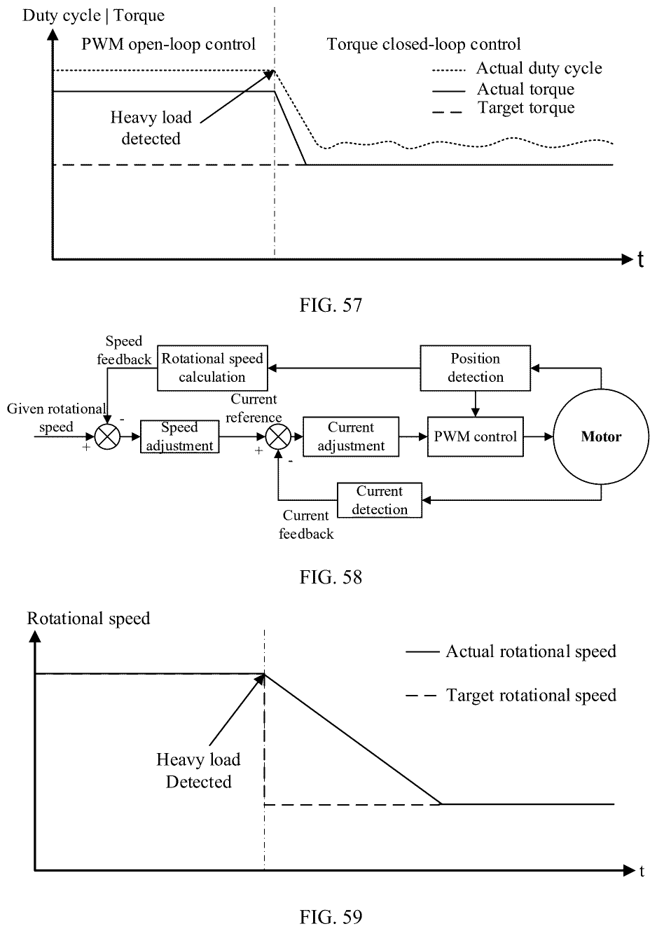

When the heavy load control unit 222 selects a torque closed-loop control strategy as the second control strategy, under this torque closed-loop control strategy, the heavy load control unit 222 may reduce the motor torque of the functional motor 211 to a target value and maintain it. This target value is less than or equal to the upper limit threshold of the motor torque under the normal operating state of the functional motor 211. FIG. 57 is a schematic diagram of motor torque change when switching from the PWM duty cycle open-loop control strategy to the torque closed-loop control strategy.

The first control strategy being a speed closed-loop control strategy is described as an example. FIG. 58 is a block diagram of the rotational speed closed-loop control logic. When the heavy load control unit 222 also selects the rotational speed closed-loop control strategy as the second control strategy, assuming the rotational speed set for normal operation of the functional motor 211 is N₀, in response to the heavy load identification unit 221 identifying entry into the heavy load state, the heavy load control unit 222 sets the target speed to N₁, and N₁<N₀.

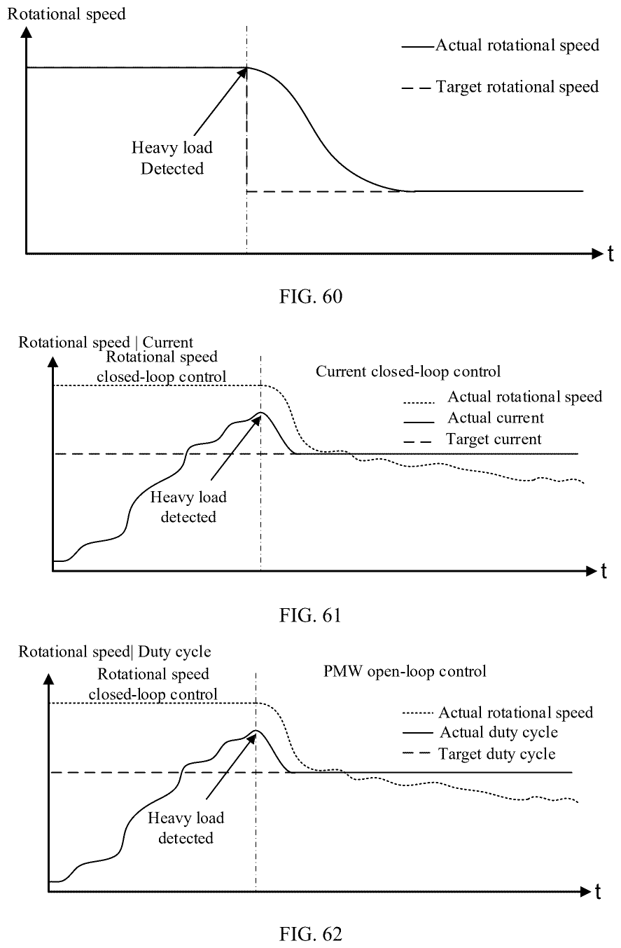

When reducing the motor speed, a linear decrease method or a curved decrease method may be used. FIG. 59 and FIG. 60 are schematic diagrams of motor speed changes using the linear decrease method and the curved decrease method, respectively, under the control of the heavy load control unit 222.

When the heavy load control unit 222 selects a current closed-loop control strategy as the second control strategy, under this current closed-loop control strategy, the heavy load control unit 222 may reduce the bus current of the functional motor 211 to a target value and maintain it. This target value is smaller than or equal to the upper limit threshold of the bus current under the normal operating state of the functional motor 211. FIG. 61 is a schematic diagram of bus current change when switching from the rotational speed closed-loop control strategy to the current closed-loop control strategy.

When the heavy load control unit 222 selects a PWM duty cycle open-loop control strategy as the second control strategy, under this PWM duty cycle open-loop control strategy, the heavy load control unit 222 may reduce the duty cycle of the functional motor 211 to a target value and maintain it. This target value is smaller than or equal to the upper limit threshold of the duty cycle under the normal operating state of the functional motor 211. FIG. 62 is a schematic diagram of duty cycle change when switching from the rotational speed closed-loop control strategy to the PWM duty cycle open-loop control strategy.

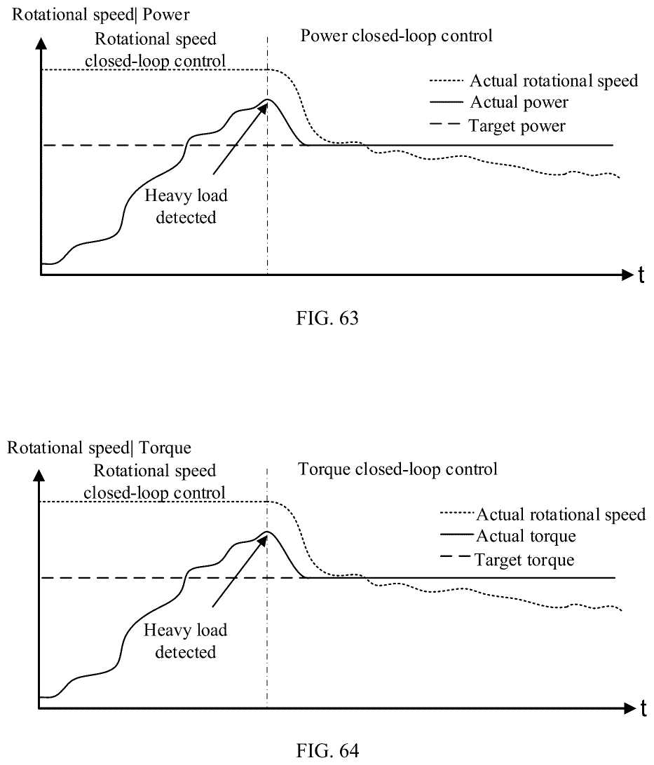

When the heavy load control unit 222 selects a power closed-loop control strategy as the second control strategy, under this power closed-loop control strategy, the heavy load control unit 222 may reduce the motor power of the functional motor 211 to a target value and maintain it. This target value is smaller than or equal to the upper limit threshold of the motor power under the normal operating state of the functional motor 211. FIG. 63 is a schematic diagram of motor power change when switching from the rotational speed closed-loop control strategy to the power closed-loop control strategy.

When the heavy load control unit 222 selects a torque closed-loop control strategy as the second control strategy, under this torque closed-loop control strategy, the heavy load control unit 222 may reduce the motor torque of the functional motor 211 to a target value and maintain it. This target value is smaller than or equal to the upper limit threshold of the motor torque under the normal operating state of the functional motor 211. FIG. 64 is a schematic diagram of motor torque change when switching from the rotational speed closed-loop control strategy to the torque closed-loop control strategy.

Similar to the above embodiments, the first control strategy being a current closed-loop control strategy is described as an example. When the heavy load control unit 222 also selects the current closed-loop control strategy as the second control strategy, assuming the current set for normal operation of the functional motor 211 is I₀, in response to the heavy load identification unit 221 identifying entry into the heavy load state, the heavy load control unit 222 sets the target current to I₁, and I₁<I₀. When reducing the motor speed, a linear decrease method or a curved decrease method may be used.

When the heavy load control unit 222 selects a speed closed-loop control strategy as the second control strategy, under this speed closed-loop control strategy, the heavy load control unit 222 may reduce the motor speed of the functional motor 211 to a target value and maintain it. This target value is smaller than or equal to the upper limit threshold of the motor speed under the normal operating state of the functional motor 211.

When the heavy load control unit 222 selects a PWM duty cycle open-loop control strategy as the second control strategy, under this PWM duty cycle open-loop control strategy, the heavy load control unit 222 may reduce the duty cycle of the functional motor 211 to a target value and maintain it. This target value is smaller than or equal to the upper limit threshold of the duty cycle under the normal operating state of the functional motor 211.

When the heavy load control unit 222 selects a power closed-loop control strategy as the second control strategy, under this power closed-loop control strategy, the heavy load control unit 222 may reduce the motor power of the functional motor 211 to a target value and maintain it. This target value is smaller than or equal to the upper limit threshold of the motor power under the normal operating state of the functional motor 211.

When the heavy load control unit 222 selects a torque closed-loop control strategy as the second control strategy, under this torque closed-loop control strategy, the heavy load control unit 222 may reduce the motor torque of the functional motor 211 to a target value and maintain it. This target value is smaller than or equal to the upper limit threshold of the motor torque under the normal operating state of the functional motor 211.

The first control strategy being a power closed-loop control strategy is described as an example. When the heavy load control unit 222 also selects the power closed-loop control strategy as the second control strategy, assuming the power set for normal operation of the functional motor 211 is P₀, in response to the heavy load identification unit 221 identifying entry into the heavy load state, the heavy load control unit 222 sets the target power to P₁, and P₁<P₀. When reducing the motor power, a linear decrease method or a curved decrease method may be used.

When the heavy load control unit 222 selects a speed closed-loop control strategy as the second control strategy, under this speed closed-loop control strategy, the heavy load control unit 222 may reduce the motor power of the functional motor 211 to a target value and maintain it. This target value is smaller than or equal to the upper limit threshold of the motor power under the normal operating state of the functional motor 211.

When the heavy load control unit 222 selects a PWM duty cycle open-loop control strategy as the second control strategy, under this PWM duty cycle open-loop control strategy, the heavy load control unit 222 may reduce the duty cycle of the functional motor 211 to a target value and maintain it. This target value is smaller than or equal to the upper limit threshold of the duty cycle under the normal operating state of the functional motor 211.

When the heavy load control unit 222 selects a current closed-loop control strategy as the second control strategy, under this current closed-loop control strategy, the heavy load control unit 222 may reduce the current of the functional motor 211 to a target value and maintain it. This target value is smaller than or equal to the upper limit threshold of the current under the normal operating state of the functional motor 211.

When the heavy load control unit 222 selects a torque closed-loop control strategy as the second control strategy, under this torque closed-loop control strategy, the heavy load control unit 222 may reduce the motor torque of the functional motor 211 to a target value and maintain it. This target value is smaller than or equal to the upper limit threshold of the motor torque under the normal operating state of the functional motor 211.

The first control strategy being a torque closed-loop control strategy is described as an example. When the heavy load control unit 222 also selects the torque closed-loop control strategy as the second control strategy, assuming the torque set for normal operation of the functional motor 211 is T₀, in response to the heavy load identification unit 221 identifying entry into the heavy load state, the heavy load control unit 222 sets the target torque to T₁, and T₁<T₀. When reducing the motor torque, a linear decrease method or a curved decrease method may be used.

When the heavy load control unit 222 selects a speed closed-loop control strategy as the second control strategy, under this speed closed-loop control strategy, the heavy load control unit 222 may reduce the motor speed of the functional motor 211 to a target value and maintain it. This target value is smaller than or equal to the upper limit threshold of the motor speed under the normal operating state of the functional motor 211.

When the heavy load control unit 222 selects a PWM duty cycle open-loop control strategy as the second control strategy, under this PWM duty cycle open-loop control strategy, the heavy load control unit 222 may reduce the duty cycle of the functional motor 211 to a target value and maintain it. This target value is smaller than or equal to the upper limit threshold of the duty cycle under the normal operating state of the functional motor 211.

When the heavy load control unit 222 selects a current closed-loop control strategy as the second control strategy, under this current closed-loop control strategy, the heavy load control unit 222 may reduce the current of the functional motor 211 to a target value and maintain it. This target value is smaller or equal to the upper limit threshold of the current under the normal operating state of the functional motor 211.

When the heavy load control unit 222 selects a power closed-loop control strategy as the second control strategy, under this power closed-loop control strategy, the heavy load control unit 222 may reduce the motor power of the functional motor 211 to a target value and maintain it. This target value is smaller than or equal to the upper limit threshold of the motor power under the normal operating state of the functional motor 211.

Based on the same objective, in another aspect, an embodiment of the present disclosure provides an electric motor-powered garden vehicle.

As shown in FIGS. 1 to 3, an electric motor-powered garden vehicle according to one or more embodiments of the present disclosure includes:
a frame 200, and a functional mechanism 21 and a drive mechanism 23 connected to the frame.

The frame 200 extends at least partially parallel to the front-rear direction. A carrying mechanism 201 may be disposed on the frame 200. The carrying mechanism 201 is configured to carry an operator of the electric motor-powered garden vehicle and may include at least one of a seat or a standing platform. FIG. 1 exemplarily shows only the case where the carrying mechanism 201 includes a seat. The seat or the standing platform is for the working user to sit or stand on. That is, the electric motor-powered garden vehicle may provide a ride-on working mode or a stand-on working mode. Furthermore, the structure of the seat and the standing platform may be flexibly switched, meaning the working mode of the electric motor-powered garden vehicle may be flexibly switched between the ride-on working mode and the stand-on working mode according to the actual needs of the working user. The frame 200 may further be provided with a hand-operated component, based on which the electric motor-powered garden vehicle may further provide a walk-behind working mode.

As shown in FIG. 1, the functional mechanism 21 is attached to the frame 200 and includes a functional motor 211 and an output component driven by the functional motor 211 to perform a functional operation. It is understandable that the functional mechanism 21 may include a plurality of the output components, and the plurality of output components may be driven by at least one functional motor 211.

The drive mechanism 23 is configured to cause the electric motor-powered garden vehicle to travel within garden scenarios such as lawns, gardens, fences, greens, or other road surfaces, and includes a drive motor and a drive wheel driven by the drive motor. During the travel of the electric motor-powered garden vehicle, the functional mechanism 21 performs corresponding functional operations in an orderly manner under the control of the controller assembly 22.

As shown in FIG. 1, the electric motor-powered garden vehicle further includes a power system 24 configured to supply power to the functional mechanism 21 and the drive mechanism 23.

The power system 24 is disposed on the frame 200 and detachably connected to the frame 200. The power system 24 includes a plurality of battery units. The plurality of battery units may include at least one of a first specification battery pack or a second specification battery pack. The specification differences between the first specification battery pack and the second specification battery pack include, but are not limited to, differences in battery pack capacity, voltage, internal resistance, weight, size, energy density, cell type, state-of-charge information, battery health status information, etc.

In some embodiments, the difference between the first specification battery pack and the second specification battery pack lies in different battery pack capacities. The capacity of the first specification battery pack is greater than the capacity of the second specification battery pack. The second specification battery pack is configured to provide power for handheld garden tools. For example, the second specification battery pack may power garden tools such as grass trimmers, pruning shears, blowers, chain saws, etc. Furthermore, the second specification battery pack may further power torque-output tools such as electric drills, electric hammers, etc.; power sawing tools such as circular saws, jigsaws, reciprocating saws, etc.; or power grinding tools such as angle grinders, sanders, etc.

In some embodiments, the difference between the first specification battery pack and the second specification battery pack lies in the different types of cells used. For example, the first specification battery pack and the second specification battery pack may use lithium iron phosphate cells and ternary lithium cells, respectively. In another embodiment, the plurality of battery units in the power system may use nickel-cadmium battery cells, lead-acid battery cells, or graphene cells, etc.

The use of the first specification battery pack and/or the second specification battery pack for the plurality of battery units of the power system 24 enables the electric motor-powered garden vehicle to be compatible with battery packs of different specifications, meeting high-power work requirements while also being adaptable to handheld electric garden tools, making the working methods of staff more flexible.

In some embodiments, the functional mechanism 21 is configured to perform a mowing function. The functional mechanism 21 includes a mowing motor 213, and a mowing element driven by the mowing motor 213. The functional mechanism 21 may include one or more mowing elements, and the one or more mowing elements are driven by at least one mowing motor 213.

It is understandable that, in some embodiments, the output component in the functional mechanism 21 may be replaced with another functional component, such as components for snow removal, snow blowing, snow shoveling, flushing, etc. Those skilled in the art should be able to adaptively replace various functional components without creative effort, all of which should fall within the protection scope of this embodiment.

In the electric motor-powered garden vehicle, a controller assembly 22 is provided corresponding to the functional mechanism 21. The controller assembly 22 is configured to control the operating state of the functional motor 211. As shown in FIG. 2, the controller assembly 22 may be set in an integrated controller system of the entire electric motor-powered garden vehicle, or may be set independently. The control chip used in the controller assembly 22 may be, for example, a Microcontroller Unit (MCU), an Advanced RISC Machine (ARM), etc.

The functional motor 211 has a plurality of operating parameters. When the controller assembly 22 controls the functional motor 211, it may select a plurality of control strategies corresponding to the plurality of operating parameters.

The plurality of operating parameters of the functional motor 211 may include, for example, a speed parameter, an electrical parameter, a power parameter, a torque parameter, and a PWM duty cycle parameter.

Corresponding to the plurality of aforementioned operating parameters, the plurality of control strategies that the controller assembly 22 may select are respectively a speed closed-loop control strategy, a current closed-loop control strategy, a power closed-loop control strategy, a torque closed-loop control strategy, and a PWM duty cycle open-loop control strategy.

As shown in FIG. 3, in some embodiments, the controller assembly 22 includes a heavy load identification unit 221 and a heavy load control unit 222.

The heavy load identification unit 221 is configured to select a target operating parameter from the plurality of operating parameters, and determine whether the functional motor enters a heavy load state based on the target operating parameter and/or a change of the target operating parameters.

The target operating parameter does not correspond the first control strategy currently adopted by the controller assembly 22 for the functional motor 211. For example, when the first control strategy currently adopted by the controller assembly 22 is the rotational speed closed-loop control strategy, an operating parameter other than the rotational speed parameter is selected as the target operating parameter. In another embodiment, when the first control strategy currently adopted by the controller assembly 22 is not a torque closed-loop control strategy, the torque parameter may be selected as the target operating parameter.

It is understandable that there are a plurality of operating parameters that do not correspond to the current first control strategy, and the heavy load identification unit 221 may select one or more operating parameters as the target operating parameters for monitoring.

When a heavy load mutation occurs during the operation of the functional motor 211, the load torque suddenly increases, and correspondingly, the motor speed, motor power, duty cycle, and related electrical parameters will fluctuate accordingly. The heavy load identification unit 221 monitors one or more operating parameters related to the functional motor 211, and based on the operating parameters and/or changes in the operating parameters, it may accurately and sensitively detect and identify the load mutation of the motor and determine whether the functional motor 211 enters the heavy load state.

After the heavy load identification unit 221 identifies that the functional motor 211 has entered the heavy load state, the heavy load control unit 222 in the controller assembly 22 may select a second control strategy to control the functional motor 211, for example, by reducing the duty cycle, reducing the rotational speed, reducing or maintaining the current, reducing or maintaining the power, reducing or maintaining the torque, etc., to cause the functional motor 211 to exit the heavy load state. The second control strategy may be the same as the first control strategy or different from the first control strategy.

In the electric motor-powered garden vehicle, the heavy load identification unit 221 in the controller assembly 22 monitors one or more operating parameters related to the functional motor 211, and determines whether the functional motor 211 enters the heavy load state based on the operating parameters and/or changes in the operating parameters. In response to determination that the functional motor 211 has entered the heavy load state, the heavy load control unit 222 in the controller assembly 22 selects an appropriate control strategy according to the situation to promptly adjust the functional motor 211, causing the functional motor 211 to exit the heavy load state. This method can accurately and sensitively identify heavy load mutations of the motor, further quickly respond to heavy load mutations, promptly adjust the control strategy, and maintain the motor system in a normal operating state, thereby improving the stability and working efficiency of the whole machine and optimizing the user experience.

Based on the same objective, in another aspect, an embodiment of the present disclosure provides an electric ride-on mower.

As shown in FIGS. 1 to 3, an electric ride-on mower according to one or more embodiments of the present disclosure includes:
a frame 200, and a mowing mechanism 25 and a drive mechanism 23 connected to the frame.

The frame 200 extends at least partially parallel to the front-rear direction. A carrying mechanism 201 may be disposed on the frame 200. The carrying mechanism 201 is configured to carry an operator of the electric ride-on mower and may include at least one of a seat or a standing platform. FIG. 1 exemplarily shows only the case where the carrying mechanism 201 includes a seat. The seat or the standing platform is for the working user to sit or stand on. That is, the electric ride-on mower may provide a ride-on working mode or a stand-on working mode. Furthermore, the structure of the seat and the standing platform may be flexibly switched, meaning the working mode of the electric ride-on mower may be flexibly switched between the ride-on working mode and the stand-on working mode according to the actual needs of the working user. The frame 200 may also be provided with a hand-operated component, based on which the electric ride-on mower may also provide a walk-behind working mode.

As shown in FIG. 1, the mowing mechanism 25 is attached to the frame 200 and includes a mowing motor 213 and a mowing element driven by the mowing motor 213 to perform mowing tasks. It is understandable that the mowing mechanism 25 may include a plurality of the mowing elements, and the plurality of mowing elements are driven by at least one mowing motor 213.

The drive mechanism 23 is configured to cause the electric ride-on mower to travel within garden scenarios such as lawns, gardens, fences, greens, or other road surfaces, and includes a drive motor and a drive wheel driven by the drive motor. During the travel of the electric ride-on mower, the mowing mechanism 25 performs corresponding functional operations in an orderly manner under the control of the controller assembly 22.

As shown in FIG. 1, the electric ride-on mower further includes a power system 24 configured to supply power to the mowing mechanism 25 and the drive mechanism 23.

The power system 24 is disposed on the frame 200 and detachably connected to the frame 200. The power system 24 includes a plurality of battery units. The plurality of battery units may include at least one of a first specification battery pack or a second specification battery pack. The specification differences between the first specification battery pack and the second specification battery pack include, but are not limited to, differences in battery pack capacity, voltage, internal resistance, weight, size, energy density, cell type, state-of-charge information, battery health status information, etc.

In some embodiments, the difference between the first specification battery pack and the second specification battery pack lies in different battery pack capacities. The capacity of the first specification battery pack is greater than the capacity of the second specification battery pack. The second specification battery pack is configured to provide power for handheld garden tools. For example, the second specification battery pack may power garden tools such as grass trimmers, pruning shears, blowers, chain saws, etc. Furthermore, the second specification battery pack may also power torque-output tools such as electric drills, electric hammers, etc.; power sawing tools such as circular saws, jigsaws, reciprocating saws, etc.; or power grinding tools such as angle grinders, sanders, etc.

In some embodiments, the difference between the first specification battery pack and the second specification battery pack lies in the different types of cells used. For example, the first specification battery pack and the second specification battery pack may use lithium iron phosphate cells and ternary lithium cells, respectively. The plurality of battery units in the power system may also use nickel-cadmium battery cells, lead-acid battery cells, graphene cells, etc.

The use of the first specification battery pack and/or the second specification battery pack for the plurality of battery units of the power system 24 enables the electric ride-on mower to be compatible with battery packs of different specifications, meeting high-power work requirements while also being adaptable to handheld electric garden tools, making the working methods of staff more flexible.

In some embodiments, the mowing mechanism 25 is configured to perform a mowing function. The mowing mechanism 25 includes a mowing motor 213, and a mowing element driven by the mowing motor 213. The mowing mechanism 25 may include one or more mowing elements, and the one or more mowing elements are driven by at least one mowing motor 213.

It is understandable that, in some embodiments, the mowing element in the mowing mechanism 25 may be replaced with another functional component, such as a component for snow removal, snow blowing, snow shoveling, flushing, etc. Those skilled in the art should be able to adaptively replace various functional components without creative effort, all of which should fall within the protection scope of this embodiment.

In the electric ride-on mower, a controller assembly 22 is provided corresponding to the mowing mechanism 25. The controller assembly 22 is configured to control the operating state of the mowing motor 213. As shown in FIG. 2, the controller assembly 22 may be set in an integrated controller system of the entire electric ride-on mower, or may be set independently. The control chip used in the controller assembly 22 may be, for example, a Microcontroller Unit (MCU), an Advanced RISC Machine (ARM), etc.

The mowing motor 213 has a plurality of operating parameters. When the controller assembly 22 controls the mowing motor 213, it may select a plurality of control strategies corresponding to the plurality of operating parameters.

The plurality of operating parameters of the mowing motor 213 may include, for example, a speed parameter, an electrical parameter, a power parameter, a torque parameter, and a PWM duty cycle parameter.

Corresponding to the plurality of aforementioned operating parameters, the plurality of control strategies that the controller assembly 22 may select are respectively a speed closed-loop control strategy, a current closed-loop control strategy, a power closed-loop control strategy, a torque closed-loop control strategy, and a PWM duty cycle open-loop control strategy.

As shown in FIG. 3, in some embodiments, the controller assembly 22 includes a heavy load identification unit 221 and a heavy load control unit 222.

The heavy load identification unit 221 is configured to select a target operating parameter from the plurality of operating parameters, and determine whether the functional motor enters a heavy load state based on the target operating parameter and/or a change of the target operating parameters.

The target operating parameter does not correspond to the first control strategy currently adopted by the controller assembly 22 for the mowing motor 213. For example, when the first control strategy currently adopted by the controller assembly 22 is the rotational speed closed-loop control strategy, an operating parameter other than the rotational speed parameter is selected as the target operating parameter. When the first control strategy currently adopted by the controller assembly 22 is not a torque closed-loop control strategy, the torque parameter may be selected as the target operating parameter.

It is understandable that there are a plurality of operating parameters that do not match the current first control strategy, and the heavy load identification unit 221 may select one or more operating parameters as the target operating parameters for monitoring.

When a heavy load mutation occurs during the operation of the mowing motor 213, the load torque suddenly increases, and correspondingly, the motor speed, motor power, duty cycle, and related electrical parameters will fluctuate and change accordingly. The heavy load identification unit 221 monitors one or more operating parameters related to the mowing motor 213, and based on the operating parameters and/or changes in the operating parameters, it may accurately and sensitively detect and identify the load mutation of the motor and determine whether it enters the heavy load state.

When the heavy load identification unit 221 identifies that the mowing motor 213 has entered the heavy load state, the heavy load control unit 222 in the controller assembly 22 may select a second control strategy to adjust the control of the mowing motor 213, for example, by reducing the duty cycle, reducing the rotational speed, reducing or maintaining the current, reducing or maintaining the power, reducing or maintaining the torque, etc., to make the mowing motor 213 exit the heavy load state. The second control strategy may be the same as the first control strategy or different from the first control strategy.

In the electric ride-on mower, the heavy load identification unit 221 in the controller assembly 22 monitors one or more operating parameters related to the mowing motor 213, and determines whether the mowing motor 213 enters the heavy load state based on the operating parameters and/or changes in the operating parameters. When it is determined that the mowing motor 213 has entered the heavy load state, the heavy load control unit 222 in the controller assembly 22 selects an appropriate control strategy according to the situation to promptly adjust the mowing motor 213, causing the mowing motor 213 to exit the heavy load state. This method may accurately and sensitively identify heavy load mutations of the motor, further quickly respond to heavy load mutations, promptly adjust the control strategy, and maintain the motor system in a normal operating state, thereby improving the stability and working efficiency of the whole machine and optimizing the user experience.

It should be noted that the method according to one or more embodiments of the present disclosure may be executed by a single device, such as a computer or a server. In another embodiment, the method according to the embodiments may be applied in a distributed scenario, where a plurality of devices cooperate with each other to complete the method. In such a distributed scenario, one of the plurality of devices may only execute one or more steps of the method according to one or more embodiments of the present disclosure, and the plurality of devices interact with each other to complete the described method.

It should be noted that the specific embodiments of the present disclosure have been described above. Other embodiments are within the scope of the appended claims. In some cases, the actions or steps recorded in the claims may be executed in a different order than in the embodiments and still achieve the desired results. In addition, the processes depicted in the accompanying drawings do not necessarily require the specific order or sequential order shown to achieve the desired results. In certain implementations, multitasking and parallel processing are also possible or may be advantageous.

For the convenience of description, the above device is described by dividing its functions into various modules. Of course, when implementing one or more embodiments of the present disclosure, the functions of each module may be implemented in one or more pieces of software and/or hardware.

The devices of the above embodiments are used to implement the corresponding methods in the foregoing embodiments and have the beneficial effects of the corresponding method embodiments, which are not repeated here.

Those skilled in the art can understand that implementing all or part of the processes in the methods of the above embodiments may be accomplished by instructing relevant hardware through a computer program. The program may be stored in a computer-readable storage medium. When the program is executed, the method according to the embodiments may be implemented. The storage medium may be a magnetic disk, an optical disc, a Read-Only Memory (ROM), a Random Access Memory (RAM), a Flash Memory, a Hard Disk Drive (HDD), a Solid-State Drive (SSD), of a combination of the foregoing.

The systems, devices, modules, or units explained in the above embodiments may be specifically implemented by computer chips or entities, or by products with certain functions. For the convenience of description, the above device is described by dividing its functions into various units. Of course, when implementing the present disclosure, the function of each unit may be implemented in one or more pieces of software and/or hardware.

It should also be noted that the terms “comprise”, “include”, or any other variants thereof are intended to cover non-exclusive inclusion, so that a process, method, commodity, or device including a series of elements not only includes those elements but also includes other elements not explicitly listed, or elements inherent to such a process, method, commodity, or device. Without further restrictions, an element defined by the phrase “including a . . . ” does not exclude the existence of other identical elements in the process, method, commodity, or device including the element.

Although the present disclosure has been described in conjunction with the specific embodiments thereof, based on the foregoing description, many substitutions, modifications, and variations of these embodiments will be apparent to those of ordinary skill in the art. One or more embodiments of the present disclosure are intended to cover all such substitutions, modifications, and variations that fall within the broad scope of the appended claims. Therefore, any omissions, modifications, equivalent substitutions, improvements, etc., made within the spirit and principles of one or more embodiments of the present disclosure shall fall within the protection scope of the present disclosure.

What is claimed is:

1. An electric vehicle, comprising:
a frame;
a functional mechanism attached to the frame, the functional mechanism comprising a functional motor and an output assembly configured to be driven by the functional motor to perform a function operation; and
a controller assembly configured to control an operating state of the functional motor,
wherein the functional motor has a plurality of operating parameters, and the controller assembly has a plurality of control strategies, the plurality of control strategies corresponding to the plurality of operating parameters of the functional motor,
wherein the controller assembly comprises:
a heavy load identification unit configured to select a target operating parameter from the plurality of operating parameters, and determine whether the functional motor enters a heavy load state based on the target operating parameter and/or a change of the target operating parameter, wherein the target operating parameter does not correspond to a first control strategy among the plurality of control strategies that is currently adopted by the controller assembly for the functional motor; and
a heavy load control unit configured to select, in response to determining that the functional motor enters the heavy load state, a second control strategy from the plurality of control strategies, and control the functional motor based on the second control strategy to exit the heavy load state.

2. The electric vehicle of claim 1, wherein the plurality of operating parameters of the functional motor comprise a rotational speed parameter, an electrical parameter, a power parameter, a torque parameter, and a PWM duty cycle parameter,
wherein the plurality of control strategies corresponding to the plurality of operating parameters comprise a rotational speed closed-loop control strategy, a current closed-loop control strategy, a power closed-loop control strategy, a torque closed-loop control strategy, and a PWM duty cycle open-loop control strategy.

3. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to the rotational speed parameter not corresponding to the first control strategy, the rotational speed parameter as the target operating parameter,
wherein the heavy load identification unit is further configured to monitor the rotational speed parameter and determine whether the functional motor enters the heavy load state based on the rotational speed parameter and/or a change of the rotational speed parameter.

4. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to the electrical parameter not corresponding to the first control strategy, the electrical parameter as the target operating parameter,
wherein the heavy load identification unit is further configured to monitor the electrical parameter and determine whether the functional motor enters the heavy load state based on the electrical parameter and/or a change of the electrical parameter.

5. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to the power parameter not corresponding to the first control strategy, the power parameter as the target operating parameter,
wherein the heavy load identification unit is further configured to monitor the power parameter and determine whether the functional motor enters the heavy load state based on the power parameter and/or a change of the power parameter.

6. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to the torque parameter not corresponding to the first control strategy, the torque parameter as the target operating parameter,
wherein the heavy load identification unit is further configured to monitor the torque parameter and determine whether the functional motor enters the heavy load state based on the torque parameter and/or a change of the torque parameter.

7. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to the PWM duty cycle parameter not corresponding to the first control strategy, the PWM duty cycle parameter as the target operating parameter,
wherein the heavy load identification unit is further configured to monitor the PWM duty cycle parameter and determine whether the functional motor enters the heavy load state based on the PWM duty cycle parameter and/or a change of the PWM duty cycle parameter.

8. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the rotational speed parameter and the electrical parameter not corresponding to the first control strategy, the rotational speed parameter and the electrical parameter as target operating parameters,
wherein the heavy load identification unit is further configured to monitor the rotational speed parameter and the electrical parameter, determine a current-to-speed ratio parameter based on a ratio of the electrical parameter to the rotational speed parameter, and determine whether the functional motor enters the heavy load state based on the current-to-speed ratio parameter and/or a change of the current-to-speed ratio parameter.

9. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the rotational speed parameter and the power parameter not corresponding to the first control strategy, the rotational speed parameter and the power parameter as target operating parameters,
wherein the heavy load identification unit is further configured to monitor the rotational speed parameter and the power parameter, determine a power-to-speed ratio parameter based on a ratio of the power parameter to the rotational speed parameter, and determine whether the functional motor enters the heavy load state based on the power-to-speed ratio parameter and/or a change of the power-to-speed ratio parameter.

10. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the rotational speed parameter and the torque parameter not corresponding to the first control strategy, the rotational speed parameter and the torque parameter as target operating parameters,
wherein the heavy load identification unit is further configured to monitor the rotational speed parameter and the torque parameter, determine a torque-to-speed ratio parameter based on a ratio of the torque parameter to the rotational speed parameter, and determine whether the functional motor enters the heavy load state based on the torque-to-speed ratio parameter and/or a change of the torque-to-speed ratio parameter.

11. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the rotational speed parameter and the PWM duty cycle parameter not corresponding to the first control strategy, the rotational speed parameter and the PWM duty cycle parameter as target operating parameters,
wherein the heavy load identification unit is further configured to monitor the rotational speed parameter and the PWM duty cycle parameter, determine a duty-cycle-to-speed ratio parameter based on a ratio of the PWM duty cycle parameter to the rotational speed parameter, and determine whether the functional motor enters the heavy load state based on the duty-cycle-to-speed ratio parameter and/or a change of the duty-cycle-to-speed ratio parameter.

12. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the electrical parameter and the PWM duty cycle parameter not corresponding to the first control strategy, the electrical parameter and the PWM duty cycle parameter as target operating parameters,
wherein the heavy load identification unit is further configured to monitor the electrical parameter and the PWM duty cycle parameter, determine a duty-cycle-to-current ratio parameter based on a ratio of the PWM duty cycle parameter to the electrical parameter, and determine whether the functional motor enters the heavy load state based on the duty-cycle-to-current ratio parameter and/or a change of the duty-cycle-to-current ratio parameter.

13. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the power parameter and the PWM duty cycle parameter not corresponding to the first control strategy, the power parameter and the PWM duty cycle parameter as target operating parameters,
wherein the heavy load identification unit is further configured to monitor the power parameter and the PWM duty cycle parameter, determine a duty-cycle-to-power ratio parameter based on a ratio of the PWM duty cycle parameter to the power parameter, and determine whether the functional motor enters the heavy load state based on the duty-cycle-to-power ratio parameter and/or a change of the duty-cycle-to-power ratio parameter.

14. The electric vehicle of claim 2, wherein the heavy load identification unit being configured to select a target operating parameter from the plurality of operating parameters, and determine whether the functional motor enters a heavy load state based on the target operating parameter and/or a change of the target operating parameter comprises:
the heavy load identification unit being configured to select, in response to both the torque parameter and the PWM duty cycle parameter not corresponding to the first control strategy, the torque parameter and the PWM duty cycle parameter as target operating parameters,
wherein the heavy load identification unit is further configured to monitor the torque parameter and the PWM duty cycle parameter, determine a duty-cycle-to-torque ratio parameter based on a ratio of the PWM duty cycle parameter to the torque parameter, and determine whether the functional motor enters the heavy load state based on the duty-cycle-to-torque ratio parameter and/or a change of the duty-cycle-to-torque ratio parameter.

15. The electric vehicle of claim 2, wherein the heavy load control unit being configured to control the functional motor based on the second control strategy comprises:
the heavy load control unit being configured to control, in response to the second control strategy being the same as the first control strategy, the operating parameter corresponding to the second control strategy to decrease to a target value, wherein the target value is smaller than a value of the operating parameter corresponding to the second control strategy under a normal operating state of the functional motor.

16. The electric vehicle of claim 2, wherein the heavy load control unit being configured to control and adjust the functional motor based on the second control strategy comprises:
the heavy load control unit being configured to control, in response to the second control strategy being different from the first control strategy, the operating parameter corresponding to the second control strategy to decrease to a target value, wherein the target value is smaller than or equal to an upper limit threshold of the operating parameter corresponding to the second control strategy under a normal operating state of the functional motor.

17. An electric garden work vehicle, comprising:
a frame;
a functional mechanism attached to the frame, the functional mechanism comprising a functional motor and an output assembly configured to be driven by the functional motor to perform a function operation; and
a controller assembly configured to control an operating state of the functional motor,
wherein the functional motor has a plurality of operating parameters, and the controller assembly has a plurality of control strategies, the plurality of control strategies corresponding to the plurality of operating parameters of the functional motor,
wherein the controller assembly comprises:
a heavy load identification unit configured to select a target operating parameter from the plurality of operating parameters, and determine whether the functional motor enters a heavy load state based on the target operating parameter and/or a change of the target operating parameter, wherein the target operating parameter does not correspond to a first control strategy among the plurality of control strategies that is currently adopted by the controller assembly for the functional motor; and
a heavy load control unit configured to select, in response to determining that the functional motor enters the heavy load state, a second control strategy from the plurality of control strategies, and control the functional motor based on the second control strategy to exit the heavy load state.

18. A riding lawn mower, comprising:
a frame;
a carrying mechanism provided at the frame and configured to carry a user;
a mowing mechanism attached to the frame, the mowing mechanism comprising a mowing motor and a cutting assembly configured to be driven by the mowing motor to perform a mowing operation; and
a controller assembly configured to control an operating state of the mowing motor,
wherein the mowing motor has a plurality of operating parameters, and the controller assembly has a plurality of control strategies, the plurality of control strategies corresponding to the plurality of operating parameters of the mowing motor,
wherein the controller assembly comprises:
a heavy load identification unit configured to select a target operating parameter from the plurality of operating parameters, and determine whether the mowing motor enters a heavy load state based on the target operating parameter and/or a change of the target operating parameter, wherein the target operating parameter does not correspond to a first control strategy among the plurality of control strategies that is currently adopted by the controller assembly for the mowing motor; and
a heavy load control unit configured to select, in response to determining that the mowing motor enters the heavy load state, a second control strategy from the plurality of control strategies, and control the mowing motor based on the second control strategy to exit the heavy load state.
